(19) United States
(12) Patent Application Publication
(10) Pub. No.: US 2003/0144989 A1
(43) Pub. Date: Jul. 31, 2003

(54) Method and system for determining athletic compliance

(76) Inventor: Christopher D. Schoemann, Minneapolis, MN (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 10/326,781

(22) Filed: Dec. 19, 2002

Related U.S. Application Data
(60) Provisional application No. 60/343,883, filed on Dec. 20, 2001.

(51) Int. Cl. G06F 7/00

(52) U.S. Cl. 707/1

(57) ABSTRACT

An interactive system for managing compliance information on institutions, teams, coaches and individuals includes an input means that permits the user to add, delete or manipulate information on institutions, teams, coaches and individuals. This information pertains to a regulated activity or activities. The input means permits adding or deleting regulations that pertain to the activity or activities. A first database structure is used for collecting and storing information on individuals. A second database structure is used for collecting and storing regulations that pertain to the regulated activity or activities. Furthermore, a third database structure accesses the first and second databases processing and comparing the information on individuals and regulations. The third database structure applies the comparison of the information on the individuals and the regulations to determine the compliance eligibility of the institutions, teams, coaches and individuals. Finally, there exists a communication link for accessing the internet and an output means for displaying and printing the information, regulations and compliance eligibility.

### CROSS REFERENCE

Cross-reference is made to provisional application, U.S. patent application No. 60/343,883 entitled “A Method And System For Determining Athletics Compliance,” filed on Dec. 20, 2001, the entire disclosure of which is hereby incorporated by reference.

### FIELD OF THE INVENTION

The present invention relates to regulated activities and, more specifically, to a system, method and computer program for facilitating compliance with the laws pertaining to regulated athletic activities.

### BACKGROUND OF THE INVENTION

Intercollegiate athletics have grown in scope, participation, cost and revenue generation for most colleges and universities. The National Collegiate Athletic Association was formed to help initiate, stimulate and improve intercollegiate athletics programs. The National Collegiate Athletic Association efforts to uphold the principle of and responsibility for all intercollegiate sports in conformity with the constitution and bylaws of the Association.

The National Collegiate Athletic Association (N.C.A.A.) and the individual member institutions have many regulations governing all athletic competition at the college/university level. These regulations include academics, extra benefits, ethical conduct, recruitment, institutional control, transfer legislation, financial aid and many more areas to provide a fair competitive environment in college athletics. The burden of tracking and complying with all the regulations and bylaws are increasing as the popularity and participation in athletics has increased. Additionally, the National Collegiate Athletic Association regulations and by-laws frequently change, which increases the burden on the individual institutions to comply.

To date, colleges and universities have used various methods to try to conform to the constantly changing regulations and by-laws, including the appointment of compliance officers and/or the formation of entire compliance departments. However, what is still needed is an easy and practical method and system for determining athletic compliance and eligibility that is readily adaptable to all institutions, athletic programs and athletic regulations.

### SUMMARY OF THE INVENTION

It is an aspect of the present invention to automate the process of complying with the N.C.A.A. rules and regulations that are used in determining compliance with those rules.

It is another aspect of the invention to automate the process of determining N.C.A.A. athletic eligibility by providing various step-by-step procedures.

To achieve these aspects an interactive system for managing compliance information on institutions, teams, coaches and individuals includes an input means that permits the user to add, delete or manipulate information on institutions, teams, coaches and individuals. This information pertains to a regulated activity or activities. The input means permits adding or deleting regulations that pertain to the activity or activities. A first database structure is used for collecting and storing information on individuals. A second database structure is used for collecting and storing regulations that pertain to the regulated activity or activities. Furthermore, a third database structure accesses the first and second databases. The third database structure applies the comparison of the information on the individuals and the regulations to determine the compliance eligibility of the institutions, teams, coaches and individuals. Finally, there exists a communication link for accessing the internet and an output means for displaying and printing the information, regulations and compliance eligibility.

These and other aspects of the invention will become apparent from the following description, the description being used to illustrate the preferred embodiment of the invention when read in conjunction with the accompanying drawings.

### BRIEF DESCRIPTION OF THE DRAWINGS

FIG. 1 illustrates a flow chart diagram depicting the application architecture.

FIG. 2 illustrates a computer system that provides access to a server/internet environment for determining athlete compliance eligibility.

FIG. 3 illustrates the main page in the preferred embodiment of the invention.

FIG. 4 illustrates the personal profile form in the preferred embodiment of the invention.

FIG. 5 illustrates a form with an expiration date in the preferred embodiment of the invention.

FIG. 6 illustrates a standard report in the preferred embodiment of the invention.

FIG. 7 illustrates a list of standard reports in the preferred embodiment of the invention.

FIG. 8 illustrates a Compliance Toolbox Item in the preferred embodiment of the invention.

FIG. 9 illustrates a list of sports in the preferred embodiment of the invention.

FIG. 10 illustrates an audit trail search report page in the preferred embodiment of the invention.

FIG. 11 illustrates the institutional user profiles in the preferred embodiment of the invention.

FIG. 12 illustrates the edit institutional user profile in the preferred embodiment of the invention.

FIG. 13 illustrates the add institutional user profile in the preferred embodiment of the invention.

FIG. 14 illustrates the enrollment history page in the preferred embodiment of the invention.

FIG. 15 illustrates the add coach to the blueprint profile in the preferred embodiment of the invention.

FIG. 16 illustrates the edit student-athlete in the blueprint profile in the preferred embodiment of the invention.

FIG. 17 illustrates the edit coach in the blueprint profile in the preferred embodiment of the invention.

FIG. 18 illustrates the view/edit CTI information profile in the preferred embodiment of the invention.

FIG. 19 illustrates the transfer eligibility profile in the preferred embodiment of the invention.

FIG. 20 illustrates the edit student-athlete financial aid information profile in the preferred embodiment of the invention.

FIG. 21 illustrates the edit student-athlete academic eligibility information profile in the preferred embodiment of the invention.

FIG. 22 illustrates the add a task item profile in the preferred embodiment of the invention.

FIG. 23 illustrates the copy previous academic year's blueprint profile in the preferred embodiment of the invention.

FIG. 24 illustrates the add a sport event profile in the preferred embodiment of the invention.

FIG. 25 illustrates the add a coach to sport's roster profile in the preferred embodiment of the invention.

FIG. 26 illustrates the add a student to sport's roster profile in the preferred embodiment of the invention.

FIG. 27 illustrates the maintain a sport's recruit profile in the preferred embodiment of the invention.

FIG. 28 illustrates the squad list report profile in the preferred embodiment of the invention.

FIG. 29 shows the sport counter determination flowchart in the preferred embodiment of the invention.

FIG. 30 shows the add a student profile flowchart in the preferred embodiment of the inventions.

FIG. 31 shows the full counter determination flowchart in the preferred embodiment of the invention.

FIG. 32 illustrates the fulfillment of credit hours 75/25 rule in the preferred embodiment of the invention.

FIG. 33 illustrates the fulfillment of minimum GPA 90/95 rule in the preferred embodiment of the invention.

FIG. 34 illustrates the fulfillment of percentage of degree requirement 25/50/75 rule in the preferred embodiment of the invention.

FIGS. 35A, 35B and 35C illustrates the determine academic eligibility text in the preferred embodiment of the invention.

FIG. 36 illustrates the message forum text in the preferred embodiment of the invention.

FIG. 37 shows the transfer student eligibility flowchart in the preferred embodiment of the invention.

FIG. 38 shows the 4-year college transfer flowchart in the preferred embodiment of the invention.

FIG. 39 shows the 2-year college transfer flowchart in the preferred embodiment of the invention.

FIG. 40 shows the 4-2-4-year college transfer flowchart in the preferred embodiment of the invention.

FIG. 41 illustrates the 4-year college transfer profile in the preferred embodiment of the invention.

FIG. 42 illustrates the 2-year college transfer profile in the preferred embodiment of the invention.

FIG. 43 illustrates the 4-2-4-year college transfer profile in the preferred embodiment of the invention.

FIG. 44 illustrates the add student-athlete to the blueprint profile in the preferred embodiment of the invention.

FIG. 45 illustrates the add/edit a sport recruit profile in the preferred embodiment of the invention.

FIG. 46 illustrates ticket assignment page in the preferred embodiment of the invention.

FIG. 47 illustrates the ticket transfer page in the preferred embodiment of the invention.

FIG. 48 illustrates the National Collegiate Athletic Association rule profile page in the preferred embodiment of the invention.

FIG. 49 illustrates the content setup page in the preferred embodiment of the invention.

FIG. 50 illustrates the system administrator page in the preferred embodiment of the invention.

FIG. 51 illustrates the CTI maintenance page in the preferred embodiment of the invention.

FIG. 52 illustrates the add what's a new item page in the preferred embodiment of the invention.

FIG. 53 illustrates the add a sport page in the preferred embodiment of the invention.

FIG. 54 illustrates the modify a sport page in the preferred embodiment of the invention.

FIG. 55 illustrates the blueprint administration page in the preferred embodiment of the invention.

FIG. 56 illustrates the event exceptions page in the preferred embodiment of the invention.

FIG. 57 illustrates the message forum administrator page in the preferred embodiment of the invention.

FIG. 58 illustrates the annual update page in the preferred embodiment of the invention.

### DETAILED DESCRIPTION OF THE INVENTION

The inventive method and system herein described, and sometimes referred to hereinafter as “Compliance Toolbox,” provides athlete compliance eligibility information for athletes, students, teams, coaches, colleges and institutions. The method and system provides hot (quick) links via the internet to the regulatory body regulations, interpretations and press releases. A Web based database contains regulatory body compliance specific information for each athlete, team, coach and recruit. The system and method further allows reporting by either individual athlete or by the sport. For example, the process of determining athletic eligibility is automated by providing a step-by-step process when new athletes are added to the system.

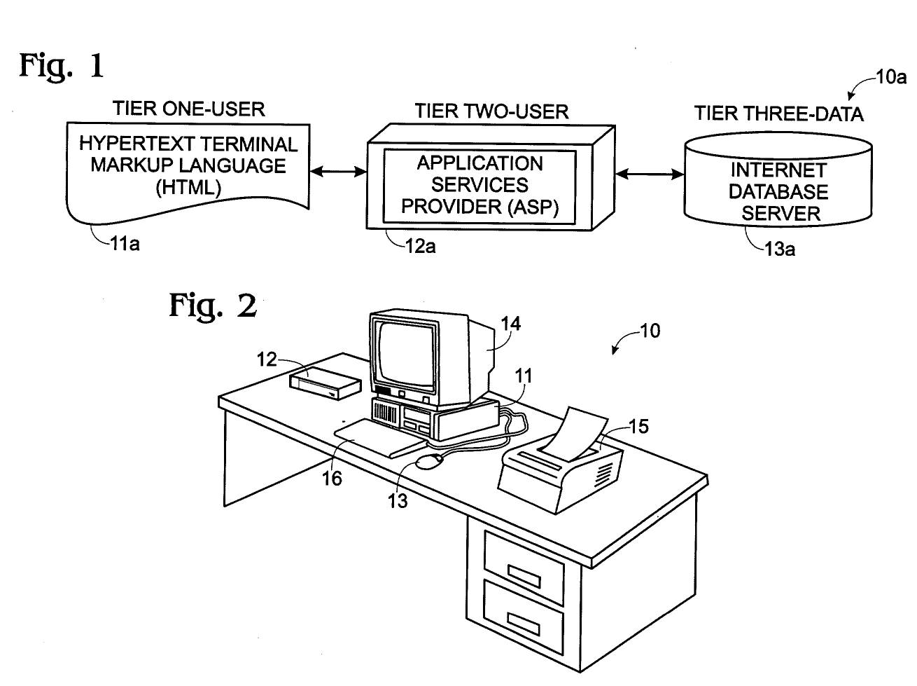

The computerized method and system 10 architecture is based on a three-tier model, as shown in FIG. 1. The Tier One 11 provides the graphical user interface (GUI) with personalization ability specific to such items such as user data requests, displaying selected information for the user, forms for data entry and local validation of data. These personalization abilities are for athletes, teams, coaches and the like. The Tier Two 12 consists of an application server to handle such items as connections from the user Tier One 11. The Tier Two 12 performs much of the application logic using a specifically designed algorithm and interfacing with databases and the like. Finally, Tier Three 13 consists of the Internet database server and physical database stores.

As the need arises for its users, the Compliance Toolbox will provide the means to select different texts or protocols to build-up databases on individual athletes. This is for them to become or remain in compliance with the governing body of regulations. These texts include add/edit, reporting, forms, community, preferences, help, a calendar of events, tasks, what's new, ineligible athletes, missing data and overdue tasks.

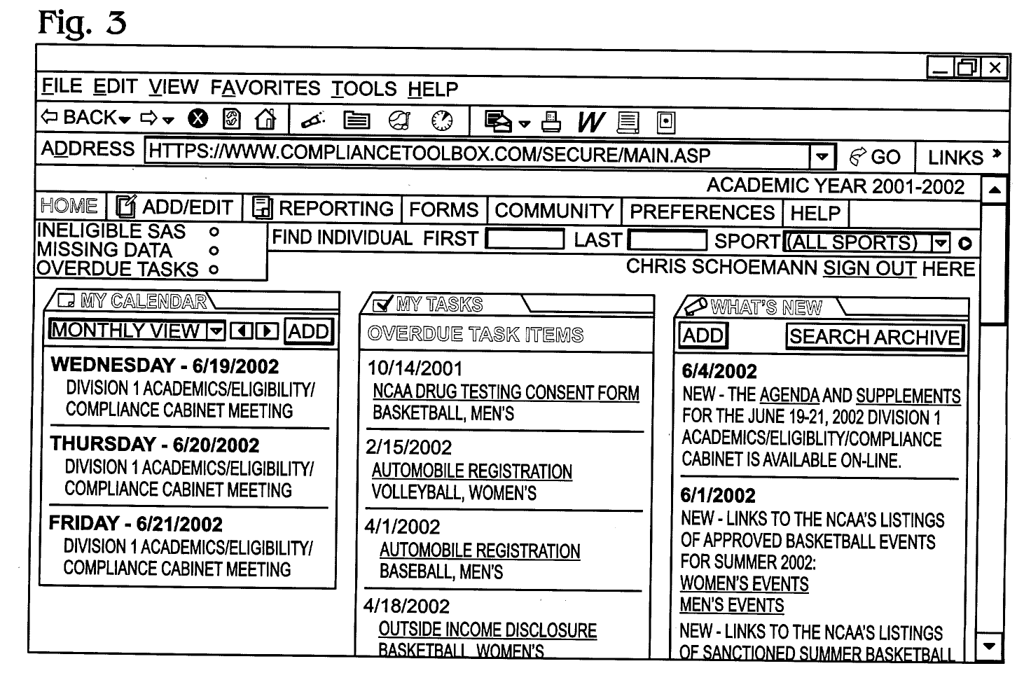

As is shown in FIG. 2, the interactive compliance and eligibility information system 10 comprises a personal computer 11. For example, the personal computer 11 can be a Pentium III, 500 MHz personal computer having four megabytes of random access memory (RAM) and a 500 megabyte hard drive. The compliance and eligibility information system 10 also comprises a color monitor 14, such as a 17″ color monitor (1024×768 resolution) together with an extended VGA graphics card (1024×768 resolution) installed in the personal computer 11. The interactive compliance and eligibility information system 10 further comprises a CD-ROM drive 12 and a color printer 15. An input means 16 includes a key board in the preferred embodiment of the invention and permits the user to add, delete or manipulate information on individuals and institutions that pertain to regulated activities. It also will add or delete regulations that pertain to the activities. Furthermore, input means 16 keyboard is substitutable for a touch screen, palm pilot or by other remote accessing wireless technology.

Generally, the interactive compliance and eligibility information system 10 provides an intuitive graphical user interface. Accessing all of the information pertinent to a specific athlete, team or institution merely requires an easy to use intuitive interface between the computer and the end-user. The icon oriented graphical user interface of the interactive compliance and eligibility information system 10 pictorially simplifies the access to assure maximum efficiency with minimum error. The extensive use of pop-up and on-line help facilities, as well as the readily available tutorial function, provide the user with on-screen guidance whenever it is needed.

The interactive compliance and eligibility information system 10 supports a full range of browsing, searching, and hunting techniques. Whether selecting the texts from the Main page or selecting a specific document reference point, users can scroll backward and forward through the information or jump directly to other cross-referenced information through the use of hyperlinks. For example, the User can search a weekly view of a calendar of athletic events or search the What's New text to identify any new National Collegiate Athletic Association regulatory interpretations. If a one-step return to frequently needed information is desired, public or private bookmarks and notes can be left at any point within the text. Customized task cards and files can be created by simply cutting and pasting text and images.

The interactive compliance and eligibility information system 10 provides a first database structure that collects and stores information on individuals and institutions. Information databases collected by different institutions or organizations are inconsistent with the way they refer to compliance related issues and requirements. Conventional CD-ROM retrieval engines are generally ineffective in dealing with these differences. To overcome these limitations and ensure complete and accurate searches, the interactive compliance and eligibility information system 10 utilizes this first database. The database is comprised of all student, athlete, roster, team, institution and player information related to compliance with the governing regulatory athletic body such as the NCAA.

The interactive compliance and eligibility information system 10 provides a second database structure that collects and stores regulations from the governing regulatory athletic body. This allows the users to determine whether or not an athlete is in compliance with the governing regulator athletic body regulations and/or its directives. The second database governing body regulations is the National Collegiate Athletic Association in the preferred embodiment of the invention. Furthermore, the second database includes a calendar of events for all sports related to the governing athletic body and interpretations of regulations or compliance issues ruled on by committees related to the governing athletic body. The second database further includes other items of news, what is new related to the governing athletic body and press releases.

The interactive compliance and eligibility information system 10 provides a third database structure that accesses the first and second databases through a set of algorithms. The third database structure processes and compares the information on individuals, institutions and regulations and applies the comparison to determine the eligibility of these individuals and institutions. The third database further identifies ineligible athletes, missing data and overdue tasks for the coach or organization.

Additionally, the interactive compliance and eligibility information system 10 provides a communication link for accessing the Internet. This provides the user with additional information from the governing athletic body or any current event or interpretation of rules that have affected other institutions.

The interactive compliance and eligibility information system 10 includes an output means that is a color monitor 14 for displaying and a color printer 15 for printing the information on individuals, institutions, regulations and compliance eligibility status. The output means printer 15 is substitutable with e-mail, facsimile, a screen or a palm pilot.

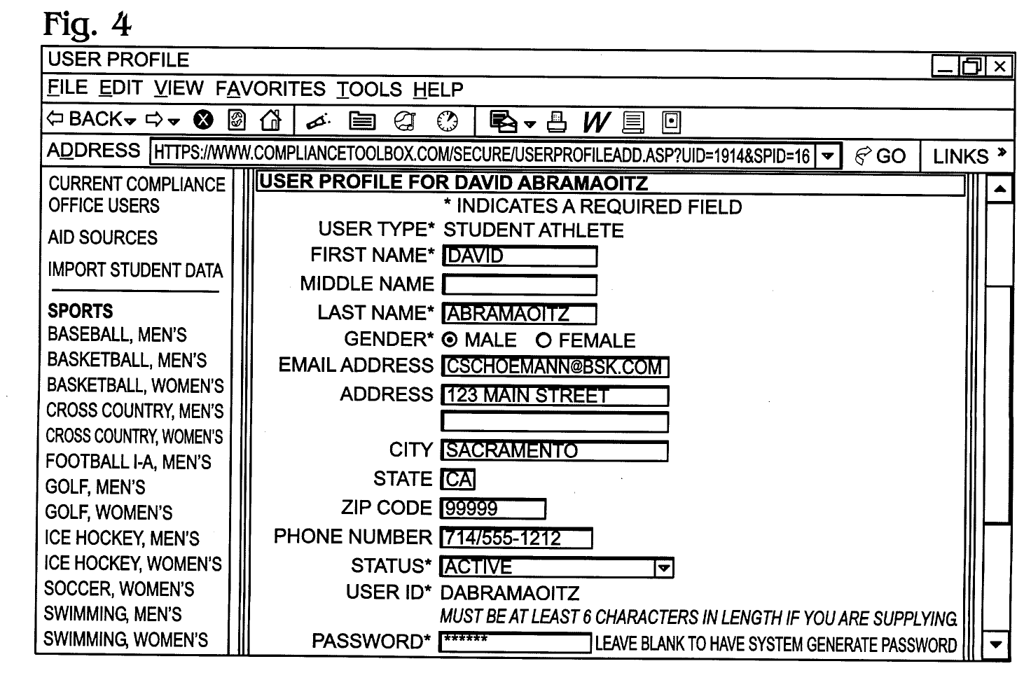

The system 10 User views the color screen 14 that provides the Compliance Toolbox web site. The User opens their web browser, navigates to the Compliance Toolbox web site and the system displays the Login screen that provides a security protocol. At this point the User enters their user id, a password and clicks Login with mouse 13. The system 10 verifies the user id and password. If the User is a student athlete or coach, and they are assigned to multiple sports, the system 10 presents them with the list of sports they are assigned to. The User then selects which sport they wish to work with and clicks OK with the mouse 13. The system 10 starts a session and displays the Main page for that User, as seen in FIG. 3. However, if the User enters an invalid user id and/or password the system 10 displays a message to that effect and asks the User to enter the information again. Furthermore, when the User forgets their password they can select E-mail Me My Password present on the screen. The system 10 then e-mails the password to the e-mail account of the User that attempted to login and returns the user to the Login screen.

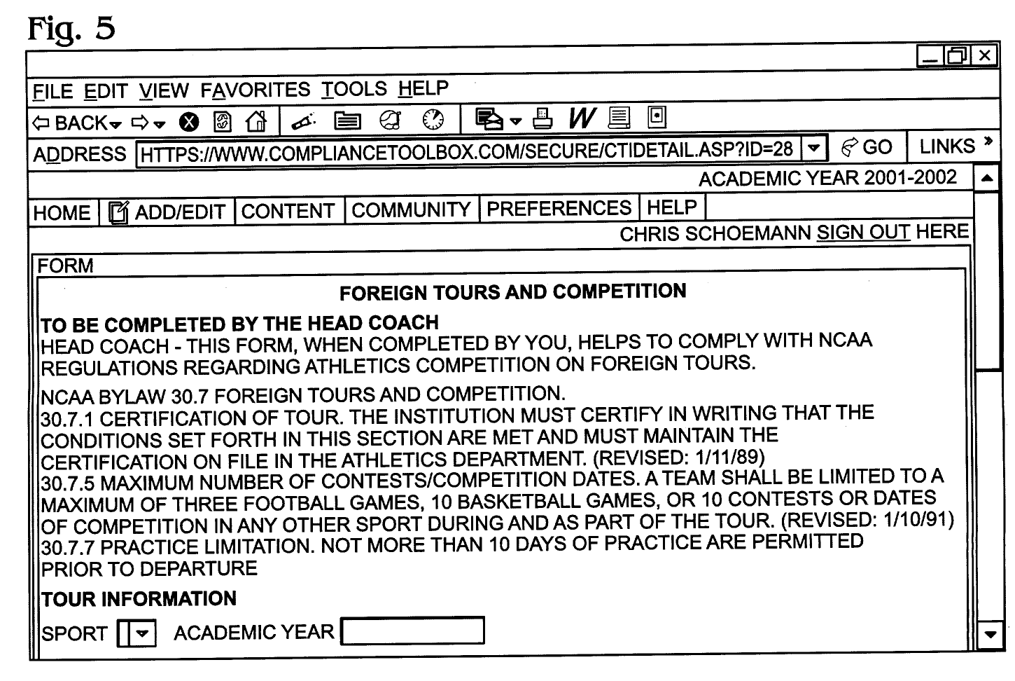

After logging in the User can maintain their personal profile by editing it. The User selects Maintain Personal Profile and the system 10 displays the personal profile form as shown in FIG. 4. The form presents fields including read only user id, first and last name, work/campus telephone number, further presents a changeable e-mail address and an additional field for student athletes and coaches. An associated sports field is presented in read only. The User can change their password by checking the Change Password checkbox and typing in the new password. The User then re-types the password in the Verify New Password text box. To save this information the User selects Submit and the system 10 saves the information. The system 10 automatically returns the User to the Main Page. However, if on saving the personal profile the system 10 determines that the data fails validation the system returns to the Maintain Personal Profile page and provides error messages indicating what corrections are needed. The User can then correct the data and resubmit.

As shown in FIG. 3, the User can view What's New information as entered by the site administrator. The User selects Main Page and the system displays the What's New section as part of the User's Main Page. All of the What's New items assigned to the sports associated with the User are displayed.

An institutional User can view, print and download the Compliance Toolbox Items (CTI) that are applicable to their assigned sport. This occurs only if the institution has at least one blueprint defined for a sport, the User is assigned as a Coach to the sport and has Compliance Toolbox items assigned to the selected sport. The User is presented with a list of Compliance Toolbox Items that were added to the sport's blueprint, as shown in FIG. 3. The User selects the CTI they wish to review. The User is presented with a brief description of the CTI and can then pick one of three options. The first option is to select View and the browser will display the pdf version of the document. The second option is to select Download and the browser will download the document to the User's computer. Finally, the last option is to select Print and the browser will print the document.

A Coach can enter data into the CTIs that accept interactive data and are assigned to their sport. The college, institution or organization must have at least one blueprint for the sport defined, a User assigned as a Coach to the sport and has editable Toolbox items assigned to the Coach for their sport. The first step is to select the Compliance Toolbox Items as shown in FIG. 3. From the list of CTIs assigned to the Coach to fill in, the Coach selects the CTI to fill out and then selects Enter to enter the information. The CTI will then be presented in an editable manner. The Coach can then enter data into the pre-defined fields. The Coach then selects Save wherein the system 10 saves the information and notifies the Compliance Office (CO) of any changes. However, if the User entered invalid information the system displays what information is invalid and allows the User to modify what they entered.

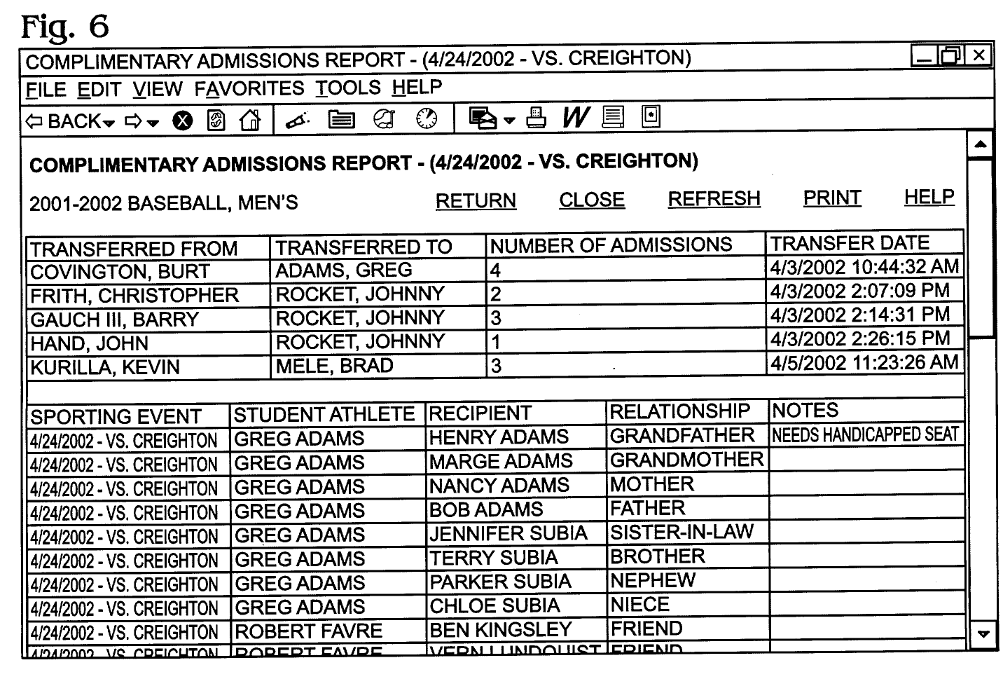

A Coach can modify data previously saved by them in a CTI. If the form has an expiration date they are not able to edit the information associated with the form, as shown in FIG. 5. The Coach selects the Compliance Toolbox Items that are desired. From the library of editable CTIs already filled in by the Coach, as part of a first database, the Coach selects the CTI to modify and then selects Modify. The CTI will then be presented in a editable manner with the current information in the fields. The Coach can then modify the data in the pre-defined fields. When Save is selected the information is saved. However, if the User entered invalid information the system displays what information is invalid and allows the User to modify what was entered.

A Coach can view their sport specific calendar as shown in FIG. 3. The institution or organization must have at least one blueprint defined for the sport and a User assigned as a Coach to the sport. The Coach selects to work with their calendar. A monthly view of the calendar is presented which displays any sport specific items entered in the sports blueprint, for example, competitions, first day of class, days of final exams, last day of class and the like. To view an item the User determines the item on the calendar they wish to see and selects View. Four fields are displayed and available for an update. The first field includes the start date and the time of the event. The second field includes the end date and the time of the event. The third field includes a description of the event and the final field includes the location of the event. To reject an item the User determines the item they wish to reject and selects Reject. The system 10 then sends a notification to the compliance office that the Coach rejected the calendar item. However, if the User entered invalid information the system displays what information is not valid and allows the User to modify what was entered.

A Coach can view and update the status of their sport specific To Do Items as shown in FIG. 3. The organization or institution must have at least one blueprint defined for the sport and a User assigned as a Coach to the sport. The Coach selects to work with their To Do Items. The system displays a list of To Do Items that are assigned to the Coach. To view the details the Coach selects a To Do Item from their list of To Do Items and selects View. The system displays the details of the To Do Item. Any Compliance Toolbox item(s) associated with this To Do Item are also presented including direct links to them if the Coach wishes to view them. Any National Collegiate Athletic Association rules, from the second database, associated with this item are displayed along with hyperlinks to view the rule. To update the status of a To Do Item the Coach determines the item they wish to update and selects Update Status. A list of possible status items are then presented and the Coach can either select a new status, save the new status or cancel this action.

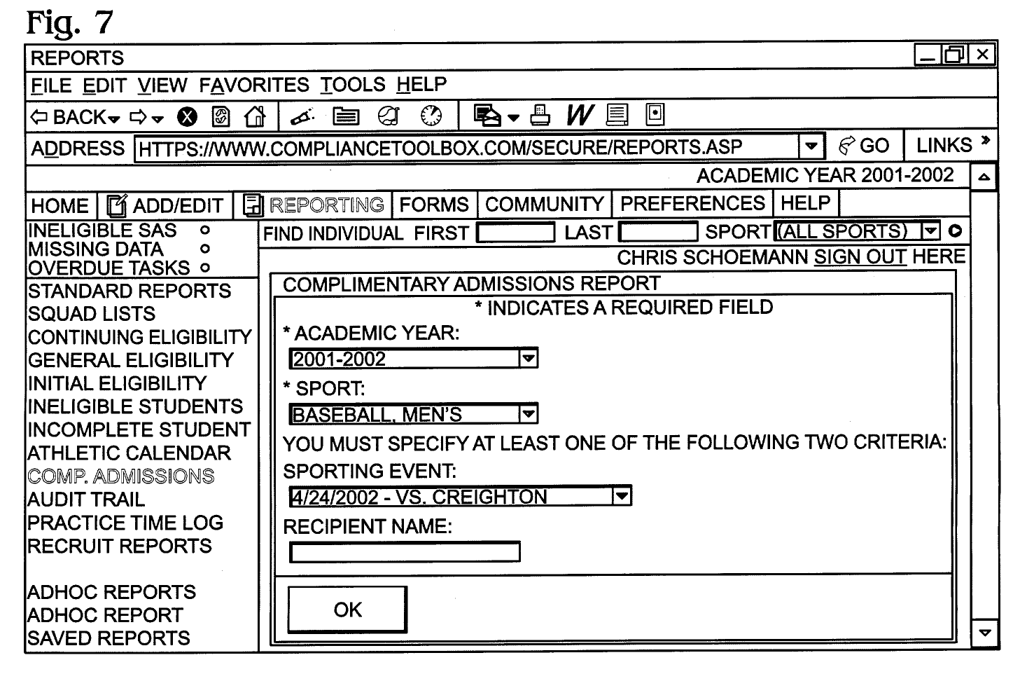

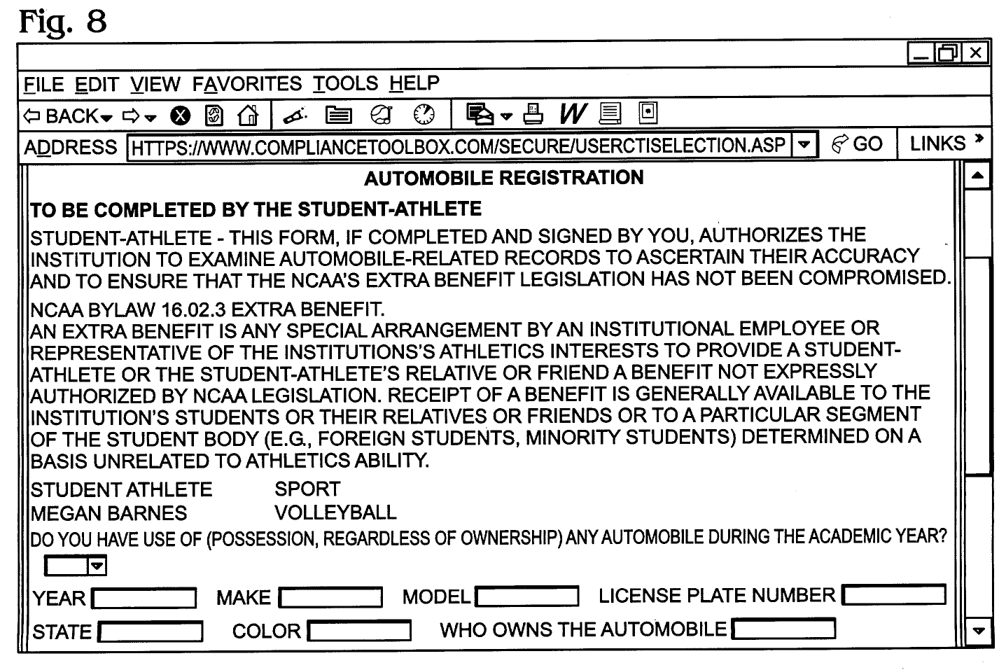

A Coach can view standard reports assigned to their sport as shown in FIG. 6. However, the organization or institution must have at least one blueprint defined for the sport and a User assigned as a Coach to the sport. The Coach selects to work with the Standard Reports and the system displays a list of standard reports as shown in FIG. 7. To view a report the desired report is chosen. The Coach selects View Report and the system will display the report. To print a report the Coach uses the browser's printing functionality.

A User sees the Main Page after logging in as shown in FIG. 3. The system presents an Outlook Today type summary of the User's current workload. This includes What's New items intended for User viewing, a Calendar of upcoming events, a To Do List and an Audit Trail Summary. Two classes of What's New items are displayed. The first class is generated by the site administrator. For these items the User can indicate which user roles at their institution or organization have access to view the item. The available roles include compliance office, coach and the student-athlete. The second class is generated by the User. For these items the User can indicate which user roles have access to view them. Additionally, the User can edit the content of these items by using the Add/Edit What's New item. Furthermore, the User can select to add a What's New item by using the Add/Edit What's New item. The calendar of upcoming events includes sporting events and any calendar events the User has added. From the calendar the User can choose to modify existing events or add new calendar events by using the Add/Edit Calendar Event. Finally, the To Do List is a monthly view where the User can select an individual To Do Item to view/maintain the item. The User may add new To Do Items by using the Maintain Tasks within the To Do Items. This leads to the Audit Trail Summary.

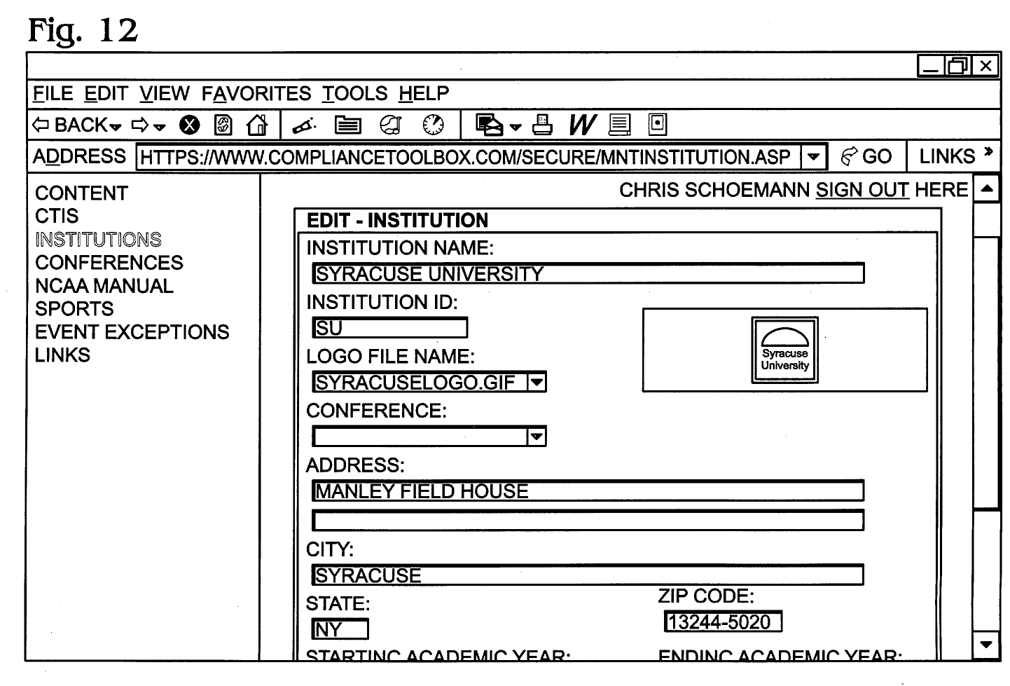

The Audit Trail Summary is a summary of changes that were made to CTI's within the last day. The summary includes a listing of sports for which CTI's were modified within the last day. The User can select a sport to drill down into more detail on what was modified. Upon selecting a sport the system performs an automated Audit Trail Search using the current academic year's blueprint, the selected sport, a From date value of current date minus one date and a To date value of the current date. The system then directs the User to view the search results by using the View Audit Trail Search Results as shown in FIG. 10. Also, the User can select to hide the Audit Trail Summary for the day. Furthermore, the system no longer displays the Audit Trail Summary on the Main Page for that day. The next day the system once again displays the Audit Trail Summary. Finally, the User can select to show the Audit Trail Summary if it has been hidden. The system then displays the Audit Trail Summary on the Main Page. However, if the institution or organization associated with the User does not yet have a blueprint setup for the current academic year the system will display a message indicating this and direct the User to begin setting up their blueprint.

On the Main Page the system presents a Menu Bar of eight items the User can choose from as shown in FIG. 3. The first item is the Main which directs the User to the Main Page. The second item is Compliance Forms that directs the User to view the list of available compliance forms. The third item is Reports that directs the User to the list of available reports. The fourth item is Blueprint that directs the User to perform setup/maintenance activities on their institutions/organizations blueprints. The fifth item is User Profiles that directs the User to perform setup/maintenance on the user profiles that exists for their institution/organization. The sixth item is Forum that directs the User to the Compliance Toolbox message forum. Furthermore, the seventh item is My Profile that directs the User to perform maintenance on their user profile. Finally, the last item is Logoff where the system logs the User out of the Compliance Toolbox web site. However, if any of the preconditions are not met the system will display an error message and prompt the User to modify or add the information that is required for the system to operate.

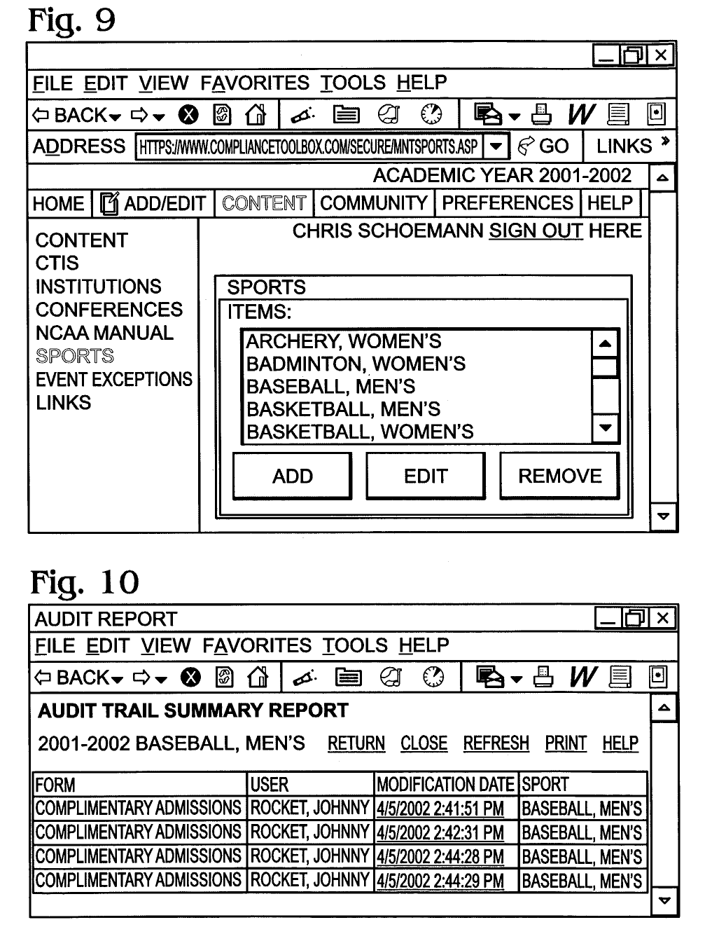

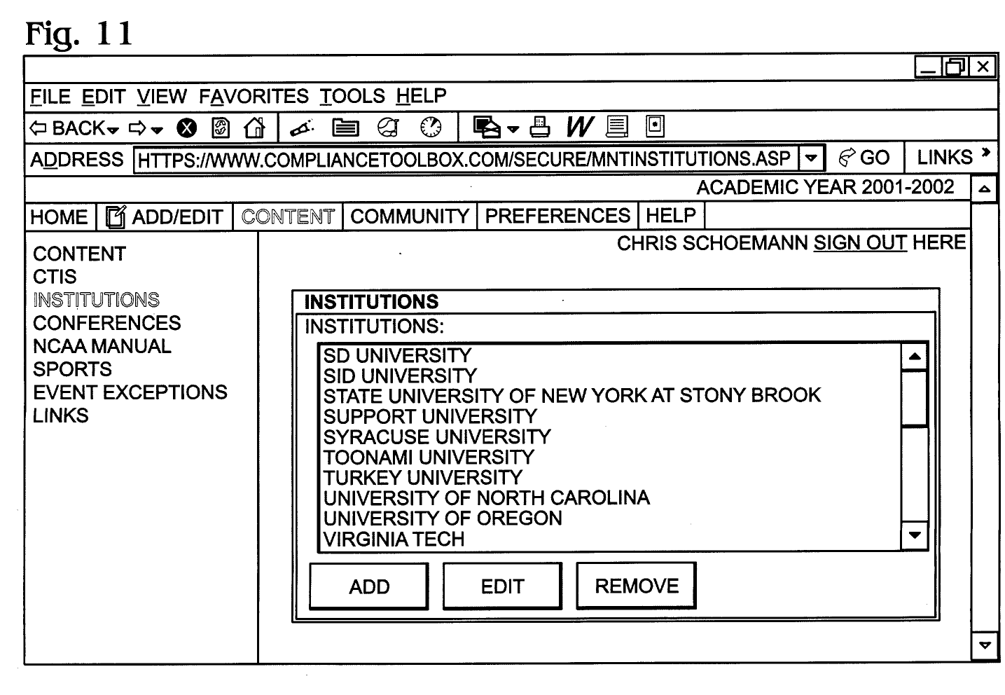

The User specifies criteria used to display Audit Trail information on a CTI as shown in FIG. 8. This is preconditioned on the User having successfully logged into the Compliance Toolbox web site and the User's associated institution/organization has at least one blueprint defined. The system presents a screen with three search criteria. The first criteria is what sport to search. The system presents a Select List of sports as shown in FIG. 9. The list contains all sports that have been defined in any of the blueprints. The second criteria is what the User is to search. The system provides the ability to search for and select a user type defined for the institution or organization. The third criteria is the date range. This allows the User to specify a From and To date range for the search. The dates allow for the specification of the month, day and year for each value. On initial load the system defaults the To value to the current date and the From value to the current date minus one day. The next step is for the User to select one or both of A Sport or A User. The User must then supply a From date. The To date can be left blank which the system understands to indicate that the current date should be used. Finally, the User selects Search and the system validates the entered search criteria. The validations performed include a Sport and/or User have been specified and a From date was specified in the format of MM/DD/YYYY. If all values are valid the system performs the specified search and present the results to the User by using View Audit Trail Search Results. However, if any of the preconditions are not met the system displays an error message. Consequently, if the search criteria is not valid the system presents the User with error messages indicating the error and allows the User to modify the values and resubmit.

The User views search results of an Audit Trail on a CTI. The precondition to search is that the User has logged into the Compliance Toolbox website, the User's associated institution or organization has at least one blueprint defined and the system as performed an Audit Trail search. The system presents a listing of the Audit Trail search results as shown in FIG. 10. By default the results are sorted by date of change in descending order, academic year in descending order and User by ascending order. Each search hit information displayed includes, date of change accurate to the second, the academic year in which the change was made, the User that made the change, the CTI that was modified, the associated sport(s) and a summary of changes. The summary of changes include a list of the fields in the CTI that were modified. Also, the User can choose to sort the list by date of change accurate to the second, the academic year, the User that made the change, the CTI that was modified and associated sport(s). From this page the User can choose to perform a new search or to modify the search they just performed. Furthermore, the User can select an individual search result and view more detail on the associated change. This detail includes date of change accurate to the second, the academic year the change was made, the CTI that was modified, the User that made the change including their full name and the associated sport(s). Further details include a listing of the fields in the CTI that were changed and their “before” and “after” values. From this page the system provides the User with the ability to navigate back to the search results listing screen. However, if any of the preconditions have not been met the system displays an error message. Consequently, if there are no search results to display the system presents a message indicating this.

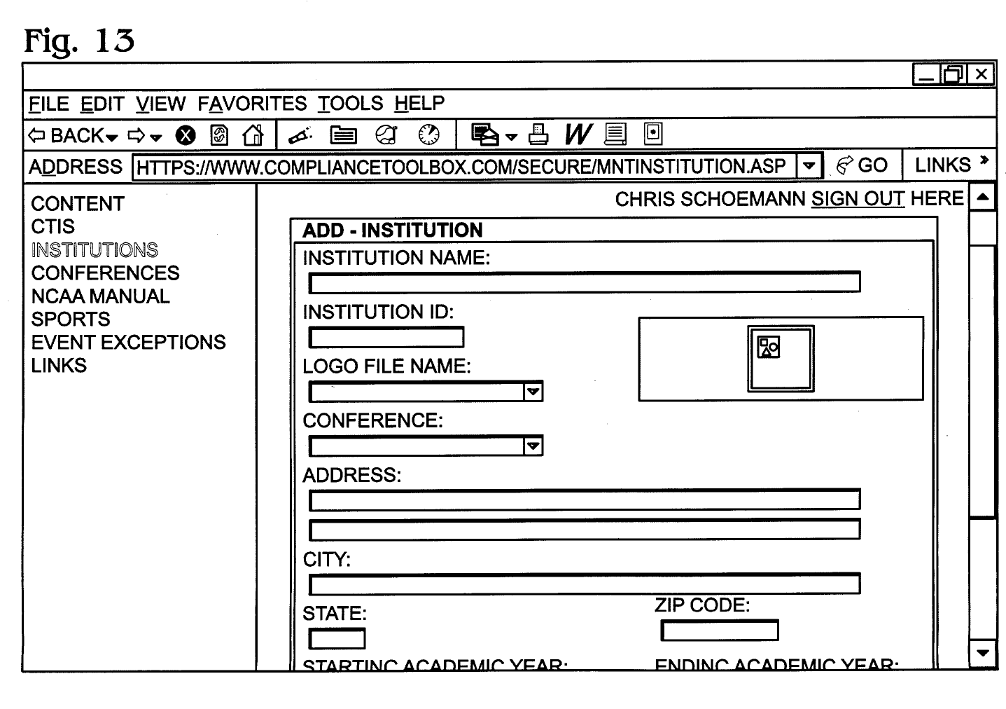

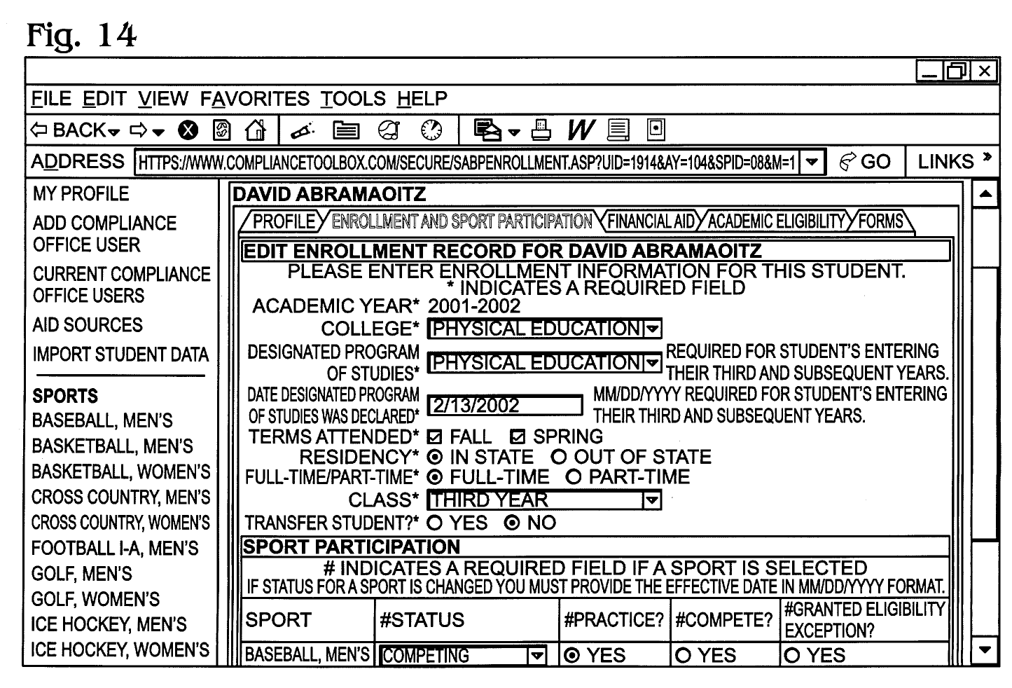

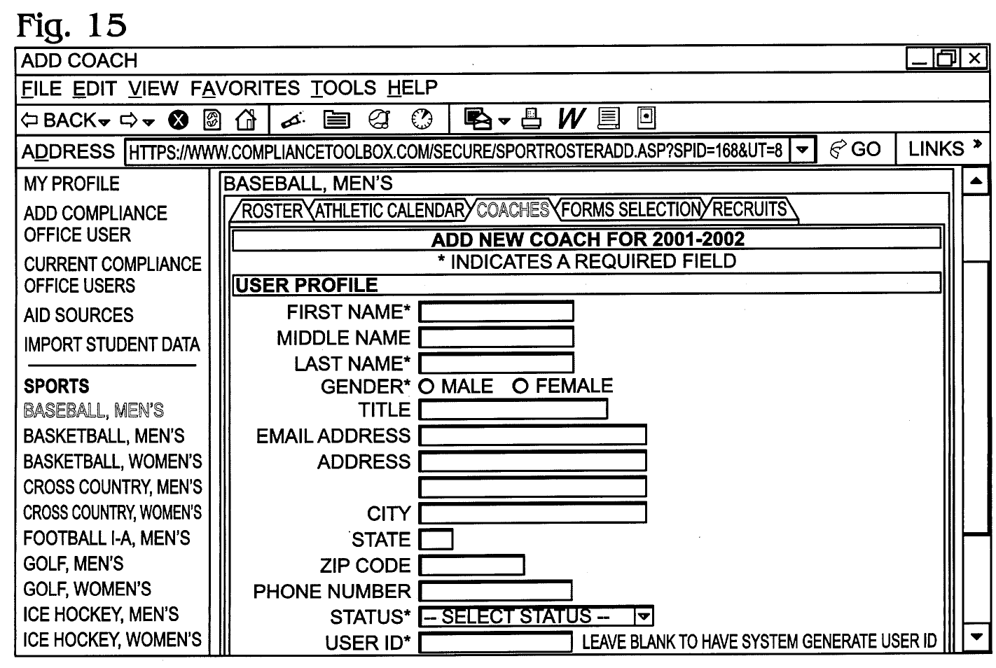

FIG. 11 shows the Maintain Institutional User Profile Page. The compliance office (CO) User performs required maintenance activities on the user types that have been defined for their institution after the CO has logged into the system. As is understood by the practitioner in the art a system administrator has the ability to also perform these maintenance activities. The CO then selects Maintain User Profiles. The system then presents the CO with a screen that allows them to search for institution user profiles. The search criteria includes the first name, the last name, the user type further comprised of all, compliance office, coach, student and status that is comprised of all, active or inactive. Next, the CO fills in the desired search criteria and selects Search. Using the supplied search criteria the system first verifies that the result set does not contain over 100 records. The system then performs the search for the institution user profile(s) matching the supplied search criteria and presents the CO with a listing of the results. The listing contains four search columns including first name, last name, the date the profile was added to the institution in MM/DD/YYYY format, the user type and status. By default the listing is initially ordered by first name, last name, the date the profile was added to the institution, user type and status. Additionally the system provides the capability to sort this list by the criteria of first name, last name, the date the profile was added, user type and status. Furthermore, the CO can select Profile to modify it and the modification can include editing and deletion by using Edit Institution User Profile as shown in FIG. 12.. Finally, from the Edit Institution User Profile Page the CO can choose to add a user profile by using Add Institution User Profile as shown in FIG. 13. However, if any of the preconditions are not met the system displays an error message. Also, if the search result set is over 100 the system redisplays the search screen with an error message indicating that the CO should refine the search criteria to narrow the search result set. If no search results are found the system redisplays the search screen with an error message indicating that no matching results were found.

In another aspect of the invention the User adds a user profile, to their institution or organization, after the User has logged into the system. The system presents the User with a screen to collect the information pertaining to what is desired to be added as shown in FIG. 13. The User selects the type of user they wish to add to the blueprint that includes compliance office administrator, compliance office, coach and student-athlete. Depending on the type of user selected, a screen or field is presented to allow the User to enter appropriate information. At a minimum the fields include first name, last name, gender, title, email address, phone number, comments and status, wherein the first name, last name, gender, email address and status are required fields. The Status field is an indication of the users status. Depending on the type of the user profile the list of valid values varies. For student athletes the status includes active, academically ineligible, graduated or mid-year graduate. The Coach status field includes active or inactive and the compliance office status includes active or inactive.

There are additional required fields including system user id, system password and verify system password. Another field is whether a user should be added to this year or next year's blueprint or not added to a blueprint at all. The system provides the ability to add a user to the current blueprint year or the next blueprint year if the institution or organization has defined these blueprints. The User is not required to make this selection and they can add a user that is not tied to any blueprint. The system defaults to select the Add To This Year's Blueprint field. However, if the user type is a student-athlete the system prompts additional fields including international student, was the student recruited, the student's qualifications out of high school, transfer student or not, student identification number and designated program of studies. In the field of the student's qualifications out of high school the User selects the student athlete's qualification out of high school. The system provides a list of allowed values including qualifier, partial qualifier and non qualifier. Under transfer student the fields are yes or no. The User selects whether the student-athlete is a transfer student. The student identification number field is required if the user type is a student-athlete, otherwise the field is not used. The User provides an institution specific identification number for the student that consists of alphanumeric characters. Also, under the designated program of studies field the User provides the student athlete's designated program of studies toward a specific degree program. This is not a required field until the student athletes 3rd year of enrollment.

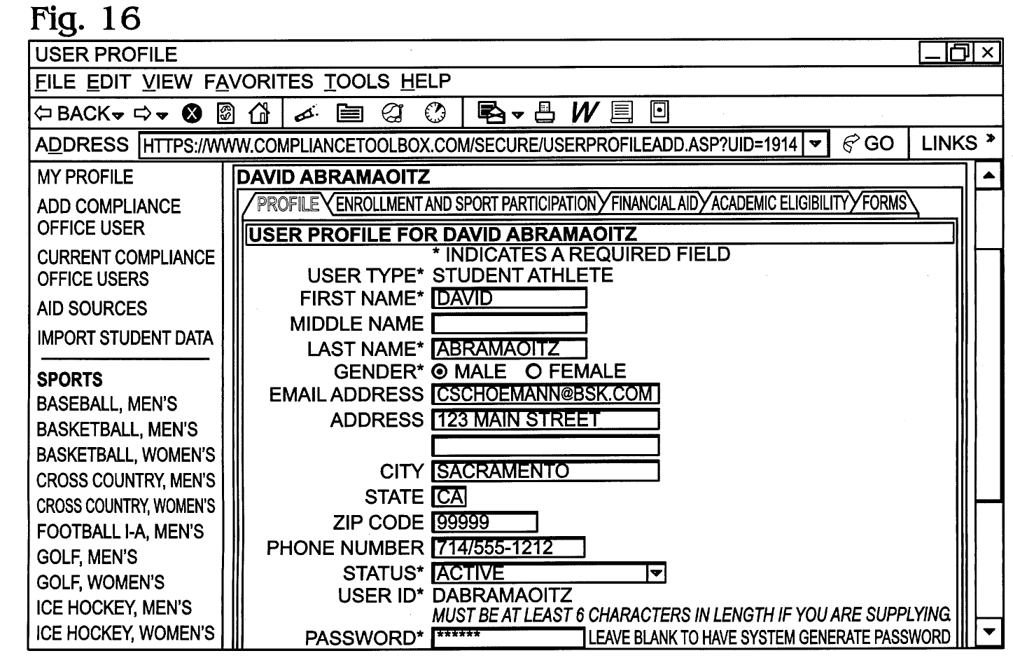

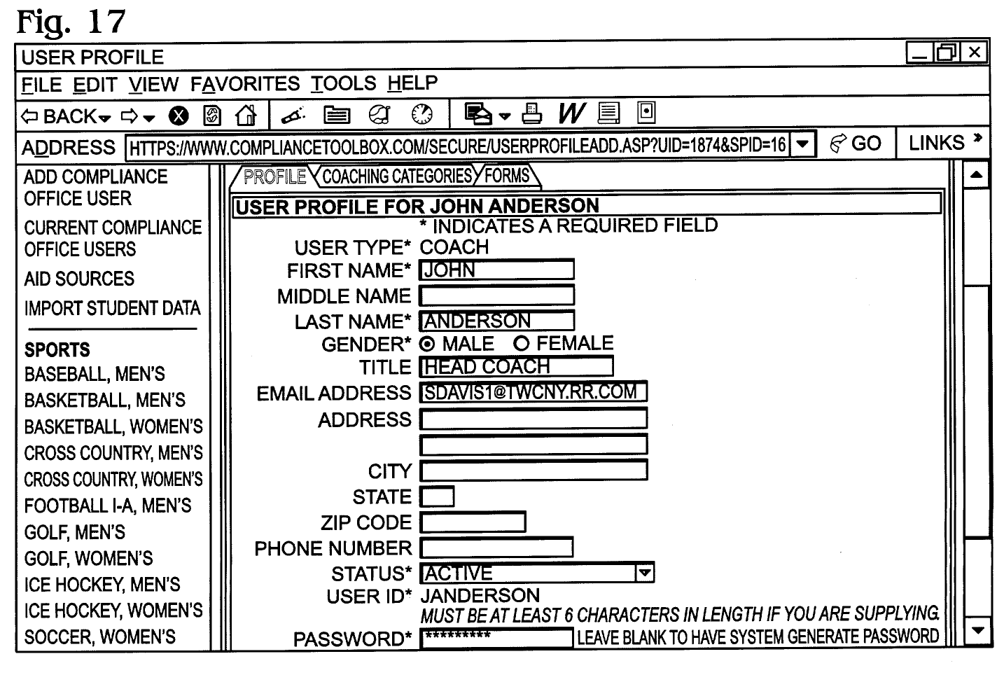

The User then selects to save the user profile. The system then validates the entered information and if valid adds the user profile to the institution or organization. If a student-athlete was added by the User the system directs the User to a screen where they can provide the students enrollment history, as shown in FIG. 14. If the User chooses to add another user type to the blueprint the system directs the User to the appropriate next screen that is dependent on the user type. For a example, a coach would be directed to Add Coach to Blueprint as shown in FIG. 15. Furthermore, if the User did not choose to add another user type to a blueprint the system warns the User that another individual was not added to a blueprint. It directs the User back to the Add User Profile screen so the User can continue to add additional user profiles. However, if any of the preconditions are not met the system displays an error message. Also, if validations of the user profile information fail the system provides error messages indicating what corrections are needed. The User then has the option to correct the data and resubmit. Finally, if the User opted to add another individual to a blueprint when the blueprint was not set up the system notifies the User of this and provides the User an opportunity to not add another user profile to the blueprint.

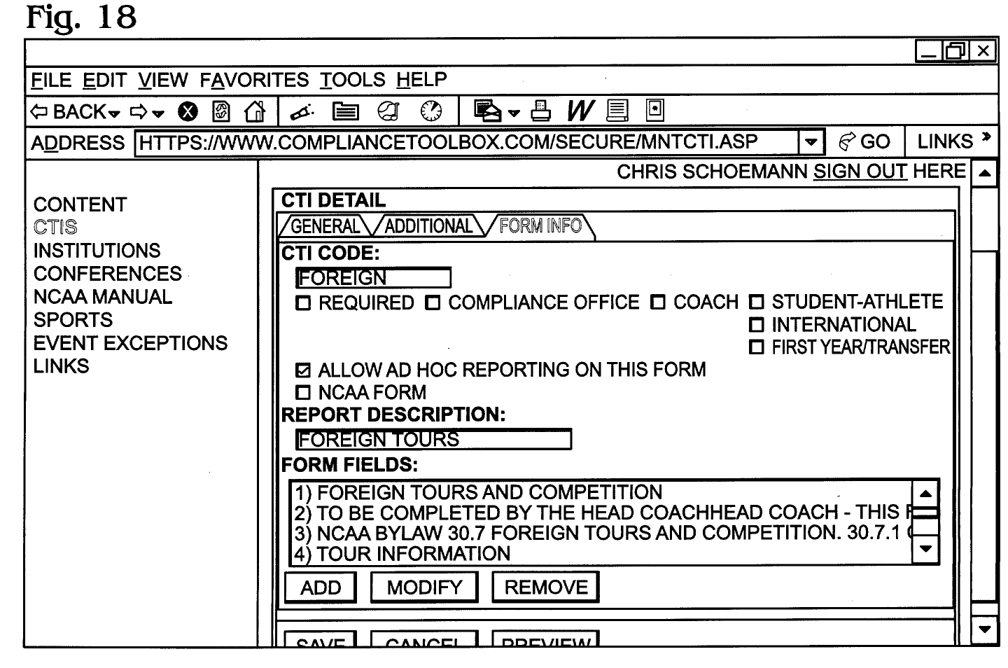

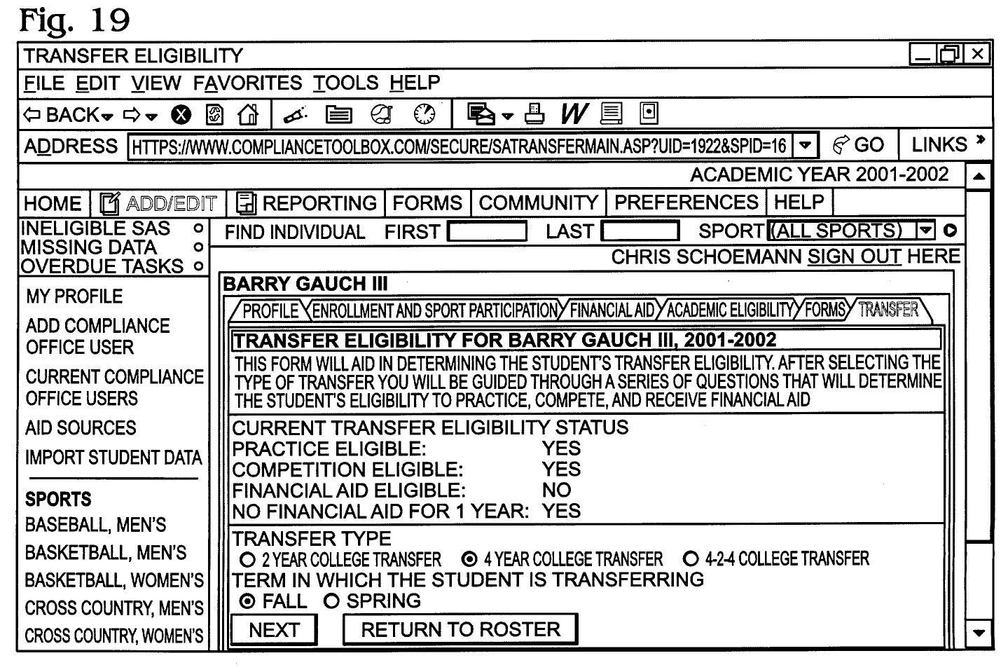

A User is able to edit an institution or organization profile after the User has logged in and the selected user profile is already known. Depending on the type of the user profile, for example, coach or student-athlete, a screen is presented to allow the User to edit information. There are several fields including those that are required to allow the Edit Institution User Profile text and provide the system editing features as shown in FIG. 12. The required fields include first name, last name, gender, e-mail address and status. The non-required fields are title, phone number, comments, system password and verify system password. Furthermore, status is an indication of the users status and depending on the user type profile the list of valid values varies. The values include for student athletes, active, academically ineligible, graduated, or mid-year graduate. For the Coach and CO the values include active or inactive. The system additionally presents a list of blueprints where the user profile is contained. The User selects one of the blueprints to edit the blueprint specific information on another individual. Depending on the type of the user's profile the system directs the User to the appropriate screen. This includes for student athletes the Edit Student Athlete in Blueprint, as shown in FIG. 16, or for coaches the Edit Coach in Blueprint as shown in FIG. 17. Selecting a blueprint year causes the system to validate any edited user profile information and save it before directing the User to the user type blueprint information.

If the User is a student-athlete there are additional fields that are editable. One field includes international student whereby the User selects whether the student-athlete is an international student. Another field includes was the student recruited whereby the User selects whether the student-athlete was recruited. Yet another field includes transfer student whereby the User selects whether the student-athlete was a transfer student. Still yet another field includes the student's qualification out of high school whereby the User selects values such as qualifier, partial qualifier and non qualifier. Furthermore, the student-athlete fields include student identification number and designated program of studies. The student identification number field is required if the user type is a student-athlete, otherwise it is not used. The User provides an institution/organization specific identification number for the student that consists of alphanumeric characters. Finally, the User provides the student athlete's designated program of studies toward a specific degree program. This is not a required field until the student athlete's 3rd year of enrollment.

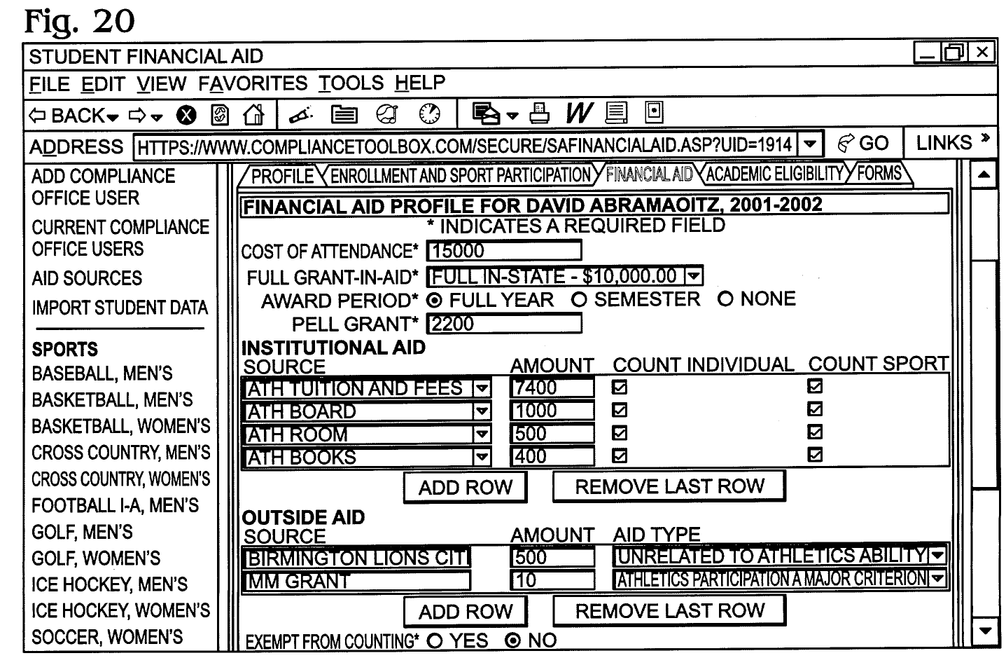

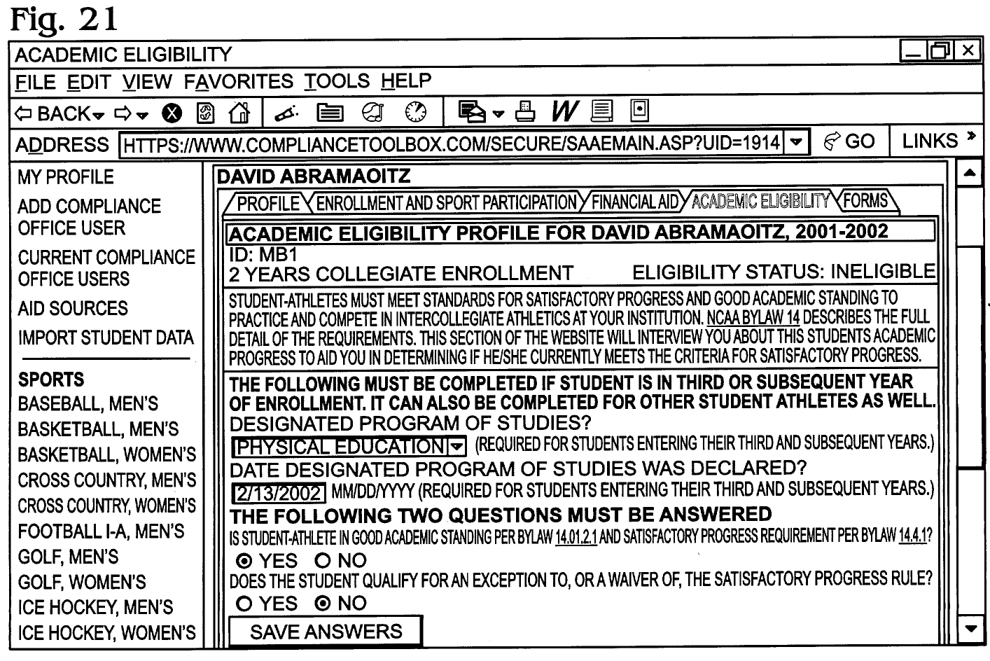

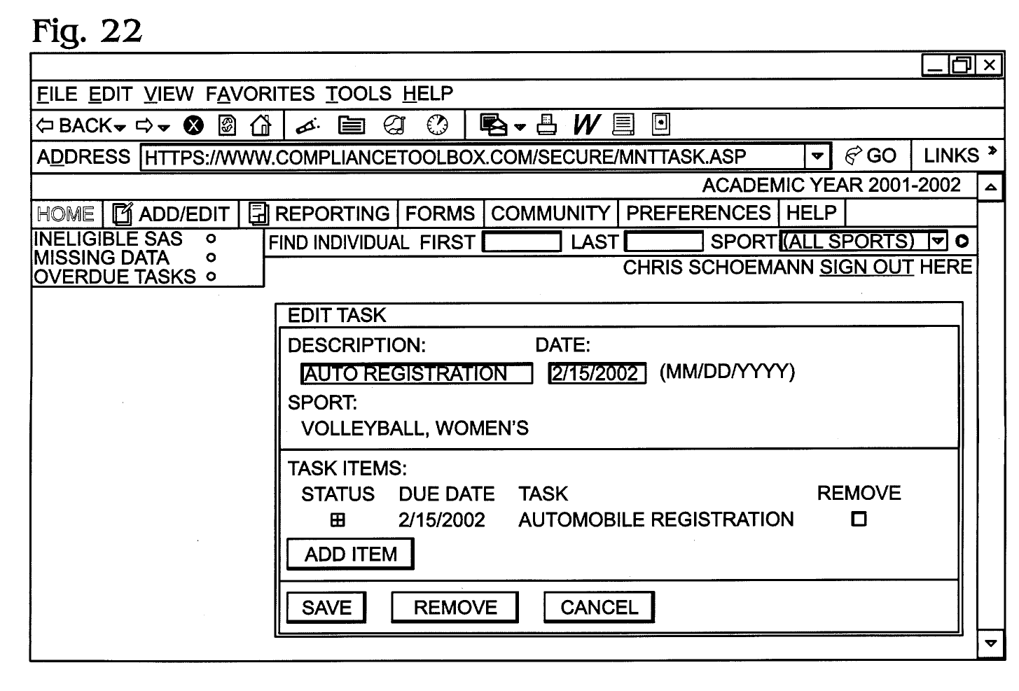

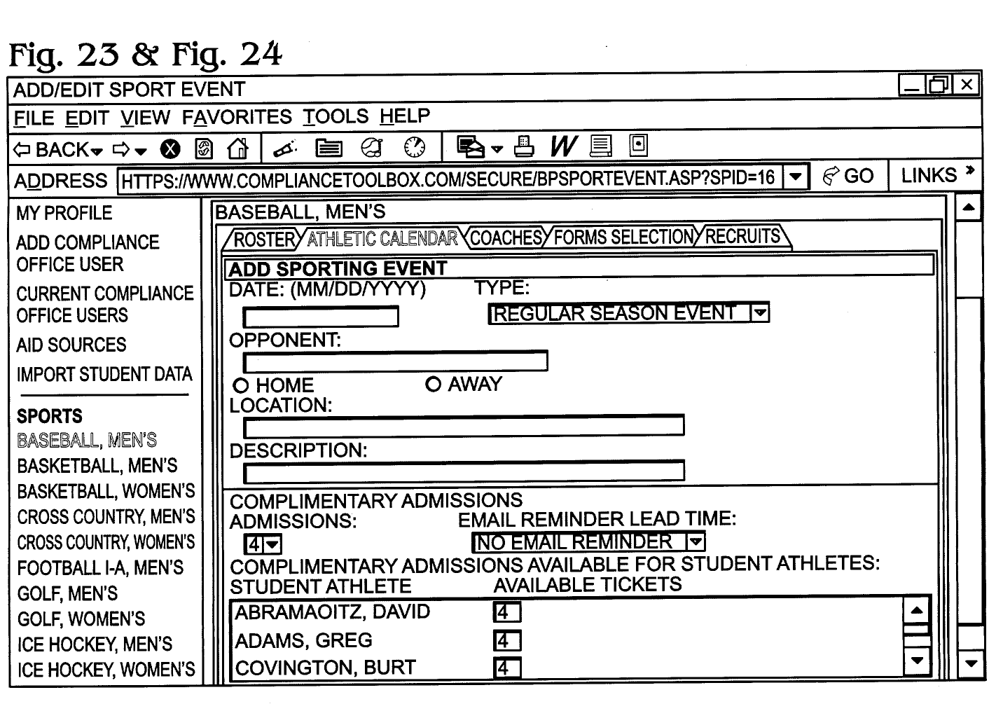

If a user type has been added to the institution/organization blueprint for the current academic year the CTI information is available on the View/Edit CTI Information menu, as shown in FIG. 18. Additionally, if the User is a student-athlete the system provides several menu selections. The first selection is Transfer Eligibility as shown in FIG. 19. This menu option is only available if the student is a transfer student for the current academic year. The second selection is Enrollment History as shown in FIG. 14. The third selection is the Blueprint Record as shown in FIG. 16. This menu option is only displayed if the student athlete has been added to the institution's/organization's blueprint for the current academic year. The fourth selection is for Financial Aid Information as shown in FIG. 20. This menu option is only displayed if the student-athlete has been added to the institution's/organization's blueprint for the current academic year. The fifth selection is for Academic Eligibility Information as shown in FIG. 21. This menu option is only displayed if three criteria are met including the student-athlete is not a transfer student, the student-athlete has been added to the institution's blueprint for the current academic year and the student athlete is not a first year student. Furthermore, the User can choose to save the user profile information. The system validates the user profile information and if valid saves the information to the first database and directs the User back to the user profile maintenance screen. Alternatively, the User can choose to delete the user profile. The system validates that the selected user profile can be deleted and if so marks the user profile as inactive. The system does not physically delete the profile but only logically deletes it. However, if any of the system preconditions are not met the system displays an error message. If validations of the user profile information fail the system provides error messages indicating what corrections are required. The User has the option to correct the data and resubmit.

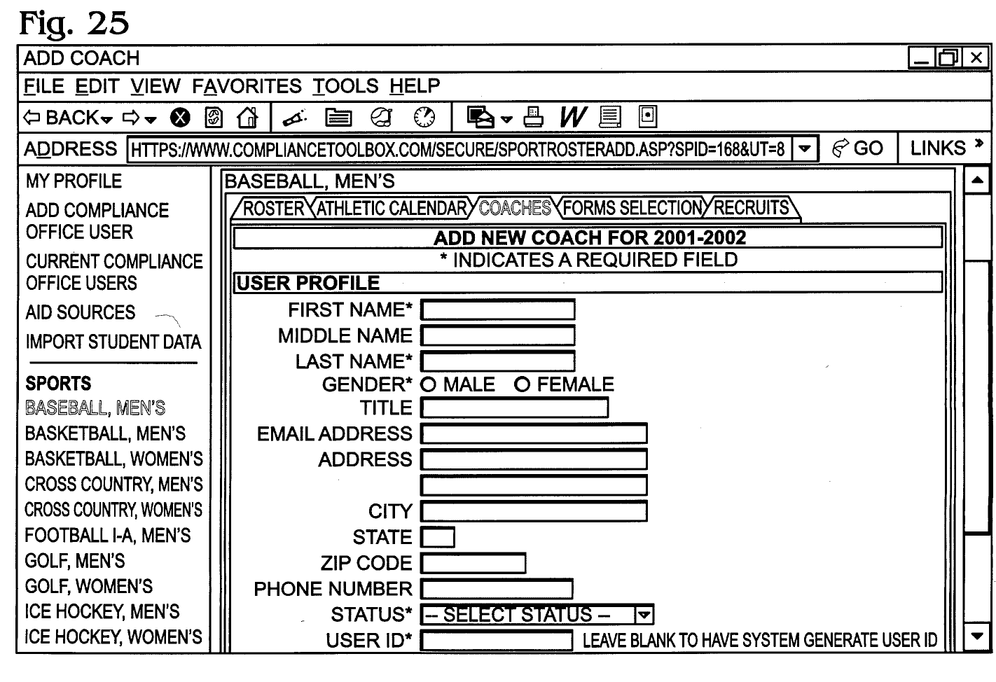

A User can maintain and schedule tasks of To Do Items, for the coaches of their assigned institution, after the user id is logged into the Compliance Toolbox application with privileges as shown in FIG. 3. The User selects the Main Page and the system will display the default CO Main Page. The tasks of To Do Items for the next 30 days will be displayed as one of the sections of the Main Page. To add a task the User selects Add and the system displays the Add A Task Item screen as shown in FIG. 22. At this point the User enters the task details that include a description and which sport to assign the task to. Next, the User enters the task items that include the due date, which is the date the To Do Item should be completed by and the task that is either a system CTI or a manual task. For CTIs the system will update the status automatically while the manual tasks the User can update the status manually. To complete entering of the task items the User selects Save and the system saves the information and returns to the To Do Item list. Furthermore, to modify a task item the User selects the task. The User modifies the task item detail, updates that the status of the task is complete and selects Save wherein the system updates the task information. Alternately, to delete a task item the User selects the task and then selects Delete wherein the system deletes the item. However, while adding or modifying if the User entered invalid information the system displays what information is invalid and allows the User to modify what was entered.

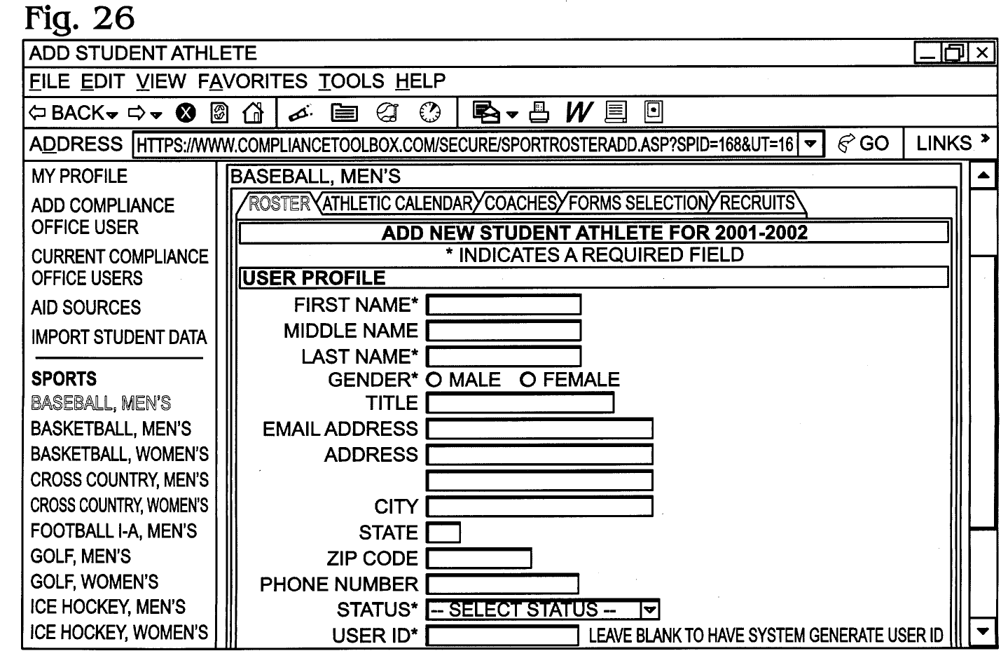

An institution's or organization's compliance office (CO), or authorized User, performs the initial setup of a Compliance Toolbox blueprint. But the institution that the CO is associated with must be defined in the system and the CO has been issued a user identification and password before the initial setup of a blueprint can commence. Also, the CO must be logged into the system. If the CO's associated institution has a blueprint set up from the previous year, the CO can opt to setup the new blueprint based on a copy of the previous academic year's blueprint as shown in FIG. 23. The system presents the CO with the option to Copy Blueprint From Last Year. If there is not a blueprint from the previous year, or the CO opts not to copy the previous year's blueprint, the system presents the CO with the initial blueprint creation screen that is prompted with various information. A Warning Message is one prompt that indicates to the User that they will not be able to edit their information after entering it. They must make sure the information is correct before entering it. Another prompt is the Active Academic Year, that is not editable, and defaults to the current active academic year as defined by the site administrator. A third prompt is the National Collegiate Athletic Association Divisional Status that is selected from a list of the system defined divisional statuses. Also, Academic Calendar is another prompt. This includes the first day and last day of classes. The fifth prompt Sponsored Sports is selected from a list of defined sports. Yet other prompts indicate whether the institution is semester based, quarter based and the start and end dates of the terms. An eighth prompt provides final exam information. This includes term 1, term 2 and term 3 if the institution is quarter based and the dates of the start and end of the final exams. Furthermore, other prompts include full grant-in-aid definitions and other countable institutional aid definitions. The CO can create as many full grant-in-aid definitions as required. For each, the definition information required includes grant description, grant amount and the number of hours on which the tuition and fees are based. The CO can create as many other countable institutional aid definitions as required. For each, the definition information required includes the countable institutional aid description. Finally, the CO fills in the required data and mouse clicks the screen to save the information. The system validates the data and if valid presents the CO with a confirmation screen. This gives the CO the option of going back to edit the entered data or to confirm the information. If confirmed the system will present the next screen.

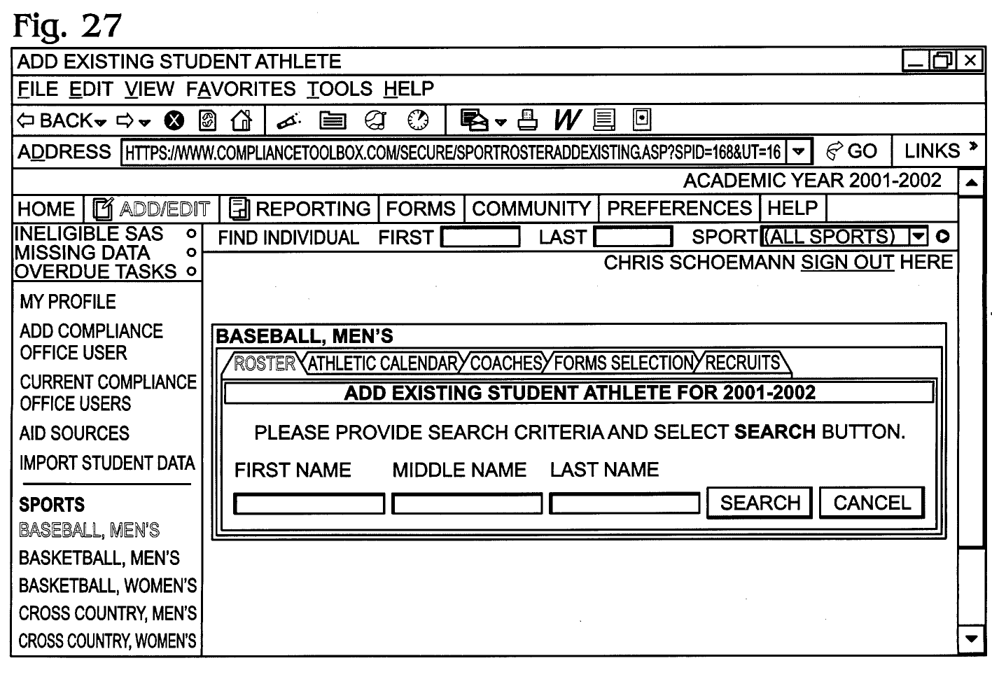

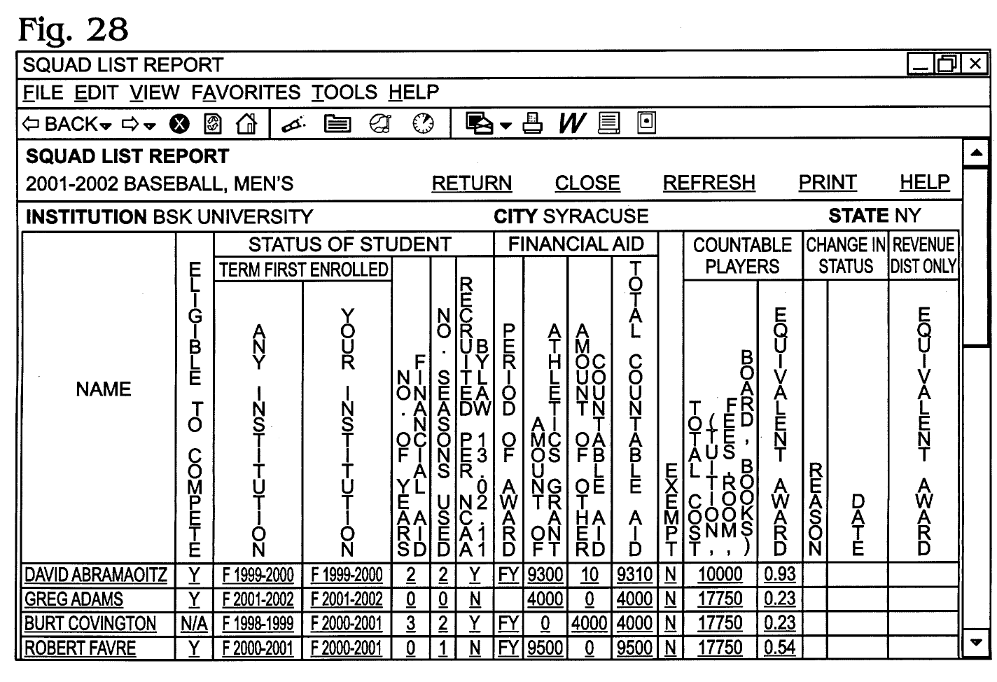

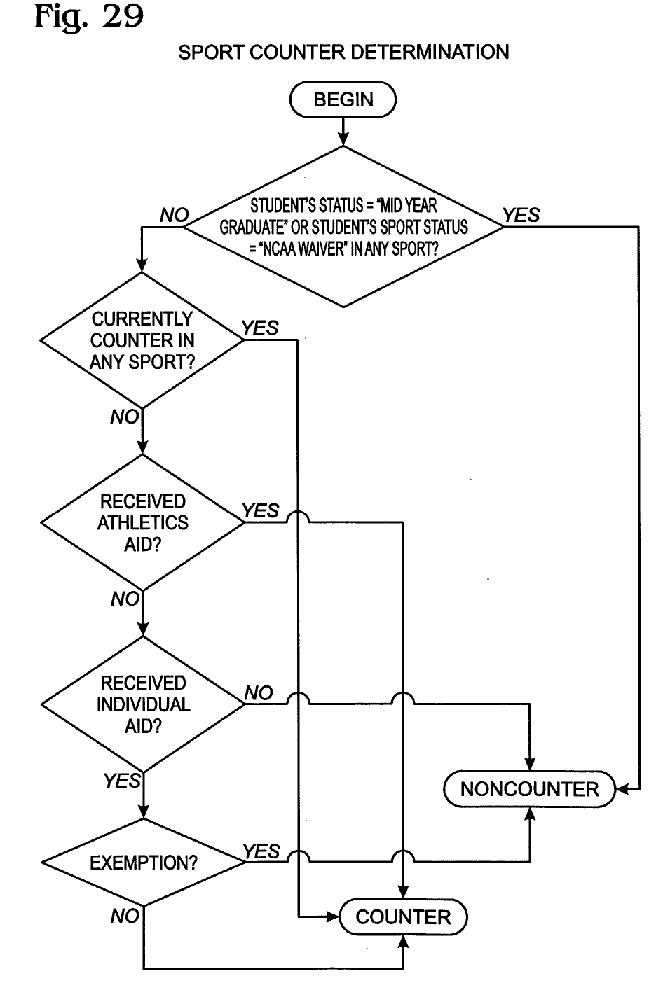

For each sport the CO has added to the blueprint the system presents a screen to prompt the CO for various information. This includes sport divisional status wherein institutions can only sponsor up in divisional status but not down, the date of first practice, the date of eligibility meeting, the date of the first contest/date of competition and the date of the conference championship. Further screens include the number of sport segments that can be either 1 or 2, the dates of sport's events that can be entered later, as shown in FIG. 24, and the coaching roster whereby the CO can choose to define the coaches for the team as shown in FIG. 25. A student athlete roster is also an available screen wherebyn the CO can choose to define the student athletes for the team as shown in FIG. 26. The CO fills in the required data and mouse clicks to save the information. The system validates the data and if valid saves the data and directs the CO back to the sport setup screen so they can continue to setup additional sports. There are some sports for which specialized screens are presented to collect additional data, for example, football and men's basketball. When the CO is completely done entering the data for all sports they select a Go To Next Step screen.

The system provides the capability for the CO to add the colleges that make up their institution. For each college the system prompts for information including college name, the number of credit hours required for graduation by students and the minimum grade point average (GPA) required for graduation. After filling in the data the CO selects to save the information. The system validates the data and if valid saves the information wherein the system then presents the CO with an opportunity to add additional colleges. The CO can continue to add colleges until all have been defined. The CO then indicates that they are finished and have no more colleges to add. Finally, the system presents the CO with a screen indicating blueprint setup is complete and that additional maintenance can be performed if necessary. The system provides a link to the blueprint maintenance screen. However, if any preconditions are not met the system displays an error message. If any validations fail the system presents error messages describing what is wrong with the entered data. The CO is then given the opportunity to make corrections and to resubmit the data.

The compliance office (CO), or authorized User, maintains the institution's defined blueprints wherein the institution must have at least one blueprint defined. The CO can choose to perform blueprint maintenance. By default the system presents the CO with the blueprint maintenance screen for the current academic year. The CO has the option of choosing a different academic year. However, the CO cannot delete a blueprint once it has been created. The CO can view but cannot edit basic information of the blueprint. This includes the National Collegiate Athletic Association divisional status, selected sports, academic calendar of the first and last day of classes, whether the institution is semester or quarter based and the starting/ending dates of the terms. Further information that is not editable includes final exam information for each term specifying the start and stop date of final exams, full grant-in-aid definitions and other countable institutional aid information. Under the grant-in-aid information grant description, grant amount and the number of hours on which the tuition fees are based are not editable. Furthermore, the description of other countable institutional aid information is not editable.

The CO can choose to add additional sports to the blueprint. If any sports are added to the blueprint for each sport the system presents a screen to prompt the CO for information. The fields include sport divisional status if different from the institutions, date of first practice, date of the eligibility meeting, date of the first contest/date of competition, date of the conference championship and either 1 or 2 sport segments. Further fields include the dates of sport's events, as shown in FIG. 24, and the coaching roster whereby the CO can choose to modify/define the coaches for the team as shown in FIG. 25. The student athlete roster is another field whereby the CO can choose to define/modify the student athletes for the team as shown in FIG. 26. The CO fills in the required data and clicks a mouse to save the information. The system validates the data and if valid saves the data and directs the CO back to the blueprint maintenance screen. There are some sports for which specialized screens are presented to collect additional required data, for example, football and men's basketball.

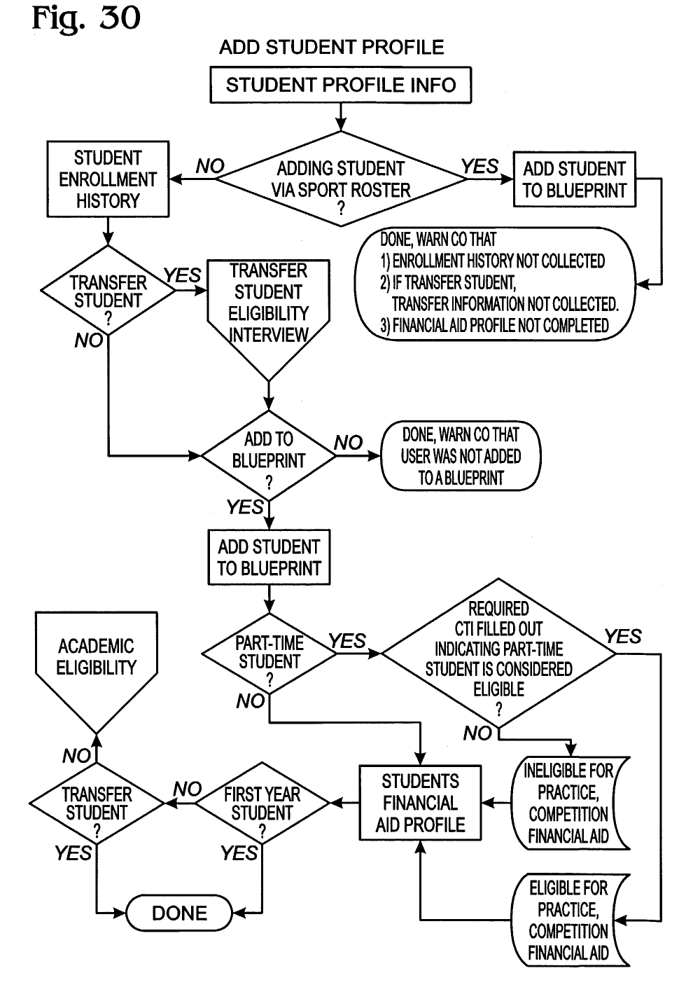

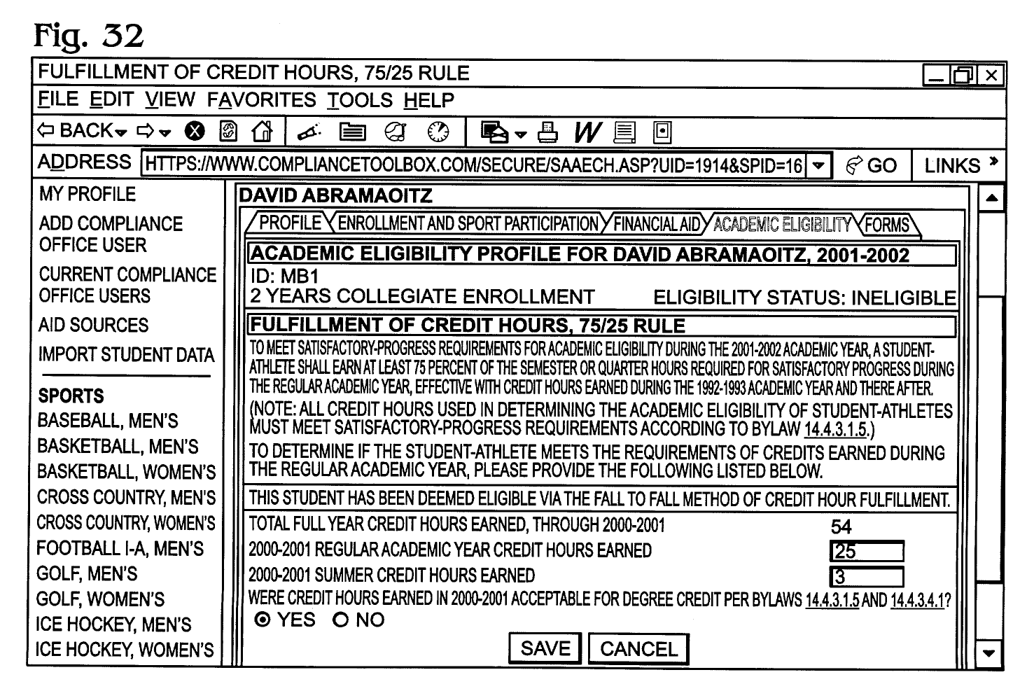

For each sport defined in the blueprint the system provides an indication if all required information for the sport's setup has been provided. The CO can choose to edit particular information for any sport. The fields include the sport divisional status if different than the institutions, date of first practice, date of the eligibility meeting, date of the first contest, date of the conference championship and either 1 or 2 number of sport segments. Further fields include the coaching roster whereby the CO can choose to define/modify the coaches for the team, as shown in FIG. 25, and the student athletic roster whereby the CO can choose to define/modify the student athletes for the team as shown in FIG. 26. As part of this roster the system displays the status of the student's current information. The status displayed includes transfer eligibility if the student is a transfer student for the current academic year, enrollment history if the student is not a first year student in the current academic year, financial aid information and academic eligibility. The academic eligibility is not shown if the student is a first year or transfer student. Other displayed status includes dates of sport's events as shown in FIG. 24, a list of defined Compliance Toolbox Items (CTI) and a list of student athletes being recruited for the sport in the current academic year as shown in FIG. 27. Under the CTI status the CO can opt to view the CTI's or delete the current item. Additionally, the sport counter value is displayed. This value is a system calculated value. It is calculated from algorithms stored in the third database of the system 10 as shown in FIG. 2. This field is not editable but displayed only for informational purposes. The sport counter value determination is shown as a flowchart in FIG. 29. This sport counter value is the financial aid counter value summed up across all athletes that participate in a particular sport. If the sport's counter is above the National Collegiate Athletic Association limit the CO will be notified of this fact. The CO is given the opportunity to drill down into a more detailed view of the counters that make up the sport's total. The drill down will consist of a listing of students who are currently counter's in the sport and their counter values as shown in FIG. 29. The CO makes the required edits to the data and mouse clicks a screen button to save the information. The system validates the data and if valid saves the information in the blueprint. The system returns the CO to the blueprint maintenance screen.

The CO can optionally add additional colleges. The system prompts and asks for information including, college name, number of credit hours required for graduation and minimum GPA required for graduation. The CO selects to save the information and the system validates the entered data. If valid the system saves the information and directs the CO back to the blueprint maintenance screen. For each college defined for the institution the CO can choose to edit field information including college name. After filling in the data the CO selects to save the information. The system validates the data and if valid saves the information and the system then directs the CO back to the blueprint maintenance screen. However, if any of the required preconditions are not met the system displays an error message. Also, if any validations fail the system presents error messages describing what is wrong with the entered data. The CO is given the opportunity to make corrections and to resubmit the data.

A compliance office (CO)/User can choose to setup a new academic year blueprint by copying the previous year's blueprint. The preconditions to set up a new blueprint in this manner include the CO is logged into the system, the current academic year is known, there is no blueprint defined for the current academic year and the institution has a blueprint defined for the previous year. The system first auto-advances all required student records. The system goes through each student that was active at the university the previous year and updates the necessary fields. The system then determines the user profiles to copy over from the previous year's blueprint and which to exclude. The profiles include the sports participation status and the student's status. In the sports participation status profile the field is for all students that have a user profile status of active or academically ineligible. For each sport the student has participated in the system, using the third database of stored algorithms, calculates the number of years of eligibility the student has used up. The system records each sport where the student has exhausted their eligibility. The student's status is for all student athletes whose class is Senior, 5th Year Senior or Graduate. The system sets the user profile status to Graduated and excludes student profiles from the copying process when the status is either academically ineligible, graduated, mid year graduate or transferred out. All students whose sport's participation status matches particular values are not copied over and include not competing, cut/dismissed from the team, exhausted eligibility, medical exception, quit team, National Collegiate Athletic Association waiver or removed. The coaches that have a user profile status of Inactive are not copied over.

The system presents the CO with a report of all users not being copied over into the new blueprint and an explanation of why. The CO has the option of choosing to override the system to include user profiles that are going to be excluded. The system copies over core information into the new blueprint and provides the CO the opportunity to edit this information. The core information includes National Collegiate Athletic Association divisional status, selected from a list of system defined divisional statuses, and sponsored sports selected from a list of system defined sports. The sports that were part of the previous year's blueprint will already be pre-selected. Additionally, core information includes the academic calendar wherein it shows the first day of classes incremented by one year from the previous year and the last day of classes incremented by one year from the previous year.

Also, the option of whether the institution is semester or quarter based is pre-selected based on the previous year's value. Other core information includes start and end dates of terms, final exam information with dates the exams start and stop for each term, full grant-in-aid and other countable aid definitions. The full grant-in-aid definitions from the previous year are copied over. The CO can create as many full grant-in-aid definitions as required or the CO can delete the definition. The definition information includes grant description, grant amount and the number of hours on which the tuition and fees are based. Also, other countable institutional aid definitions from the previous year are copied over. The CO can create as many other countable institutional aid definitions as required or can delete the definitions.

Finally, the CO can edit the data and then save the information. The system validates the data and if valid presents the CO with a confirmation screen that gives the CO the option of going back to edit the entered data or to confirm the information. If the information is confirmed the system presents the next screen.

For any sports selected in the previous step that Were in the previous year's blueprint the system performs several functions. The first function copies over all the basic information including dates incremented by one year. Another function identifies all student athlete's that were associated With the sports from the previous year that were not on the exclude list and copies the information over into the new blueprint. A student's class function is for each student-athlete and when their information is copied over the system advances the students class standing. The advance is sequenced by first year student to sophomore, sophomore to junior, junior to senior, senior to 5th year senior and graduate to graduate. The sports events function from the previous year are not copied over. The system provides an indication if all required information for the sport's setup has been provided. The CO can choose to edit information on any sport including sport divisional status if different than the institutions, date of first practice, date of eligibility meeting, date of first contest, date of conference championship and either 1 or 2 sport segments. Other editable information includes dates of sport's events as shown in FIG. 24, the coaching roster as shown in FIG. 25 and the student athlete roster as shown in FIG. 26. Under the coaching roster function the CO can choose to define/modify the coaches for the team. Furthermore, the student athlete roster can be defined/modified by the CO when changes to the teams occur. As part of this roster the system displays the status of the student's current information. The student information includes transfer eligibility if the student is a transfer, enrollment history when the student is beyond the first year, financial aid information and academic eligibility if the student is not a first year or transfer. Additionally, a CTI function provides a list of Compliance Toolbox Items where the CO can view the CTI's or delete current items.

The last function determines the sport counter value as shown by the flowchart in FIG. 29. This is the financial aid counter value summed up across all athletes that participate in a particular sport. If the sport's counter is above the National Collegiate Athletic Association limit, the CO will be notified of this and be given the opportunity to drill down into a more detailed view of the counters that make up the sport's total. The drill down will consist of a listing of students who are currently counter's in the sport and their individual counter values. The CO makes required edits to the data and saves the information. The system validates the data and if valid saves the information in blueprint. It then returns the CO to the blueprint maintenance screen.

The system copies over the college information from the previous blueprint into the new blueprint. It provides the CO with the ability to review the list and add or delete from it. This is particularly useful where there are university institutions with numerous colleges at different locations. In adding a new college the system prompts for particular information including, college name, number of credit hours required for graduation and the minimum grade point average (GPA) required for graduation. After filling in the data the CO selects to Save the information. The system validates the data and if valid saves the information. It then presents the CO with the opportunity to add additional colleges. The CO can continue to add colleges until all have been defined or can indicate there are no more colleges to add. Once this is complete the CO is presented with a screen indicating the blueprint setup is complete and that additional maintenance can be performed if necessary. The system automatically provides a link to the blueprint maintenance screen. However, if the required preconditions have not been met the system displays an error message. If any validations fail the system presents error messages describing what is wrong with the entered data. The CO is given the opportunity to make corrections and resubmit the data.

The CO can maintain the Toolbox items that are included in one of the institution's blueprints after at least one blueprint as been defined. The system presents the CO with a list of Compliance Tool Items that can be added to a blueprint. The CTI's are predominately forms that can be printed or filled out online. The CO selects a particular CTI to review and the system presents a brief description of the CTI. The CO has the option of viewing a pdf version of the form or adding a CTI to their blueprint. In selecting to view a pdf version of the form the CO uses the Adobe Acrobat Reader installed on the personal computer 11 to view the pdf document, as shown in FIG. 1. The system 10 presents a hyperlink via the Internet to get the Adobe Acrobat Reader if not already installed in the personal computer 11. If the CO chooses to add the CTI to the blueprint, the system provides the capability to add the CTI to the blueprint for the current academic year. A list of sports are provided that are defined in the blueprint that can utilize the selected CTI. The CO must choose one or more sports that they wish to include and an option to add to all sports is also provided. A summary is provided of the CO's choices and the option to finalize the selections. The CO chooses to finalize the choices and the system adds the CTI to all selected sports in the blueprint. However, if any of the preconditions are not met the system displays error messages. If any validations fail the system presents error messages describing what is wrong with the entered data giving the CO a chance to correct the data and resubmit.

A User can add a coach to one of the institution's predefined blueprints if there is at least one blueprint defined and the selected blueprint and coach are known. The system prompts the User for coach data including associated sports, coach type and coach status. The associated sports function is a list of sports defined in the institution's blueprint wherein the User chooses one or more sports where the coach participates. The coach type includes head, assistant, restricted, undergraduate, volunteer and non-coaching. The coach status is either active, inactive or dismissed. The User selects to save the coach blueprint and the system saves the information adding it to the blueprint if the information is valid. However, if the preconditions are not met the system displays error messages. If the validations of the information fail the system provides error messages indicating what corrections are needed. The User has the option to correct the data and the User then resubmits the data.

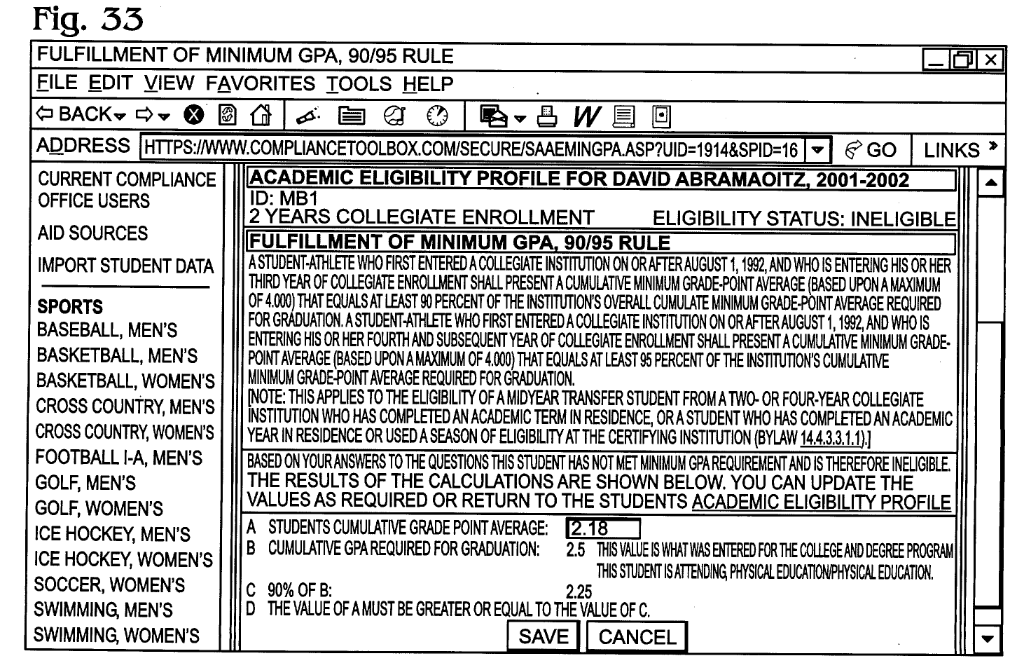

A student-athlete profile can be added to one of the institution's predefined blueprints if the preconditions are met as shown in FIG. 30. The preconditions include the institution having at least one defined blueprint and the selected blueprint along with a student-athlete are already known. The system prompts the User for student-athlete data. The first such data involves associated sports where the system provides a list of sports defined in the institution's blueprint. The User chooses one or more sports in which the student-athlete participates. For each sport selected the User specifies the student athletes status for the sport, whether the student-athlete did practice, whether the student-athlete did compete and whether the student-athlete was granted an eligibility exception. The student-athlete's status for the sport includes competing, not competing, cut/dismissed from the team, exhausted eligibility, medical exception resulting from a career-ending injury/condition, quit the team, National Collegiate Athletic Association waiver or was removed from the team. The next data field provides a list of colleges defined in the institution's blueprint that the student-athlete is attending. The third data field is the term attended by the student athlete and includes Fall, Winter if a quarter system and Spring. Also, a data field indicates whether the student-athlete attended full-time or part-time and whether the student-athlete is an in state or out of state resident. If the User selects a part-time student the system provides a message indicating that the student will be marked as ineligible to compete, practice or receive financial aid unless a specific CTI is filled out for the student. A sixth data field indicates class status that includes, first year student, sophomore, junior, senior, 5th year senior or graduate. A non-editable data field is the number of years of eligibility that has been used by the student-athlete. The system computes this number based on the enrollment information contained in the student athlete's profile. Finally, the User selects to save the student-athlete information to the blueprint. The system validates the information and if valid adds the student-athlete to the appropriate blueprint. The system then prompts the User for the student athlete's financial aid information as shown in FIG. 20. However, if any of the preconditions are not met the system displays and error message. If the validations of the information fail the system provides error messages indicating what corrections are needed and gives the User the option to correct the data and resubmit.

A student athlete's profile that exists in one of the institution's defined blueprints is editable by a User provided the institution has at least one blueprint defined. Also, the selected blueprint and student-athlete must be known. The system prompts the User to edit selected information and presents a link that goes to edit the student's financial aid information as shown in FIG. 20. In the associated sport(s) field the system provides a list of sports defined in the institutions blueprint. The User, which is generally the compliance office (CO), chooses one or more sports in which the student athlete is participating. For each sport selected the User also specifies the student athlete's status for the sport. This includes the additional fields of active, academically ineligible, cut/dismissed from the team, exhausted eligibility in the sport, graduated, medical exception resulting from a career-ending injury/condition, quit the team or the student was removed. The system further provides a list of colleges defined in the institution's blueprint within the institution the student-athlete is attending, whether the student was recruited or not, whether the student is an in state or out of state resident and class standing status. The class status is either that of freshman, sophomore, junior or senior. Furthermore, the number of years of eligibility that have been used by the student is another field but this field is not editable. The system computes the number of years of eligibility used based on enrollment information contained in the student athlete's profile. Finally, the User selects to save the updated student-athlete information in the blueprint wherein the system validates the information. If it is valid the system updates the student-athlete profile in the appropriate blueprint. The system then prompts the User asking if they wish to edit the student athlete's financial aid information. If the User responds affirmatively they are directed to the student-athlete financial aid screen as shown in FIG. 20. However, if any preconditions have not been met the system displays an error message. If validations of the information fail the system further provides error messages indicating what corrections are needed. The User has the option at this step to correct the data and resubmit it to the system.

A User can modify a student athlete's financial aid information within a blueprint if the institution has at least one blueprint, the selected blueprint and student-athlete are known and the selected student-athlete exists in a selected blueprint. The system prompts the User, which is typically the compliance office (CO), to enter financial aid information in different fields. One such field reports the cost of attendance of the student-athlete. The costs include tuition, fees, room, board, books, supplies, transportation and other expenses related to attendance at the institution. There is an initial counter, as shown in the flowchart in FIG. 29, if the User selects whether the student-athlete is to be considered in an initial sports count determination. This is only required if the student is participating in football or men's basketball. Another field includes full grant-in-aid whereby the User selects the full grant-in-aid amount applicable to the student-athlete. The system provides a list of values from the institutions blueprint. The User may select the athletics aid award period field to include a full year or semester of aid awarded to the student-athlete. The amount of athletics aid if the award period is for a full year provides a single input entry. If the award period is for a semester the system provides two input entries. Furthermore, the User supplies information on any PELL grant the student-athlete is receiving and the amount of other institutional aid. The other institution aid field includes information regarding the source of the financial aid wherein the system provides a list of Values defined in the institutions blueprint and the amount of the aid. Other fields include amount of other countable outside aid, the amount of other countable individual aid and honorary academic awards. In theses fields the system provides the User the ability to enter as many entries as required wherein each entry is composed of information relating to the source and the amount of the aid received by the student-athlete. Finally, the User can indicate if the student-athlete is exempt from counting as a financial aid recipient. If the User indicates the student-athlete is exempt the system requires and the User must supply a reason. The system supplies a list of reasons including not receiving financial aid, not recruited/receiving financial aid, recruited/not Division I football or basketball/receiving financial aid and recruited/Division I football or basketball/receiving financial aid.

The system calculates financial aid values and these values are displayed for the User to view. This is accomplished through algorithms stored in the third database of the system 10 shown in FIG. 2. If the required financial aid information has not yet been defined for the student, when this screen is presented, the system indicates that the values cannot yet be calculated. These calculated values are only displayed once the User has defined the financial aid information for the student. Once this information is input/validated/and saved the calculated values are displayed. The calculated values include the total amount of aid to be counted toward the student athlete's individual limit, the total amount of countable equivalency aid for the student-athlete and the equivalency value for the student-athlete rounded to the nearest tenth.

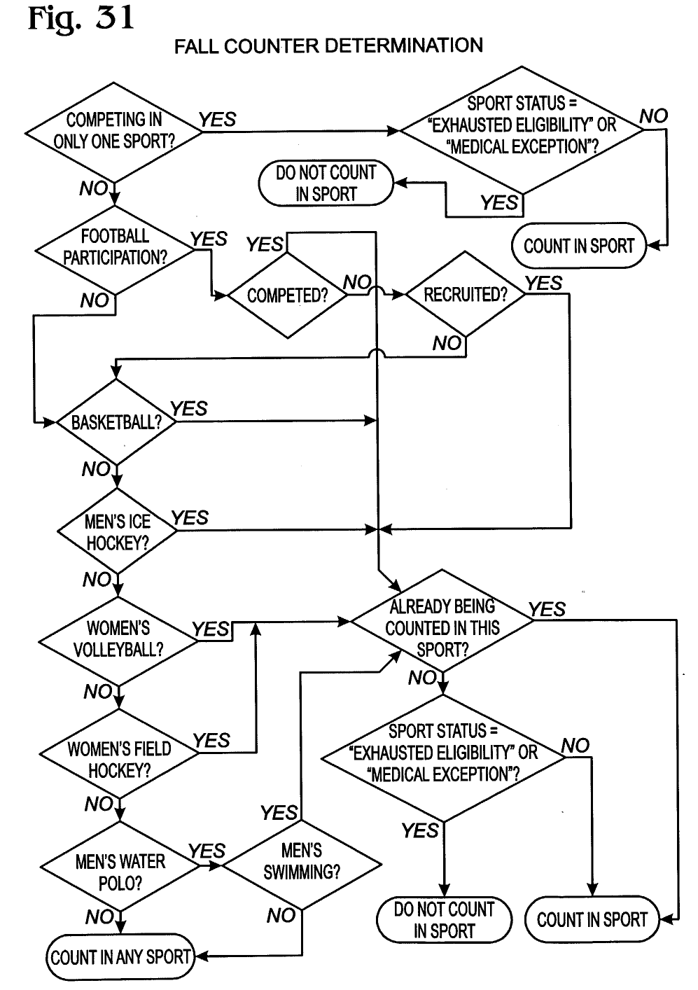

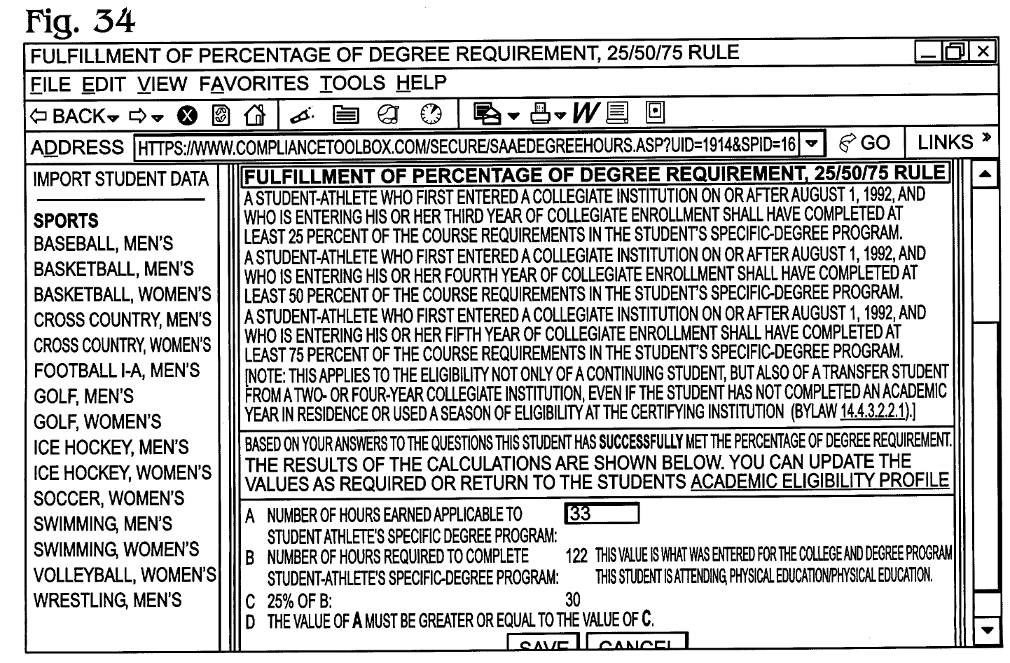

The sport the student-athlete is counted in is shown as a flowchart in FIG. 31. Once a student is a counter in a sport they muster remain a counter in this sport or another for the rest of the year, that is, once a counter they must remain a counter. The sport in which the student-athlete counts may change if the student is added to another sport's roster. The exception is if a student's status changes to mid year graduate or receives a National Collegiate Athletic Association waiver. Then the student no longer counts in the associated sport or any sport for the year. Furthermore, if a student's status is exhausted eligibility, or a medical exception, then the student-athlete will not count in the current year if they are not already being counted in a sport. This status is carried over into the next year by default when copying over a blueprint. Additionally, for the sport the student-athlete is counted in the system will report the total counter value for the sport. If the sport's counter is above the National Collegiate Athletic Association limit, the User will be notified of this and be given the opportunity to drill down into a more detailed view of the counters that make up the sport's total. The drill down will consist of listing students who are currently counter's in the sport in question and their individual counter values as shown in FIG. 28.

When the User selects to save the financial aid information the system validates the submitted data and if valid it saves the information. If the student-athlete is being added to a blueprint the system directs the User to a page indicating the student has been successfully added to the blueprint. If the student's existing financial aid info is being modified the system directs the User to the user profile maintenance screen. However, if any of the preconditions are not met the system displays error messages. If validations of the financial aid information fails the system provides error messages indicating what corrections are needed. It also gives the User the opportunity to correct the data and resubmit it to the system.

A User can add a contest or date of competition for a sport provided they are logged into the system if the institution has at least one blueprint defined and the selected blueprint and sport are already known. The system presents the User with a screen that allows them to create a sporting event for the selected sport. If the sport is divided into segments the User is given the option to select which segment the event is to occur in. The User selects the type of event, for example, regular season or an National Collegiate Athletic Association event, when the system provides a list of allowable specific events. The list varies from sport to sport. In the next step, the User specifies whether the event is a contest or a date of competition and then sets whether or not the student-athlete can assign complimentary tickets for the event. If the student-athlete can assign tickets the User also provides the e-mail reminder lead time. This is the number of days before the event that e-mail reminders should be sent to student athletes on the sport's roster reminding them that they can perform ticket transfers. The default days are 1 week and the system provides a drop down list of valid dates including, 1 day, 2 days, 3 days, 4 days, 5 days, 6 days, 1 week, 2 weeks and 3 weeks. Accordingly, the User must provide the name of the opponent, the location of the competition and the description of the event. Furthermore, the system default is “vs. opponent” for home games and “at opponent” for away games. For example, Georgia Tech at Rutgers for a Georgia Tech away game. If there is no opponent then no default will be displayed. If the User selects to Save this information the system validates the entered information and if valid saves the information.

The User is then presented with the add sport event screen again, as shown in FIG. 24, so they can enter additional sport events if desired or the User can select Return to the Sport Blueprint to return to the sport's blueprint page. However, if any preconditions are not met the system provides error messages. If the entered event fails validation the system presents error message(s) indicating what validation(s) failed. The User at this step can correct and resubmit the event. Also, if the sport has already reached its limit of non-exception sporting events for the segment an error message will be displayed if the User tries to add another one. If the User enters the same non-exception sporting event in the four year exception or annual exception, before the system allows it, the system displays an error message.

In the squad list report as shown in FIG. 28, the User views a summary listing of the student athletes that are participating in a sport and their financial aid counter value. The User must be logged into the system and the selected blueprint year and sport already known. The system presents a screen with the selected sport, whether the sport is head count or equivalency type and a listing of the student athletes on the sport's roster. Other screens include sum of the athletic grants, sum of total countable aid, sum of initial counter, sum of overall counters and sum of equivalency awards. These calculations are preformed by algorithms stored on the third database of the system. If the sum of the counter values is greater that the sports allowed limit the system indicates this with a warning message. The list contains many items including the student athlete's first name, middle and last name wherein the User can select this screen to view the student's user profile information as shown in FIG. 12. The User is then prompted by the system whether the student-athlete is eligible to compete. Another item on the list is the term the student was first enrolled, including the date the student first enrolled in any institution and the date the student enrolled in the certifying institution. The User can select this to view the student athlete's enrollment information as shown in FIG. 14. Also, the number of years the student received financial aid and number of years used in eligibility is an item on the list. The list also indicates whether the student-athlete was recruited or not whereby the User can select this to view the student athlete's user profile information as shown in FIG. 12. The list includes the period of financial aid awarded, either by full year, by semester or term, whereby the User can select this to view the student athlete's financial aid information as shown in FIG. 20. Other items on the list include the amount of the athletics aid grant, amount of other countable aid, total countable aid, whether the student-athlete has been deemed exempt from being counted in the sport and the student athlete's total cost of tuition, fees, room, board and books. Furthermore, the list contains fields for an initial counter, an overall value, an equivalency award, the student's current status and change in status. The initial counter is used only for football and men's basketball wherein the system indicates if the student-athlete was deemed an initial counter. The overall field is used only for counter type sports and indicates if the student-athlete has been deemed a counter in the sport. The equivalency award is only used for equivalency sports, women's gymnastics, women's volleyball and women's tennis wherein the system reports the student athlete's counter value. Under the change of status field the User must supply the reason for the status change and the date of the change in status.

A User can view the status of the Compliance Toolbox Items (CTI's) that are assigned for a particular individual to complete after the User has logged in, the associated institution has at least one blueprint defined and the selected blueprint year and individual are known. The system determines the CTI's and their status, for the indicated individual, and displays a screen listing each CTI sorted alphabetically by CTI. Each listing element contains the CTI title, due date, whether it is required or not and whether the User has entered any data for the CTI. The User can select the CTI to view/edit its information wherein the system presents a screen that allows for the entering information for the indicated CTI. Any values that have already been supplied for the CTI are shown. The User can elect to edit this information, save the information or cancel it and return to the CTI listing screen. However, if any of the preconditions are not met the system displays an error message. If validations on the entered CTI information fail the system presents an error message indicating the problem. The system allows the User to correct the information and resubmit it to the system.

The compliance officer (CO) User associated with a Division I institution modifies a student athlete's academic eligibility information with a blueprint as shown in FIG. 21. There are several preconditions before the User can modify this blueprint including that the institution has at least one blueprint defined and the selected blueprint and the student-athlete are all known. The selected student-athlete exists in a particular blueprint and cannot be a first year or transfer student. The status of the student-athlete cannot be that of graduate, mid year graduate or transferred out of the institution. Also, the selected student athlete's enrollment information must be completed.

The system presents the student athlete's name, a student identification (ID) number and then presents the sum total of the student athlete's years of collegiate enrollment. It further presents the student athlete's current academic eligibility status of either eligible, illegible or cannot determine. Next, the system presents the CO with a high level description of the National Collegiate Athletic Association academic eligibility requirements and provides hyperlinks to the relevant Bylaws. Also, the system determines if the student-athlete is in their 3rd year of academic enrollment. If so, the student athlete's designated program of study must be identified. If not, the system prompts the CO to provide this information and the CO enters the program of study and elects to Save it. If the designated program of study has been identified the system displays it. At this step, the CO answers yes or no to whether the student-athlete is in good academic standing per National Collegiate Athletic Association Bylaw 14.01.2.1 and whether satisfactory-progress is being met per the requirement of Bylaw 14.4.1. If the CO chooses no, the system identifies that the student-athlete is ineligible and that they should consider mid year certification.

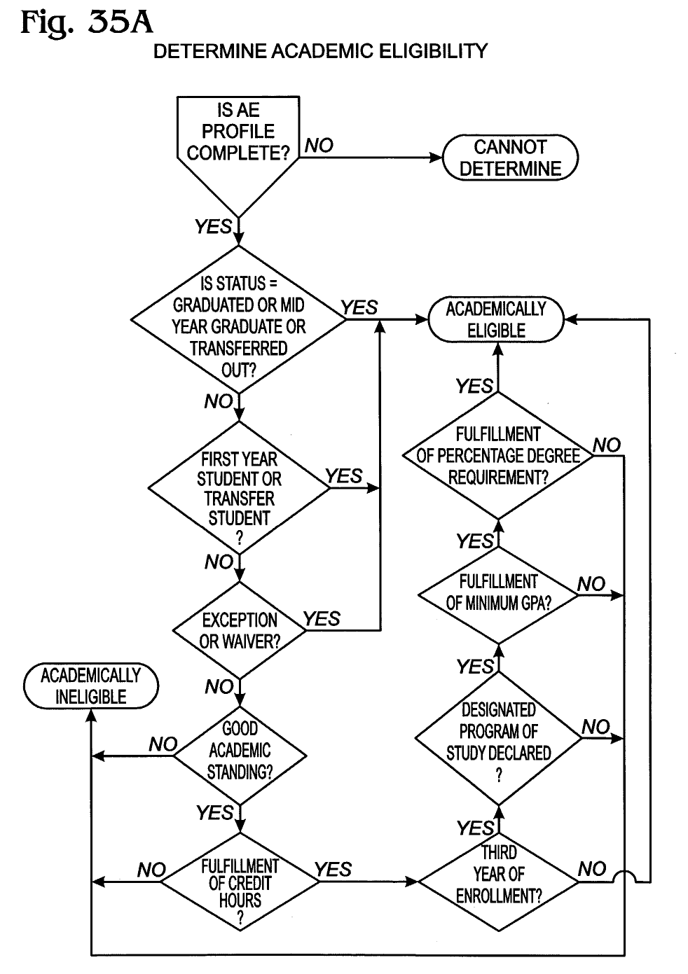

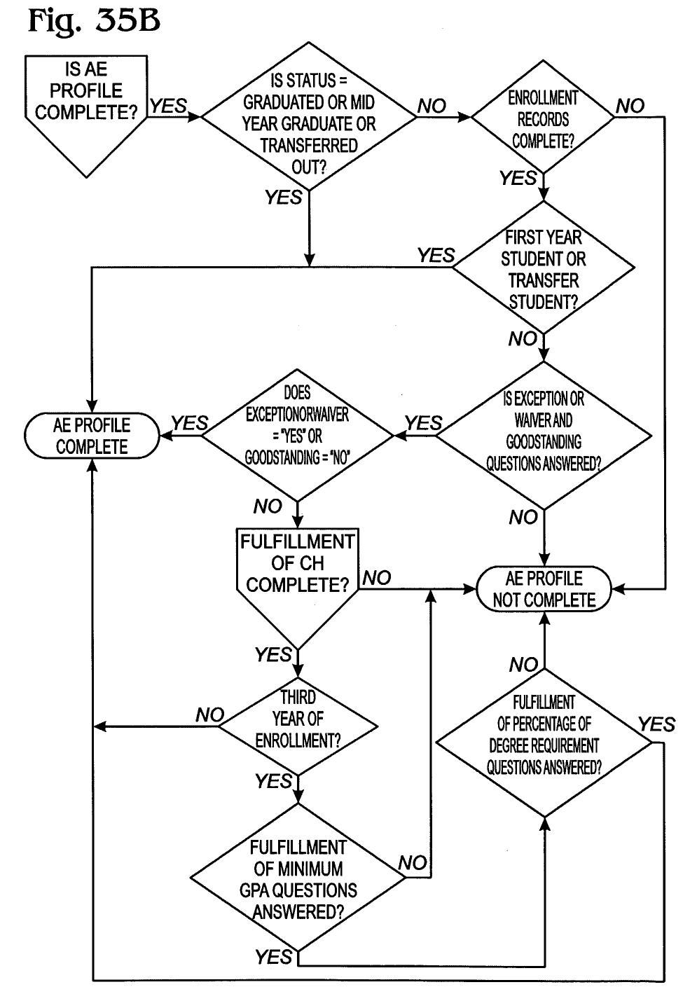

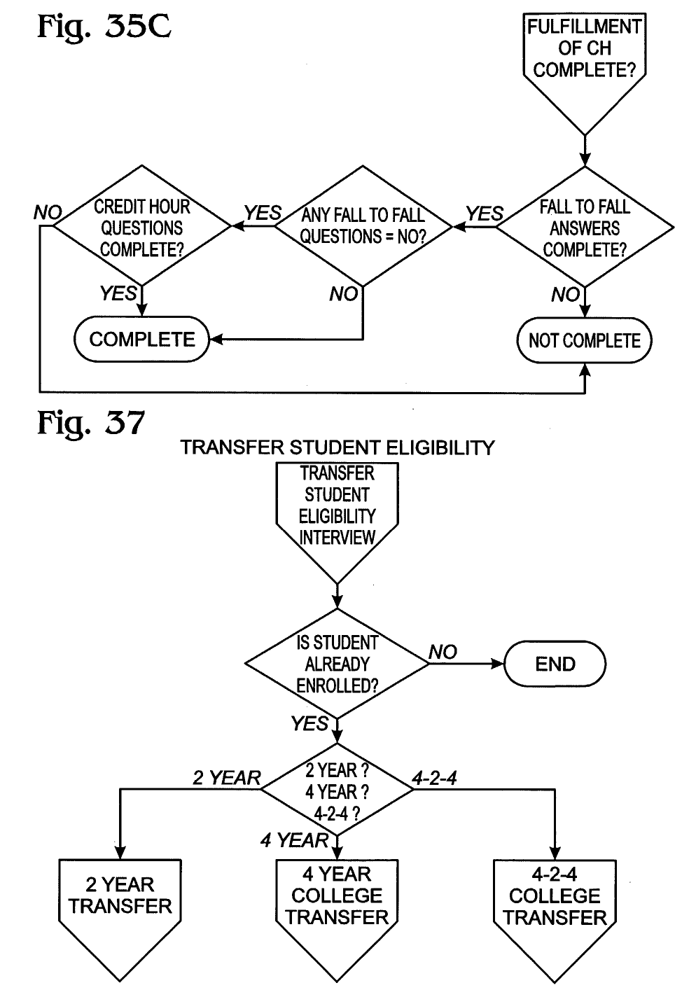

As the editing of the student athlete's academic eligibility profile continues, the CO can choose yes or no to the question whether the student-athlete does qualify for an exception to or waiver of the satisfactory progress rule. If the CO chooses yes the system identifies that the student-athlete is eligible and no other information is required. Furthermore, there are three academic eligibility wizards that need to be completed before it can be determined if the student-athlete is academically eligible. The system determines if these three CTI's are complete for the student-athlete and if not prompts to go ahead and complete them. The first wizard is the fulfillment of credit hours 75/25 rule as shown in FIG. 32. If the student-athlete is in their third or subsequent year of enrollment, the system also prompts the CO to complete the fulfillment of minimum GPA 90/95 rule and the fulfillment of percentage of degree 25/50/75 rule as respectively shown in FIGS. 33 and 34. If these CTI's have been completed for the student-athlete the system reports on the status of each. For example, if the student has not satisfied the fulfillment of credit hour requirements the system indicates the status of this CTI as ineligible. The CO can proceed to go and update the CTI's as required.

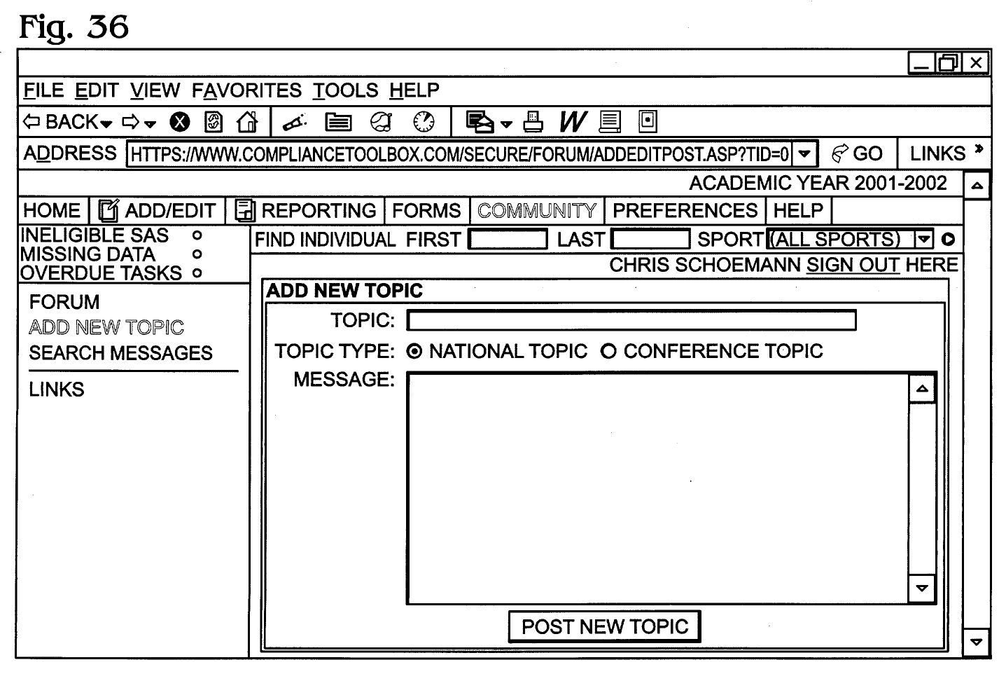

The system determines the academic eligibility through an algorithm stored in the third database as shown by the flowchart in FIGS. 35A, 35B and 35C. The logic developed is if any of the required CTI's and steps indicate the student-athlete is ineligible then the system designates the student as ineligible. Likewise, if all of the required CTI's and steps indicate the student-athlete is eligible then the system designates the student as eligible. If a student-athlete is determined to be academically ineligible the system updates the student athlete's status to academically ineligible. If a student-athlete is determined to be academically eligible the system updates the student athlete's status to active. Finally, the system presents an indication of the student athlete's current academic eligibility status either eligible or ineligible. However, if any of the preconditions are not met the system displays an error message.

The system walks the User through a series of questions to determine if a student-athlete meets the fulfillment of credit hours 75/25. This occurs if the institution has at least one blueprint defined and the selected blueprint and student-athlete are known. The selected student-athlete must exist in the selected blueprint and the student-athlete must not be a first year or transfer student. Also, the student athlete's status cannot be that of graduated, mid year graduate or transferred out. Furthermore, the selected student athlete's enrollment information must be completed.

The system presents the student athlete's name and student ID number wherein the system then presents the sum total of the student athlete's years of collegiate enrollment. It further presents whether the student athlete's current academic eligibility status is either eligible, ineligible or cannot be determined. The next step is that the User is presented with a high level description of the National Collegiate Athletic Association rules regarding the fulfillment of credit hours. These rule descriptions are stored in the second database. The hours earned by the student-athlete during the regular academic year are stored in the first database. After this presentation answers to the previous questions are displayed.

The fulfillment of credit hours is broken into two parts that includes the fall-to-fall method and the averaging method. Where appropriate the system provides links to details about each relevant Bylaw that is stored in the second database. The algorithm for the fall-to-fall and averaging method are stored and the calculations are accomplished in the third database of the system. The fall-to-fall method and averaging method are both prompted by the system. The fall-to-fall method presents a series of questions to the User. The first question is whether the student-athlete earned 24 semester or 36 quarter hours since the beginning of the previous fall term as required by National Collegiate Athletic Association Bylaw 14.4.3.1-(b). The User answers yes or no. If the answer is no the system directs the User to the averaging method. The second question is whether the hours earned are acceptable for degree credit per National Collegiate Athletic Association Bylaw 14.4.3.1.5 and 14.4.3.4.1. The User answers yes or no. If the answer is no the system directs the User to the averaging method. The third question is whether the student-athlete earned at least 18 semester or 27 quarter hours during the regular academic year excluding summer school. The User answers yes or no. If the answer is no the system directs the user to the averaging method. If the answer is yes to any of the three questions the system indicates the student-athlete has satisfied the fulfillment of credit hours.

The averaging method presents questions and directs the User through a protocol. The system prompts and displays information including credit hours wherein the system determines this value based on the student's enrollment information at the User's institution only. The required credit hours is determined by multiplying the number of terms by 12. Also, satisfactory progress credit hours earned during the fall to summer periods for each academic year the student-athlete was enrolled at their institution is displayed by the system. For example, if the student-athlete had attended their institution for three academic years starting in 1998 the system would prompt satisfactory progress credit hours earned during, Fall 1998 to Summer 1999, Fall 1999 to Summer and Fall 2000 to Summer 2001. The system sums up these values and stores them in the first database. If this value is less than the credit hours required the student-athlete does not meet satisfactory progress under the averaging method. The system then notifies the User that the student-athlete does not meet the fulfillment of the required credit hours. Furthermore, the system prompts for satisfactory credit hours earned during the regular academic periods for each academic year the student-athlete was enrolled at their institution. For example, if the student attended their institution for three academic years starting in 1998 the system prompts for satisfactory credit hours earned during the 1998 to 1999 regular academic year, 1999 to 2000 regular academic year and 2000 to 2001 regular academic year. The system sums up these values and determines 75% of the credit hours required. If this value is less than the 75% value the student-athlete does not meet satisfactory progress under the averaging method. The system notifies the User that the student-athlete does not meet the fulfillment of credit hours. If this values is greater than the 75% value the student-athlete meets satisfactory progress and has met the fulfillment of credit hours. The system then notifies the User as such. However, if any preconditions are not met the system displays an error message whereby the User must correct to further use the system.

The system walks the User through a series of questions to determine if a student-athlete meets the fulfillment of the minimum GPA 90/95 rule as shown in FIG. 33. The algorithm for these calculations are stored in the third database. These calculated values are stored in the first database. The system requires the institution have at least one blueprint defined, the selected blueprint and student-athlete are known, the selected student-athlete exists in the selected blueprint and the student-athlete is not a first year or transfer student. Also, the student athlete's status cannot be that of graduated, mid year graduate and transferred out. Furthermore, the student cannot be in their third year or greater year of collegiate enrollment and the selected student athlete's enrollment information is complete. When all the preconditions are met the system presents the student athlete's name, student ID number and then presents the sum total of the student athlete's years of collegiate enrollment. The system proceeds to present the student athlete's current academic eligibility status which is either eligible, ineligible or cannot determine. A high level description of the National Collegiate Athletic Association rules regarding minimum GPA requirements are presented Also, the system displays any previous answers to questions. At this step the system prompts the User for the student athlete's cumulative grade point average. The system determines the minimum GPA required of the student-athlete. If the student-athlete is in their third year of collegiate enrollment the system uses 90% of the minimum GPA required for graduation from the college the student-athlete is attending. If the student-athlete is entering their fourth or subsequent year of collegiate enrollment the system uses 95% of the minimum GPA required for graduation from the college the student-athlete is attending. If the student athlete's GPA is less than either the 90% value for the third year student-athlete, or the 95% values for the fourth or subsequent year student-athlete, then the student-athlete does not meet satisfactory progress. The system notifies the User the student-athlete does not meet the fulfillment of the minimum GPA. Otherwise, the student-athlete does meet satisfactory progress for fulfillment of the GPA. However, if any of the preconditions are not met the system displays an error message which the User must correct to proceed.

Another aspect of the system walks the User through a series of questions to determine if a student-athlete meets the fulfillment of the percentage of degree requirement 25/50/75 rule. This is shown in FIG. 34. This aspect of the system operates only after several system preconditions are met. The preconditions include the institution must have at least one blueprint defined, the selected blueprint and student-athlete are known and the selected student-athlete exists in the selected blueprint is not a first year or transfer student. Further preconditions include the student athlete's status is not either graduated, mid year graduate or transferred out. Other preconditions include the student-athlete is in their third year, or greater year of collegiate enrollment and their enrollment information is completed. If these preconditions are met the system presents the student athlete's name, ID number and the sum total of the student athlete's years of collegiate enrollment. Also presented is the student athlete's current academic eligibility status of either eligible, ineligible and cannot determine. The system then presents the User with a high level description of the National Collegiate Athletic Association rules regarding the fulfillment of the percentage of degree requirement. It further displays answers to previous questions. The system next prompts the User for the number of hours earned applicable to the student athlete's specific degree program. The system determines the percentage of degree required of the student athlete and stores this information in the first database. If the student-athlete is entering their third year of collegiate enrollment the system uses 25% of the number of hours required to complete the student athlete's specific degree program. If the student-athlete is entering their fourth year of collegiate enrollment the system uses 50% of the number of hours required to complete the student athlete's specific degree program. Finally, if the student athlete is entering their fifth year of collegiate enrollment the system uses 75% of the number of hours required for the student athlete's specific degree program. When the actual credit hours earned by the student athlete is less than the respective percentage values, the student-athlete does not meet satisfactory progress and the system notifies the User that the student-athlete does not meet the fulfillment of percentage of degree. Otherwise, the student-athlete does meet satisfactory progress for fulfillment of percentage of degree and the system notifies the User as such. However, if any of the system preconditions are not met it displays an error message which indicates to the User what needs to be corrected to proceed.

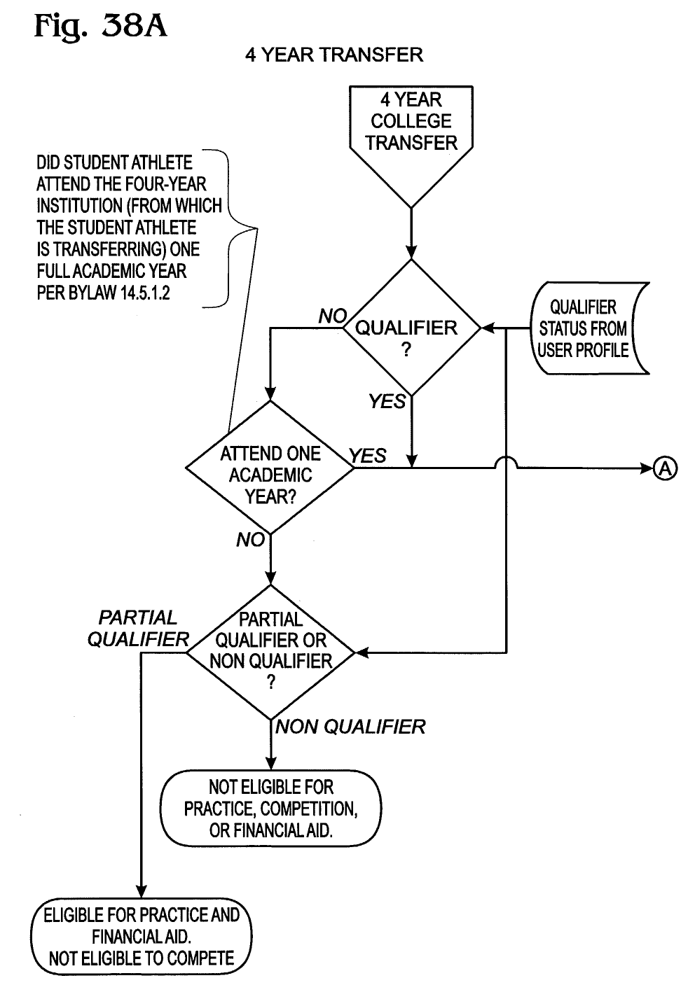

It is a further aspect of the system to allow the User to interact with the Compliance Toolbox's message (discussion) forum after the User has logged in. The system presents the User with a message forum page that list forum messages posted in the last 30 days as shown in FIG. 36. The User can select a message wherein the system presents the message in detail including post a reply to the message, post a new message and edit the message if the User is the one who created the positing. To post a message the User provides the subject, message text and then the User can select an option to receive e-mail if/when someone responds to the posting. When replying to a posting the User provides the message text and then the User can select an option to receive email if/when someone responds to the posting. If the posting is to be edited by the creating User it can be updated including the subject, message text and then the User can modify the option to receive e-mail if/when someone responds to the posting. The User can search the message forum by providing a keyword or keyword phrase. The system provides a list of messages that contain the string in the subject or message text. Each message in the listing includes message subject, message text, user that created the posting and posting date. The User can select any individual message in the list to view its details.

A User can Add/Edit a What's New Item for their institution after the User has logged into the Compliance Toolbox application. From the Main Page the User selects to Add/Edit a What's New Item as shown in FIG. 3. The User can only edit the What's New Items that were created by themselves. The system presents a screen with fields populated by previously entered data. This is to collect updated data including begin display date, end display date and the message to display. The message can be formatted in straight text, HTML, straight text/HTML which sports the What's New Item should be associated with and the User access. The User can indicate which user-roles have access to view the What's New Item including the compliance office, coaches and student athlete's. After entering the required information the User selects to Add/Update the item. The system then validates the information including verifying that all required fields contain information and are in the necessary format. The begin date must be less than or equal to the end date and at least one sport must be selected. All dates must be in the MM/DD/YYYY format. If all the entered information is valid the system adds/updates the data into the first database. The system redirects the User back to the Add/Edit What's New screen item, with a confirmation message, so they can continue to add additional items or edit the existing item. However, if the system determines the entered data is not valid it redisplays the screen with messages indicating which data elements were invalid and allows the User to modify what was entered. The user selects Cancel and the system redirects the User back to the Main page screen without adding/editing the What's New Item.

A User can Add/Edit a Calendar Event for their institution after they have logged in. From the Main Page screen the User selects to Add/Edit a Calendar Event. The User can only edit the events that were created by them. The system presents a screen with fields populated by previously entered information, to collect the event date, the text of the event to display wherein the text can be formatted in straight text, HTML, straight text/HTML, which sports the Calendar Event is associated with and User access. The User can indicate which user-roles have access to view the Calendar Event including the compliance office, coaches and student athlete's. After entering the required information the User selects to add/update the item. Next, the system validates the information that includes verifying all the fields containing information are in the necessary format and at least one sport has been selected. The dates must be in the MM/DD/YYYY format. If all entered information is valid the system adds/updates the data into the first database. The system redirects the User back to the Add/Edit Calendar Event screen, with a confirmation message, so they can continue to add additional items or edit the existing item. However, if the system determines the entered data is not valid it redisplays with messages indicating which data elements were invalid and allows the User to modify what was entered. If the User selects to cancel the data the system redirects the User back to the Main Page screen without adding/editing the calendar event.

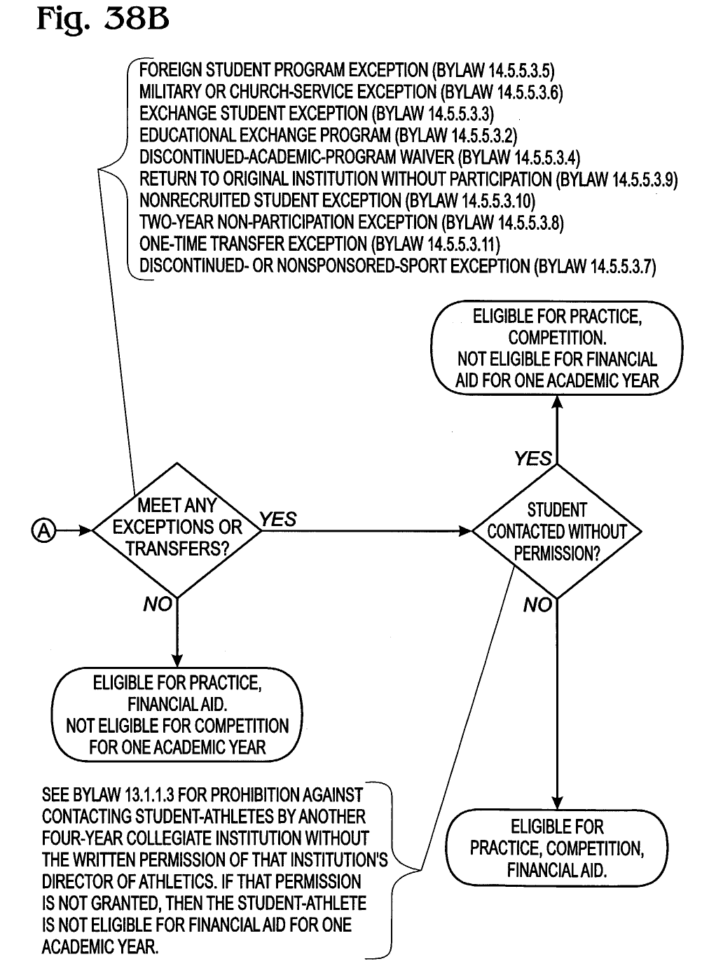

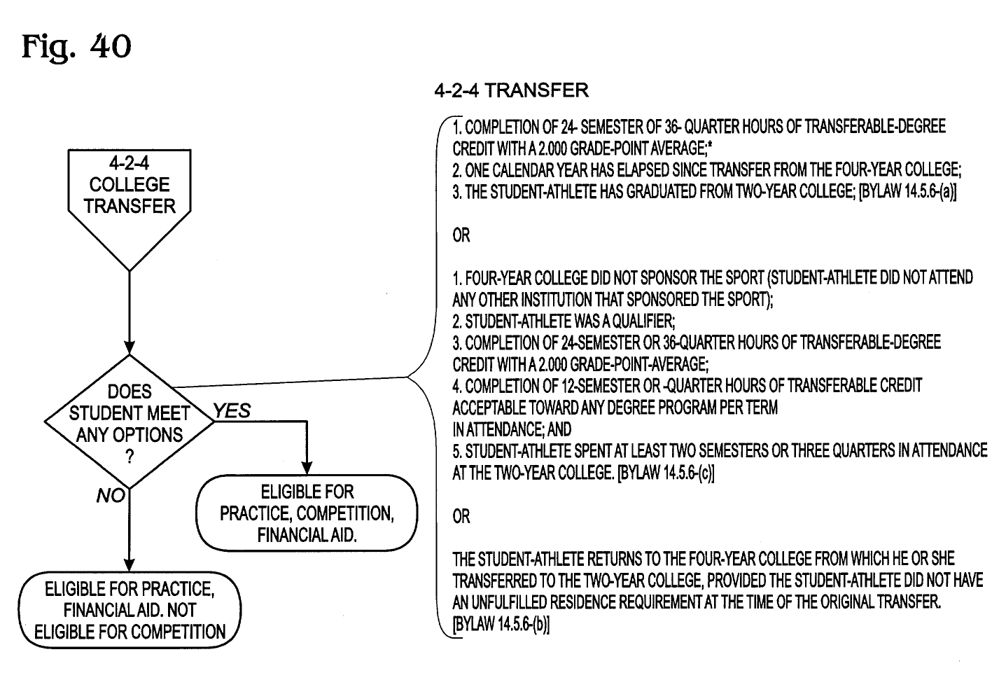

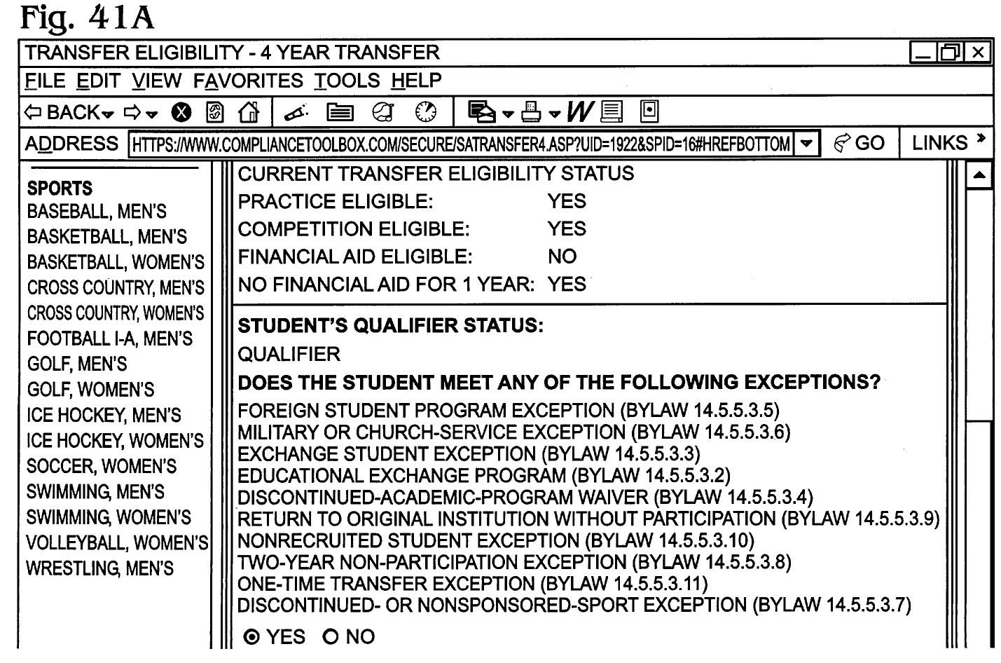

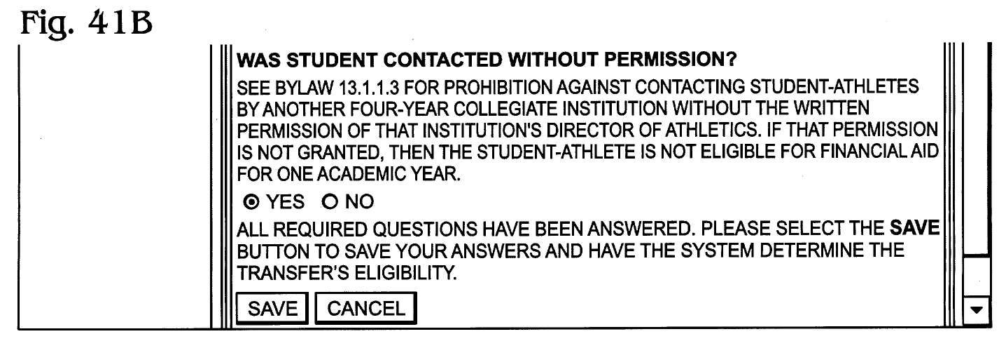

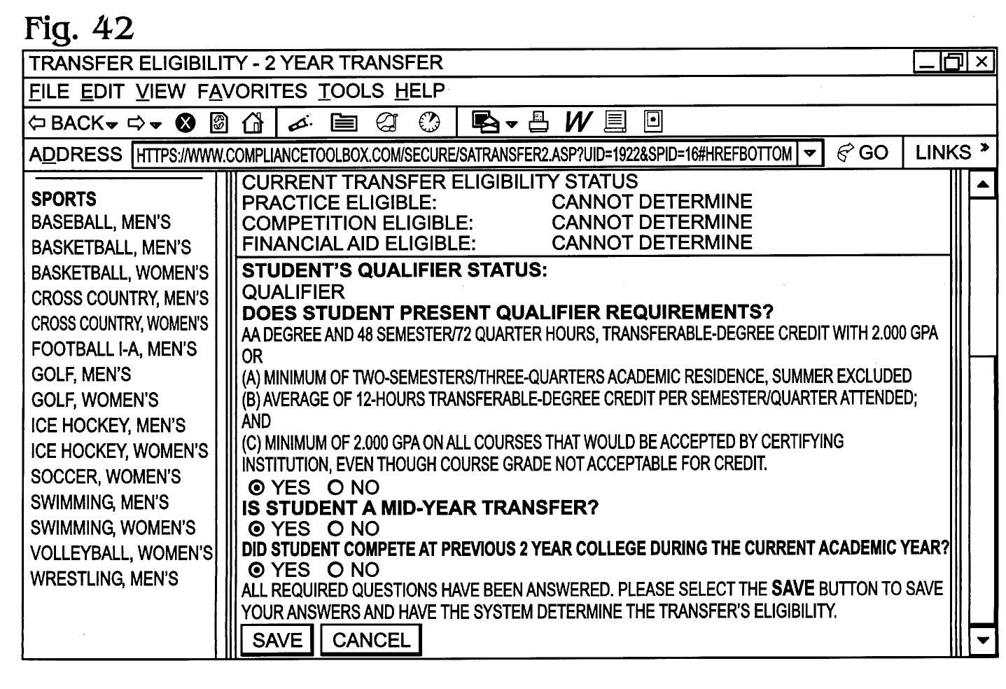

Another feature to this system is that it provides information to determine a transfer student's eligibility, as shown in FIGS. 19 and 37, after the User has logged into the system and if the student profile information has already been added to the system. The system prompts the User as to the type of the student-athlete transfer including the 4-year college transfer profile as shown in FIG. 41, the 2-year college transfer profile as shown in FIG. 42 and the 4-2-4-year college transfer profile as shown in FIG. 43. The system prompts the User for the term the student-athlete is transferring including fall, winter if the institution is on the quarter basis and spring whereby the User selects the appropriate action. The system directs the User to the appropriate transfer eligibility questionnaire and they complete the required information. When adding the student athlete's profile, if the User indicated the student-athlete should be added to a blueprint the system redirects the User to add the student-athlete to the blueprint as shown in FIG. 44. If the User did not indicate the student-athlete should be added to a blueprint, the system notifies the User that all required information has been collected and warns the User that the student athlete has not yet been added to a blueprint when this is necessary. However, if any system preconditions are not met it displays an error message which must be corrected by the User before proceeding.

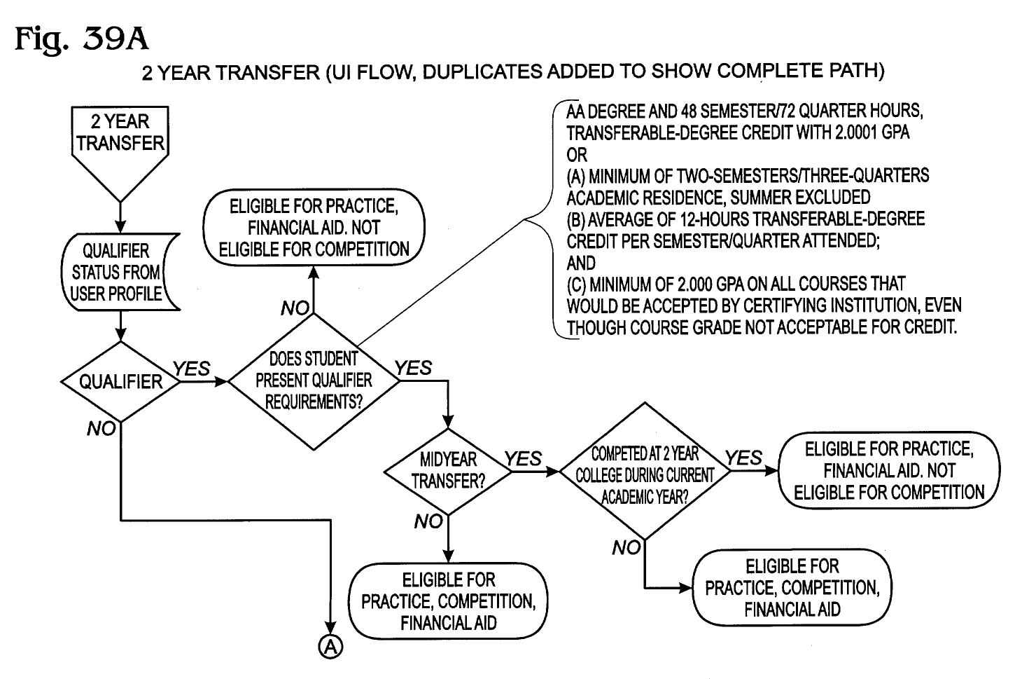

For a student-athlete that is transferring from a 4-year college, as shown in FIG. 38, the User provides information necessary to determine the student athlete's eligibility as shown in FIG. 41. The system requires the User to be logged-in and to indicate the student-athlete is a 4-year college transfer wherein the student profile information has already been added to the system. From the student athlete's profile information the system determines if the student was a qualifier out of high school. The system draws this information from the first database. If a student-athlete was not a qualifier, but a partial qualifier or non qualifier, the system prompts the User with a question. The question is whether or not the student-athlete attended the four-year institution from which the student-athlete is transferring for one full academic year per National Collegiate Athletic Association Bylaw 14.5.1.2. If the User answers no to this question the system determines if the student-athlete was a partial qualifier or non qualifier using the student athlete's profile information. If the student-athlete is a partial qualifier the system marks the transfer student-athlete as eligible for practice and financial aid but not eligible to compete. If the student-athlete was a non qualifier the system marks the transfer student-athlete as ineligible for practice, financial aid and competition. If the User answers yes to this question the system prompts with another question as to whether the student-athlete meets any exceptions for transfers. The system presents an exceptions list with hyperlinks to the appropriate National Collegiate Athletic Association Bylaws. The Bylaws stored in the second database include, foreign student program exception Bylaw 14.5.5.3.5, military or church service exception Bylaw 14.5.5.3.6, exchange student exception Bylaw 14.5.5.3.3 and the educational exchange program Bylaw 14.5.5.3.2. Other Bylaws include the discontinued-academic-program waiver Bylaw 14.5.5.3.4, the return to original institution without participation Bylaw 14.5.5.3.9 and the non recruited student exception Bylaw 14.5.5.3.10. Further Bylaws include the two-year non-participation exception Bylaw 14.5.5.3.8, the one-time transfer exception Bylaw 14.5.5.3.11 and the discontinued or non sponsored sport exception Bylaw 14.5.5.3.7. If the User answers no to this second question the system marks the transfer student-athlete as ineligible to compete for one academic year but eligible to practice and receive financial aid. The system notifies the User as such. If the User answers yes to this second question the system prompts the User with a third question on whether or not the student-athlete was contacted without written permission under Bylaw 13.1.1.3. This Bylaw prohibits contacting student athlete's, by another four-year collegiate institution, without the written permission of the student athlete's institution's director of athletics. If that permission is not granted then the student-athlete is not eligible for financial aid for one academic year. If the User answers no to the third question the system marks the transfer student-athlete as eligible for practice, competition and financial aid. The system notifies the User as such. If the User answers yes to the third question the system marks transfer student-athlete as eligible for practice and competition but ineligible for financial aid for one academic year. The system notifies the User as such. However, if any of the system preconditions are not met it displays an error message and directs to User to make corrections before proceeding.

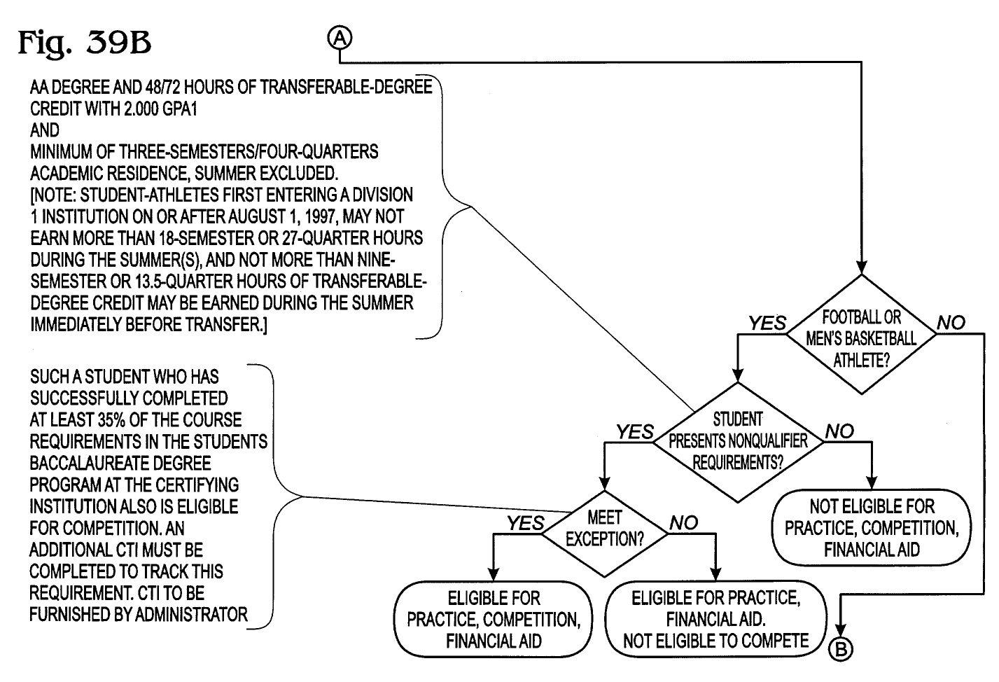

Another aspect of the present invention is for a User to determine a student athlete's eligibility when a student-athlete is transferring from a two year college, as shown in FIG. 39, by necessary information provide by the User as shown in FIG. 42. The system requires the User to log in and indicate the student-athlete is a 2-year college transfer. The student-athlete profile information must already be added to the system. From the student athlete's profile information the system determines if the student-athlete was a qualifier directly out of high school. If the student was either a partial qualifier or non qualifier out of high school the system prompts a first question as to whether the student-athlete is a football or men's basketball athlete. If the User answers no to the first question the system prompts the User to whether the transfer student-athlete meets particular requirements. The requirements are that the transfer student have an associate art's (AA) degree, 48/72 hours of transferable-degree credit with a 2.0 GPA and a minimum of three-semester/four-quarters academic residence, summer classes excluded. The system notes that student athletes first entering a Division I institution on or after Aug. 1, 1997, may not earn more than 18-semester or 27-quarter hours during the summer(s). Not more than nine-semesters or 13.5-quarter hours of transferable-degree credit may be earned during the summer immediately before the transfer. If the User indicates yes to these requirements the system asks a third question. If the User indicates no, that the student does not meet these requirements, the system marks the student-athlete as ineligible for practice, competition and financial aid. If the User answers yes to the first question the system prompts the User to whether the student-athlete meets particular requirements. The requirements are the student-athlete hold an AA degree, 48/72 hours of transferable-degree credit with a 2.0 GPA and a minimum of three-semesters/four-quarters academic residence, summer(s) excluded. The system notes that student athlete's first entering a Division I institution on or after Aug. 1, 1997, may not earn more that 18-semester or 27-quarter hours during the summer(s). Not more than nine-semester or 13.5-quarter hours of transferable-degree credit may be earned during the summer immediately before the transfer.

If the User indicates yes the student-athlete meets these requirements the system prompts the User with a second question. The question is whether or not the student has successfully completed at least 35% of the course requirements in the student athlete's baccalaureate degree program at the certifying institution. If the User indicates yes to this question the system notifies the User that an additional CTI needs to be added to the student athlete's associated sport and filled out for the student-athlete. The system marks the transfer student eligible for practice and financial aid but ineligible for competition pending completion of the CTI. Once the CTI is completed the system marks the student-athlete as eligible for competition. Alternately, the User will answer the second question as no when the student-athlete does not meet the 35% completed course requirement. The system then marks the transfer student-athlete as ineligible for practice, competition or financial aid.

If the student was a qualifier the system prompts the User whether the student-athlete meets particular requirements. The student-athlete must have an AA degree, 48 semester/72 quarter hours transferable-degree credit with a 2.00 GPA or a set of three other requirements. The first requirement is the student-athlete must have a minimum two-semester/three-quarter academic residence, summer excluded, at the prior institution. The second requirement is the student-athlete must have an average of 12-hours transferable-degree credit per semester/quarter attended. The third requirement is that the student-athlete must have a minimum 2.00 GPA on all courses, that would be accepted by the certifying institution, even though the course grade is not acceptable for credit. If the User indicates yes that the student-athlete does meet these three requirements the system asks a third question. If the User indicates no that the student-athlete does not meet these three requirements the system marks the student-athlete as eligible to practice and financial aid but ineligible for competition.

The system prompts the User with a third question as to whether the student-athlete is a mid year transfer. If the User indicates yes the system prompts a fourth question as to whether the transfer student-athlete competed at the two year college in the same academic year. If the User answers yes to the fourth question the system marks the student-athlete as eligible for practice and financial aid but ineligible for competition. If the User answers the fourth question as no the system marks the student-athlete as eligible for practice, financial aid and competition. Alternately, if the User answers no to the third question the system marks the student as eligible for practice, financial aid and competition. However, if any of the system preconditions are not met it displays an error message whereby the User has the opportunity to correct the data and then proceed.

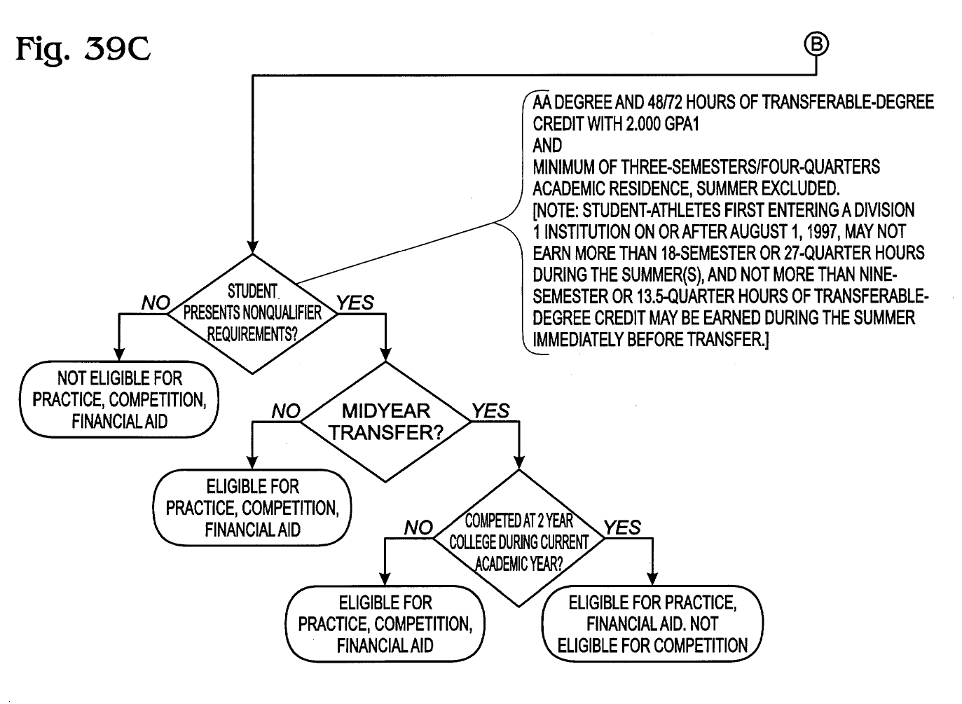

For a student-athlete that is performing a 4-2-4 transfer, as shown in FIG. 40, the User provides information necessary to determine the student athlete's eligibility as shown in FIG. 43. The system requires the User to be logged in and have indicated the student-athlete is a 4-2-4 transfer wherein the student profile must be in the system. The system prompts the User whether the transfer student-athlete has completed 24-semester or 36-quarter hours of transferable-degree credit with a 2.00 grade point average. Other questions prompted are whether one calendar year has elapsed since transfer from the four-year college and whether the student-athlete has graduated from a two-year college under Bylaw 14.5.6-(a). The system prompts alternate questions including whether the four-year college did not sponsor the sport, whether the student-athlete did not attend any other institution that sponsored the sport and whether the student-athlete was a qualifier. Still other questions include whether the student-athlete completed 24-semester or 36-quarter hours of transferable-degree credit with a 2.00 grade point average and 12-semester or 18-quarter hours of transferable credit acceptable toward any degree program per term in attendance. An additional question is whether the student-athlete spent at least two semester or three quarters in attendance at the two year college under Bylaw 14.5.6-c.

A third set of alternate questions are prompted by the system. The first question is whether the student-athlete has returned back to the four-year college from which they transferred to a two-year college. The second question is whether the student-athlete did not have an unfulfilled residence requirement at the time of original transfer under Bylaw 14.5.6-(b). If the User indicates no that the student-athlete does not meet these requirements the system marks the student-athlete ineligible for competition but eligible for practice and to receive financial aid. Alternately, if the User indicates yes that the student-athlete does meet all of these requirements the system marks the transfer student-athlete as eligible for practice, competition and to receive financial aid. The system notifies the User as such. However, if any system preconditions are not met it displays and error message directing the User to correct and then proceed.

The User can add or maintain enrollment history information for the institutions the student athlete has attended as shown in FIG. 14. To use the system the User must be logged into it and the selected student-athlete is known. Also, the system is aware whether this operation is being performed for a new student-athlete or an existing one. After the preconditions have been met the system presents the User with the ability to enter/update the enrollment history for a student-athlete. The User enters enrollment information for each unique school/year that the student-athlete attended any institution. The User should not enter enrollment information for the current academic year since that is captured later as part of adding the student-athlete to the blueprint. The system provides the User with the ability to add as many enrollment entries as required and prompts several enrollment history fields. The first field is the academic year which is the year of the enrollment record. The year must be in the YYYY format. The second field is the institution name wherein the system provides the User the ability to specify that the enrollment record is for their institution. For example, if the User indicates that the record is for their institution the system will tie this record to the User's institution. The third field is the term(s) attended where the User can select which term the student-athlete attended the institution and it includes the list of fall, winter if a quarter system and spring. The fourth field is whether the college program is a 2 or 4 year program. The fifth field is whether the student-athlete is a full-time or part-time student at the institution. The sixth field is the student athlete's class standing status for the enrollment record and includes the list of first year student, sophomore, junior, senior, 5th year senior and graduate. The seventh field specifies the financial aid the student-athlete is receiving at the institution. The eighth field specifies the fulfilled academic requirements whereby the User indicates if the student-athlete satisfactorily met the institution's academic eligibility requirements.

For each enrollment entry the User can specify which sport(s) the student-athlete participated in. For each sport the information collected includes a sport that is selected from a list of sports and yes or no answers to the questions of whether the student-athlete practiced, whether the student-athlete competed and whether the student-athlete was granted an eligibility exception. The User provides the answer to the questions related to the student athlete's sport. Accordingly, each record is saved wherein the system validates the entered information and saves it in the first database when the information is valid. The system then redirects the User back to the enrollment screen so they can continue to enter additional enrollment history records. If a new student-athlete is being added the system displays a Next>>button for the User. When the User has completed all necessary enrollment records the User selects Next>>. If the student-athlete is a transfer student the system directs the User to the Transfer Eligibility page as shown in FIG. 19. Otherwise, if the student-athlete is to be added to a blueprint the system directs the User to Add Student-Athlete to Blueprint as shown in FIG. 44. If neither condition is true the system notifies the User that all required information has been collected but a student-athlete was not added to a blueprint. However, if any of the system preconditions were not met it displays the appropriate error message whereby the User corrects the information and resubmits.

Another feature of the system allows the User to add a coach to one of the institution's sports after the User has logged in, selected a blueprint and a sport. The system first presents the User with a screen to search for current coaches defined for the institution and prompts to search for the coaches last name and first name. Additionally, the system provides an Add New Coach option whereby the User selects it and the system directs the user to a screen that allows the User to add a new coach as shown in FIG. 25. Alternately, the User enters a last name and/or first name and then selects to Search. The system utilizes any entered first name and last name information to search for matching coaches in the institution's user profiles and presents found entries in a list format. Each entry lists the first name/middle name/last name, the sport(s) they are coaching and their role. The User then selects a Coach they wish to add to the sport's roster wherein the system prompts the User for the coaching role the coach will hold. The system provides a list of coaching roles including head, assistant, restricted, undergraduate, volunteer and non-coaching. The User selects the coaches role and the system adds the new coach to the sport's roster and directs the User back to the sport's blueprint page. However, if any of the system preconditions are not met it displays error messages. If no matching entries are found, as a result of a search, the system notifies the user that they need to broaden their search criteria. Furthermore, if more than 100 matching entries are found as a result of a search the system notifies the User that they must refine their search criteria.

If the institution has a new coach the User can add the coach into the system after the User has logged in, selected a blueprint and a sport. The system presents a screen that prompts for required information including the coach's first name, last name, gender, e-mail address, status, system user ID, system password, verify system password and coach type. Further information prompted includes non-required information including the new coach's title, phone number and comments. The coach's status is selected from a provided list that includes active, inactive or dismissed. The coach type is selected from a provided list that includes head, assistant, restricted, undergraduate, volunteer or non-coaching. The User fills in the data and selects to save the coach's information. The system validates the entered information and if valid adds the user profile to the institution, adds the profile to the indicated sport's roster and directs the User to the sport's blueprint page. However, if any of the system preconditions or validations are not met it displays an error message for the User to correct and resubmit.

The system allows a User to add a student-athlete to one of the institution's sports after the User has logged in, selected a blueprint a and sport. The system presents the User with a screen of current student athlete's defined at the institution and prompts for the student's last name and first name to search for that particular student-athlete. Additionally, the system provides an Add New Student option. The User selects Add New Student and the system directs the User to a screen that allows adding the new student-athlete as shown in FIG. 26. Alternately, the User enters a last name and/or a first name and selects Search. The system utilizes any entered first and last name information to search for matching students in the institution's user profiles and presents found entries in a list. Each entry lists the student athlete's first/middle/last name, current status and sport(s) they are participating in. The next step is for the User to select a student-athlete they wish to add to the sport's roster wherein the system determines if the student currently exists in the current academic year's blueprint. If not, the system presents a screen to collect the required blueprint information. If the student-athlete is already added to the blueprint the system adds the student-athlete to the sport's roster and routes the User back to the sport's blueprint maintenance roster screen. However, if any of the system preconditions or validations are not met it displays an error message that allows the User to correct and resubmit. If no matching entries are found as the result of the search the system notifies the User that they need to broaden their search criteria. Finally, if more than 100 matching listings are found as a result of the search the system notifies the User that they must refine their search criteria.

A new student-athlete can be added to a sport's roster after the User has logged in ,selected a blueprint and a sport. Also, it must be known whether an existing student athlete's institution profile is being added to the current academic year's blueprint and sport's roster or whether this is a completely new student-athlete. If an entirely new student-athlete profile is being added the system prompts for the institution profile. This profile includes the required field information of the student's first name, last name, gender, e-mail address and status. The profile further includes the system user ID, a system password, verification of the system password, whether the student is an international student and was the student recruited. Additionally, the profile includes the student athlete's qualification out of high school, whether the student is a transfer student and the student-athlete's identification number. Other non-required field information on the student-athlete includes title, phone number, comments and designated program of studies. The student athlete's status field includes a provided listing to determine whether the student-athlete is active, academically ineligible, a graduate or a mid-year graduate. The student athlete's qualification out of high school field includes a provided listing of qualifier, partial qualifier and non qualifier. The system asks whether the student-athlete was a transfer student, international student or recruited whereby the User selects the appropriate designation. The student-athlete identification number is required only if the user type is a student-athlete. The User then provides an institution specific ID number for the student-athlete with the ID number consisting of alphanumeric characters. The User also provides the student athlete's designated program of studies toward a specific degree program. This is not a required field until the student athlete's 3rd year of enrollment.

In the next step the system prompts the User for blueprint profile information. This includes the required field of sport participation for the sport the student-athlete is being added. The system prompts the User for the student athlete's status in this sport which is either competing, not competing, cut/dismissed from the team, exhausted eligibility, medical exception resulting from a career-ending injury/condition, quit the team, National Collegiate Athletic Association waiver or removed. The system next asks whether the student-athlete practiced whereby the User answers yes or no. The system then asks whether the student-athlete competed whereby the User answers yes or no. Also, the system asks whether the student-athlete was granted an eligibility exception whereby the User answers yes or no. Other blueprint profile required information includes the college the student-athlete is attending, terms attended by the student-athlete, whether the student-athlete is an in state or out of state resident, whether the student-athlete is attending full-time or part-time and class standing status. The system provides a list of colleges defined in the institution's blueprint for the User to determine the student athlete's college. The system provides the terms including fall, winter if the institution is quarter based and spring. Furthermore, the system provides a list of class standing status of the student-athlete including first year, sophomore, junior, senior, 5th year senior and graduated whereby the User selects the appropriate status. The User fills in the information and selects to save the student athlete's information. The system validates the entered data and if valid adds the user profile to the institution if not already present. The system then adds the profile to the indicated sport's roster and directs the User to the sport's blueprint roster page. However if any preconditions or validations are not met the system displays error messages and allows the User to correct and resubmit.

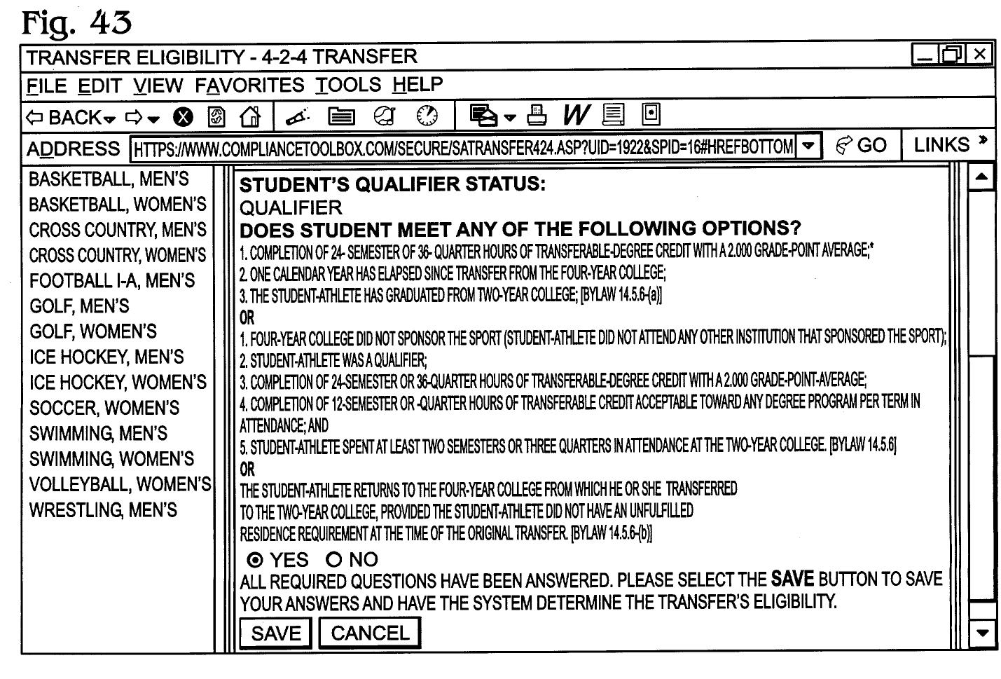

A User can manage recruits for a particular sport with this system if the User is logged in, the selected blueprint and the sport are known. The system presents the User with a list of the current non-deleted recruits associated with the sport and then presents options. The options include adding a new recruit, edit an existing recruit's information and deleting an existing recruit. The User chooses to add a new recruit or edit and existing recruit to add/edit a sport recruit's profile as shown in FIG. 45. The User can also choose to delete a recruit wherein the system presents the User with a confirmation screen verifying they want to delete the recruit. The User confirms the deletion and the system marks the recruit as deleted but does not physically delete the recruit from the data store. The system then returns the User to the recruit listing screen. Alternately, the User cancels the deletion and the system takes no action on the recruit and returns the User to the recruit listing screen. However, if any preconditions or validations are not met the system displays error messages allowing the User to correct and resubmit the data.

Another feature of this system allows a User to edit an existing recruit's information or add a new recruit after the User has logged in, selected a blueprint and a sport. The system must also be aware whether an existing recruit is being edited or a new recruit is being added. The system is aware if the User is proceeding from a sport's blueprint page or recruit test score report. When these preconditions are satisfied the system presents the User with a screen to collect recruit personal information as shown in FIG. 45. If the recruit is being edited the fields are pre-populated with existing data. The information includes the recruit's first, middle, and last name and phone number. The User provides the information and the selects save wherein the system validates the information. If the information is valid the system saves this information and directs the User back to the Add/Edit Recruit screen. In the next step the system presents the User the capability to provide a set of test score information for the recruit. The User provides the required field of entry date of test scores and scores including SAT verbal, SAT math or ACT english, ACT math ACT reading, ACT science and ACT composite. The entry date of the test scores must be unique for each set of test scores. The User then enters the necessary test scores and selects Save Test Scores. The system then validates the information and if valid directs the User back to the Add/Edit recruit screen so the User can perform edits if necessary.

If the recruit has existing test score entries, the system provides a listing of the entries and provides the User the ability to edit them except for the entry date field of the test scores. The entry date is only displayed on the screen. These test scores are stored in the first database. The editable scores include SAT math, SAT verbal or ACT english, ACT math ACT reading, ACT science and ACT composite. The Entry of Test Data Scores must be unique for each set of test scores. The User edits the necessary test score data and selects Save Test Scores, wherein the system validates the information and if valid directs the User back to the Add/Edit recruit screen so the User can perform additional edits if necessary. Furthermore, if the recruit has more than one existing set of test scores the system calculates a set of metrics, from stored algorithms in the third database, and displays these metrics to the User. The system notifies the User if any metric is outside of the system defined limits. The metrics include SAT math increase, SAT verbal increase, ACT composite increase, ACT sum increase, ACT english increase, ACT math increase, ACT reading increase, ACT science and ACT to SAT composite/sum increase as a percentage. These metrics are calculated on test score differences between the recruit's first set of test scores, their last set of test scores and the greatest test score differences between two sequential test scores. Finally, the system provides a Done button whereby the User selects it and the system directs the User back to the screen from where the User navigated. This includes either the sport's blueprint recruit or recruit test score report screens. However, if any of the preconditions or validations of the system are not met it displays error messages that allow the User to correct and resubmit the data.

A User can next view the test score metrics for the recruits of a sport in an academic year's blueprint after logging in, selecting the particular blueprint and the sport. The system presents a screen listing the recruits associated with the indicated sport and their test score metrics. Each entry in the listing displays the recruit's first name, last name, middle name, the recruit's phone number and test score metrics. The test scores include the combined SAT verbal/math increase, the SAT verbal increase, the SAT math increase, ACT scores and ACT to SAT composite/sum increase as a percentage. The ACT scores further include the ACT composite increase, ACT sum increase, ACT english increase, ACT math increase, ACT reading increase and ACT science increase. The above metrics are calculated using algorithms stored in the third database. They are based on test score differences between the recruit's first set of test scores, their last test scores and the greatest test score differences between two sequential test scores. The system notifies the User if any metric values fall outside the defined limits. Finally, the User can select a recruit to view their detailed information as shown in FIG. 45. However, if any of the system preconditions are not met it displays error messages allowing the User to correct and resubmit.

The system maintains a users' session state wherein it utilizes HTTP cookies to maintain an unique session id for each users' session. To allow the application to be distributed across more than one web server the system records all users' session variables in a data store. This feature can be enabled or disabled as required. The system further utilizes a users' session id, via the HTTP cookie, to retrieve a session variable from the data store if the feature has been enabled. Finally, when the User logs off the system deletes the user session state from the data store.

Another feature of the application of this system is that it analyzes upcoming sporting events and emails student athletes with complimentary admission reminders as required by the National Collegiate Athletic Association. Once a day the system will be scheduled to scan all active institutions and determine any sporting events for which email reminders are required to be sent. For each event that is configured to send out e-mail reminders, the system scans the associated sport's roster for all student athletes and e-mails each with a reminder that they can perform complimentary admission assignments for the event. The e-mail includes a HTTP link to the Compliance Toolbox URL, from the third database, where the student-athlete can perform the assignment.

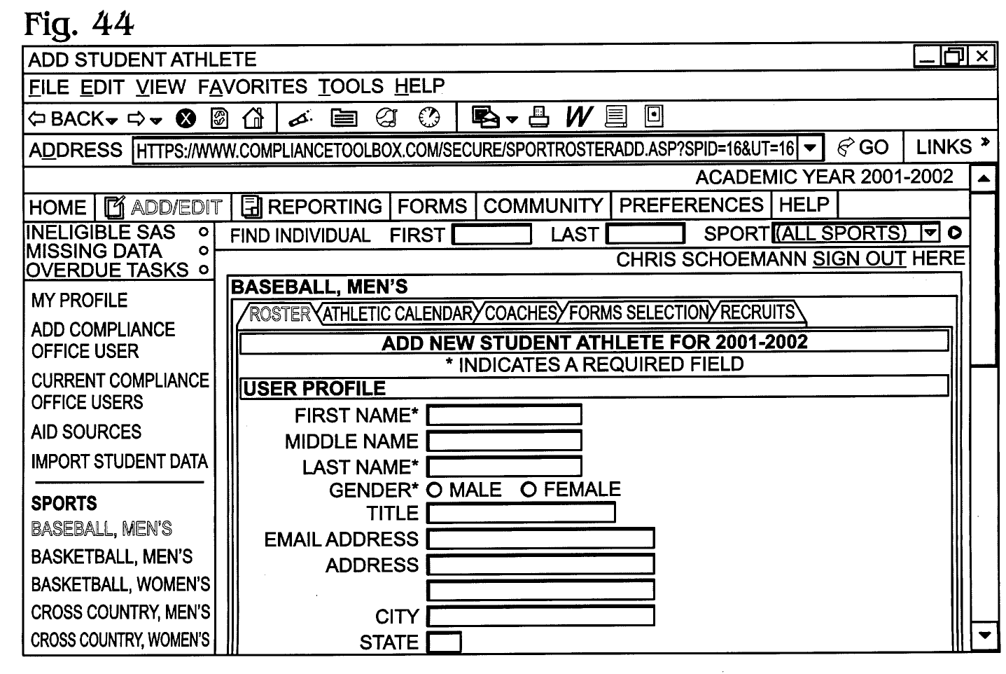

A student-athlete can assign a set number of complimentary tickets per sporting event after a user id has been assigned to the student-athlete and a schedule of sporting contests is defined. The student-athlete can also assign extra tickets if another student-athlete transfers their complimentary tickets to that student-athlete or less if they transferred ticket assignments themselves. The student-athlete finds the sporting event listed on the calendar of the Main Page as shown in FIG. 3. They click Assign Tickets and the system displays the ticket assignment page for the selected game as shown in FIG. 46. A new screen is displayed, showing event information, wherein the system will create text boxes to enter the name of the person to whom complimentary tickets are to be assigned. Also, a comments text box is created for any additional messages for the box office. The number of text boxes that appear will be set to the number of complimentary tickets that can be assigned by that student-athlete for the selected event. The User will enter the names and any comments of the assignees into the text boxes. The User next selects Submit and the system will save the complimentary ticket assignment. However, if the student-athlete selects a sports event that already happened the system will display a message telling them of this.

A student-athlete can modify complimentary ticket assignments to a sporting event after a user id is assigned to the student-athlete and a schedule of sporting contests is defined. The student-athlete finds the sporting event listed on the calendar of the Main Page as shown in FIG. 3. They click Assign Tickets and the system displays the ticket assignment page for the selected game with the previously saved information loaded as shown in FIG. 46. To modify a complimentary ticket the student-athlete modifies the data in the Name and Comments text boxes. Once all modifications are completed the student-athlete selects Submit and the system saves the ticket assignment information.

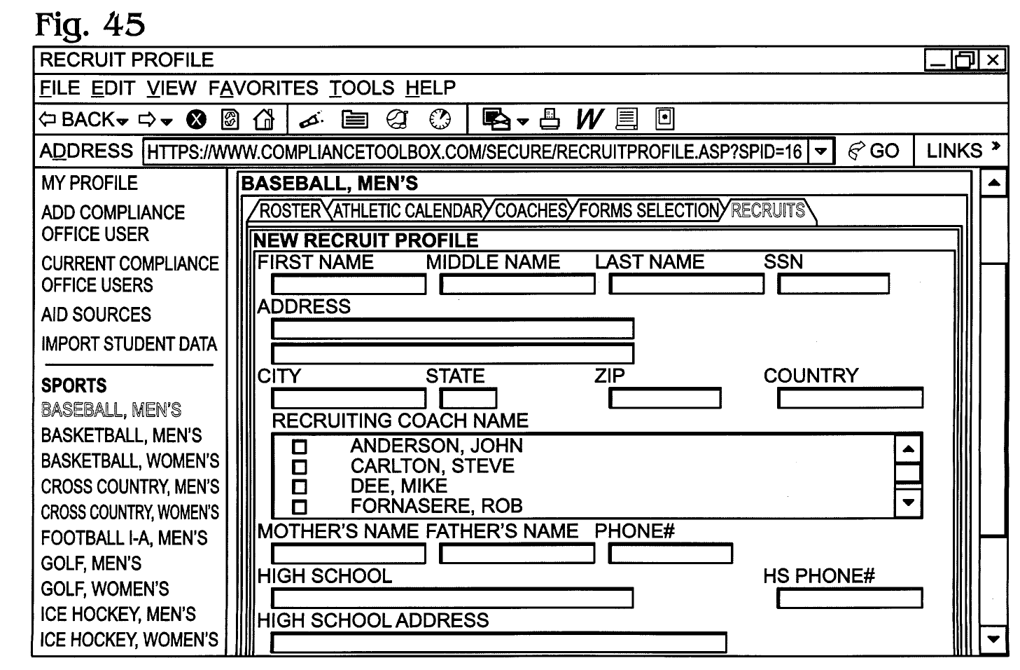

A student-athlete can transfer un-assigned complimentary tickets for a sporting event to another student-athlete after a user id is assigned to the student-athlete for a sport and a schedule of sporting contests is defined. The student-athlete finds the sporting event listed on the calendar of the Main Page as shown in FIG. 3. They next click Assign Tickets and the system displays the ticket assignment page for the selected game as shown in FIG. 46. The student-athlete next selects Transfer Tickets and the system displays the Transfer Tickets page as shown in FIG. 47. The student-athlete selects the number of tickets to transfer from the drop down list containing the number of unassigned tickets the User wishes to transfer. The maximum number of tickets to transfer is determined by the number of tickets allotted for a particular event for the student-athlete to assign. This includes 4 tickets for regular season contests and 6 for National Collegiate Athletic Association contests. Also, included are any tickets transferred from the student-athlete minus any tickets transferred to another student-athlete minus any tickets already assigned. This calculation uses an algorithm stored in the third database. The User then selects the name of a student-athlete from a list of other student-athletes assigned to the same sport so that the User can transfer the ticket assignments. The User then selects Transfer and the system will then transfer the ticket assignment to the selected student-athlete.

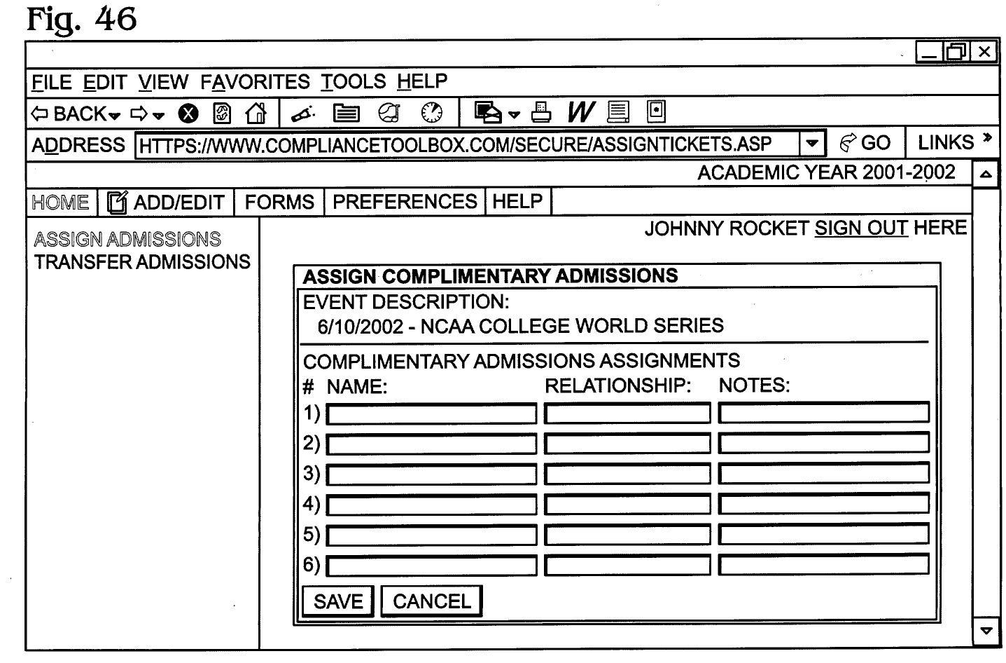

A system administrator (SA) maintains, translates to, adds, edits and deletes National Collegiate Athletic Association rules from a second database after a user id is logged into the Compliance application with system administrator (SA) privileges. The SA selects Content Setup whereby the SA next selects the National Collegiate Athletic Association Annual The system displays the National Collegiate Athletic Association rules for a selected National Collegiate Athletic Association division as shown in FIG. 48. To select the National Collegiate Athletic Association division the SA selects the desired National Collegiate Athletic Association division from the drop down list of defined divisions. The system then displays the National Collegiate Athletic Association rules for that division. To add a National Collegiate Athletic Association rule the SA selects Add and enters the National Collegiate Athletic Association rule in detail. These rule details include the rule article number, category and deep link to the National Collegiate Athletic Association site. The SA then selects Save and the system saves the Compliance Toolbox Item (CTI). To modify the properties of a National Collegiate Athletic Association rule the SA selects the rule and then selects Edit. The SA modifies the rule detail information and selects Save and the system updates the National Collegiate Athletic Association rule information. To Delete a rule the SA selects the rule and then selects Remove and the system deletes the item. However, while adding or modifying a rule if the user entered invalid information the system displays what information is invalid and allows the SA to correct what they entered.

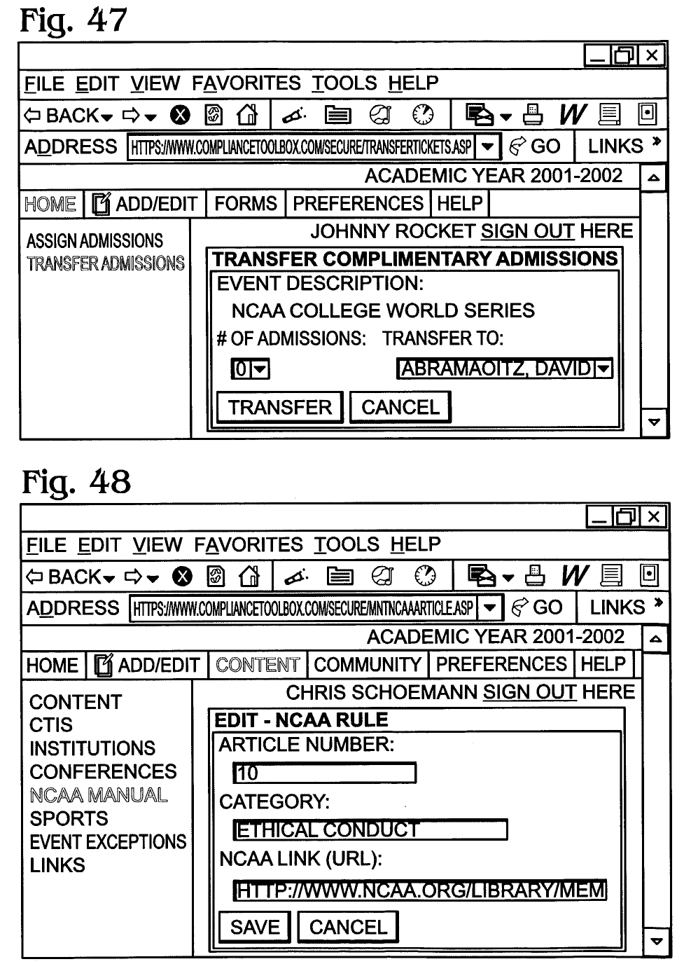

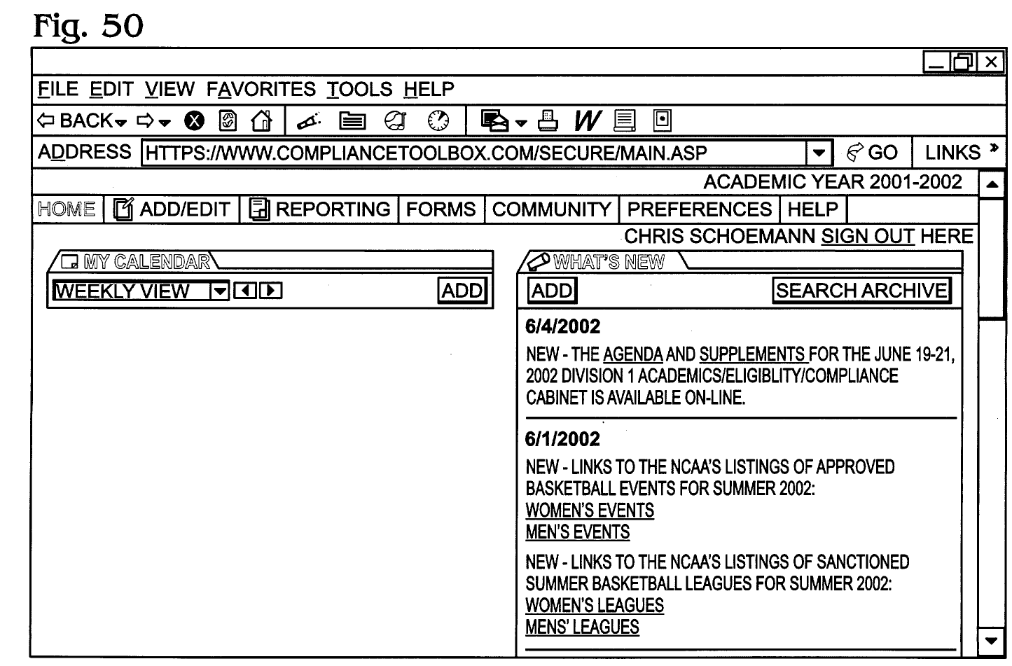

A system administrator (SA) can maintain Compliance Toolbox Items (CTI) that are through out the system after a user id is logged into the Compliance Toolbox application with SA privileges. The SA selects Content Setup and the system displays the Content Setup page as shown in FIG. 49. The SA selects the CTIs and the system displays the CTI maintenance page as shown in FIG. 51. To Add a CTI the SA selects Add and the system loads the CTI detail page. The information changed/entered includes title, description, purpose, action, is editable, is visible and is required once per year or multiple per year. Further information changed/entered includes pdf filename from a list of available pdf files, ad-hoc report description and include this CTI in the add-hoc report list. If there is no editable field the information is not editable in the opened CTI. There are also Add CTI Data Capture field definitions that include entries for field descriptions, a title description field, a field type and include field. This field is an ad-hoc report criteria. The SA selects Save and the system saves this CTI. To modify a CTI the SA selects the CTI and then selects Edit. The data that can be edited includes modifying the CTI detail information as defined for the Add A CTI, selecting which if any rules apply to this CTI and selecting the user roles that have access to this CTI. Further editing includes selecting the sport(s) this CTI applies to and selecting Save wherein the system will update the CTI. To delete a CTI the SA selects Delete after selecting the CTI and the system deletes the CTI. However, while adding or modifying if the SA entered invalid information the system displays what information is invalid and allows the SA to correct that information.

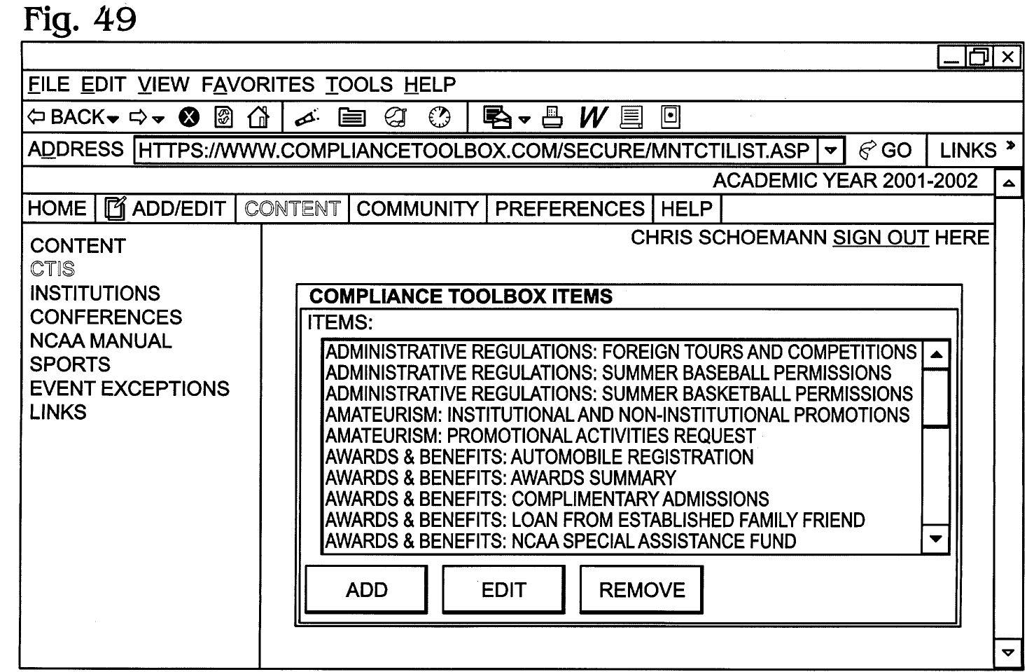

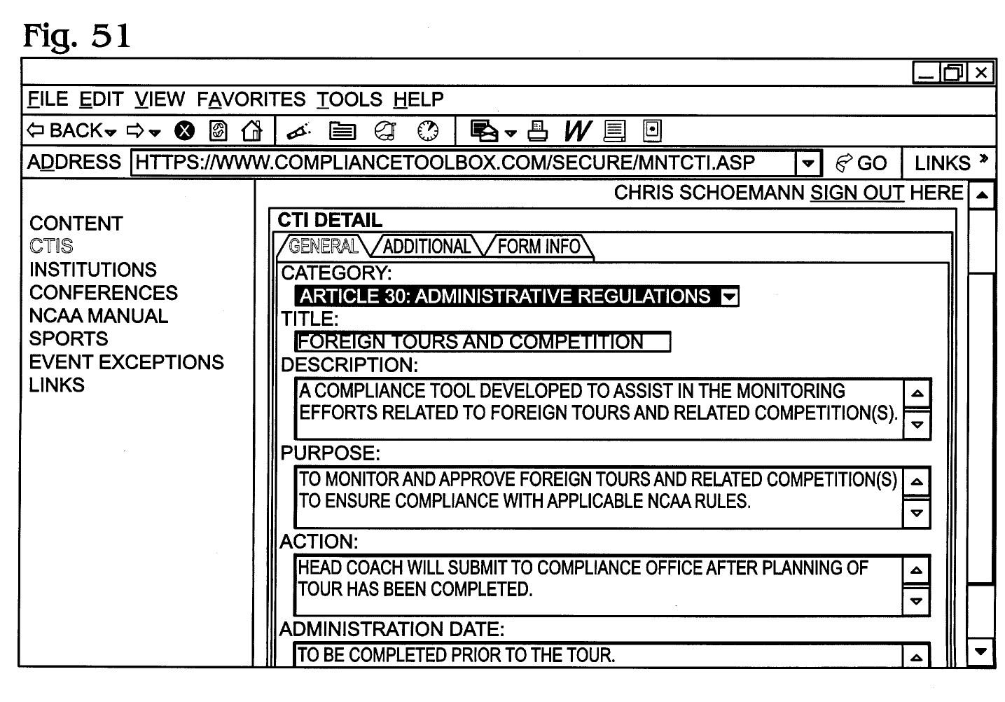

The SA can maintain the information presented in the What's New section of the system after a user id is logged into the Compliance Toolbox application with SA privileges. The SA selects the Main Page and then the system will display the default Administrator's Main page as shown in FIG. 50. The current and any future What's New Item will be displayed as one of the sections of the Main Page as shown in FIG. 3. To Add a What's New Item the SA selects Add and the system displays the Add A What's New Item page as shown in FIG. 52. The SA enters the What's New Item in detail including begin, end display date and the message in either straight text or HTML. The SA next selects Submit, the system saves the information and returns the SA to the Main Page. To modify a What's New Item, the SA selects the Edit button of the desired What's New Item in the list and modifies the description detail as defined for the Add A What's New Item. The SA then selects the sport and the What's New Item that it applies to, finally selects Submit wherein the system saves the information and returns to the What's New Item list. However, while adding or editing the information if the SA entered invalid information the system displays what information is invalid and allows the SA to correct that information.

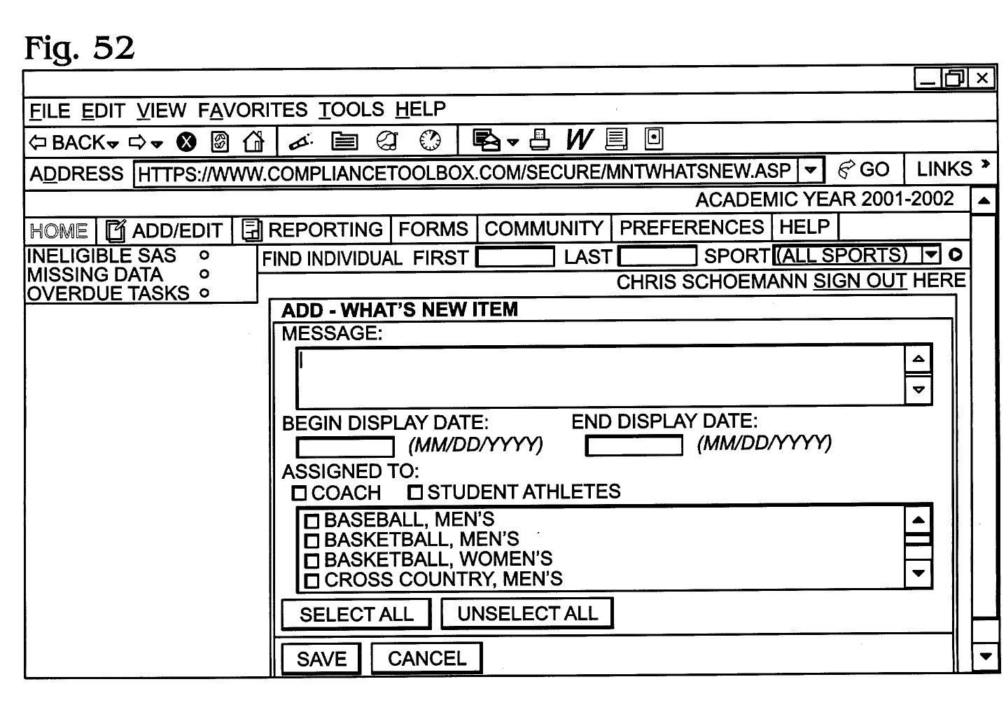

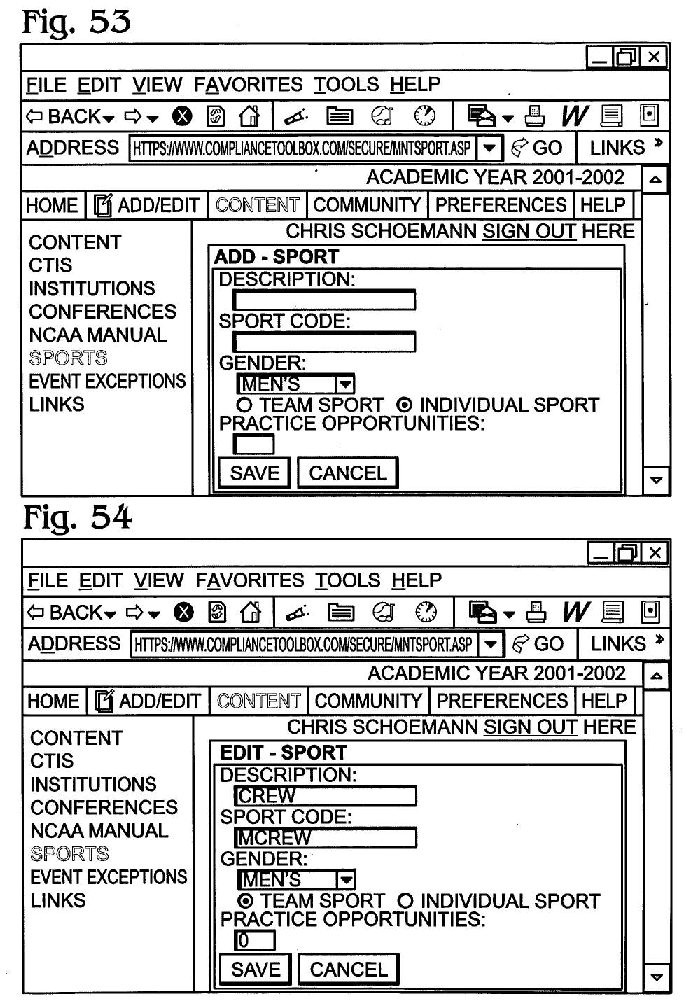

A SA can maintain the collection of valid National Collegiate Athletic Association sports and any date associated with the sport after a user id is logged into the Compliance Toolbox application with SA privileges. The SA selects Content Setup and then selects Sports wherein the system displays a list of the sports. To add a sport the SA selects Add and the system displays the Add A Sport page as shown in FIG. 53. The SA enters information including the sport name and indicates whether it is a men's or women's sport. The SA then selects Save and the system saves the information and returns to the sport's list. To modify a sport the SA selects the Sport and then selects Modify wherein the system loads the selected sport information and displays it in the Modify A Sport page as shown in FIG. 54. The SA then can modify the sport's detail as defined for Add A Sport and selects Save wherein the system saves the information and returns to the sport list. To delete a sport the SA selects Delete and the system deletes the sport. However, while adding or modifying if the User entered invalid information the system displays what information is invalid and allows the SA to modify what was entered. If removing a sport breaks referential integrity the system will display a message to that affect and not remove the sport from the database.

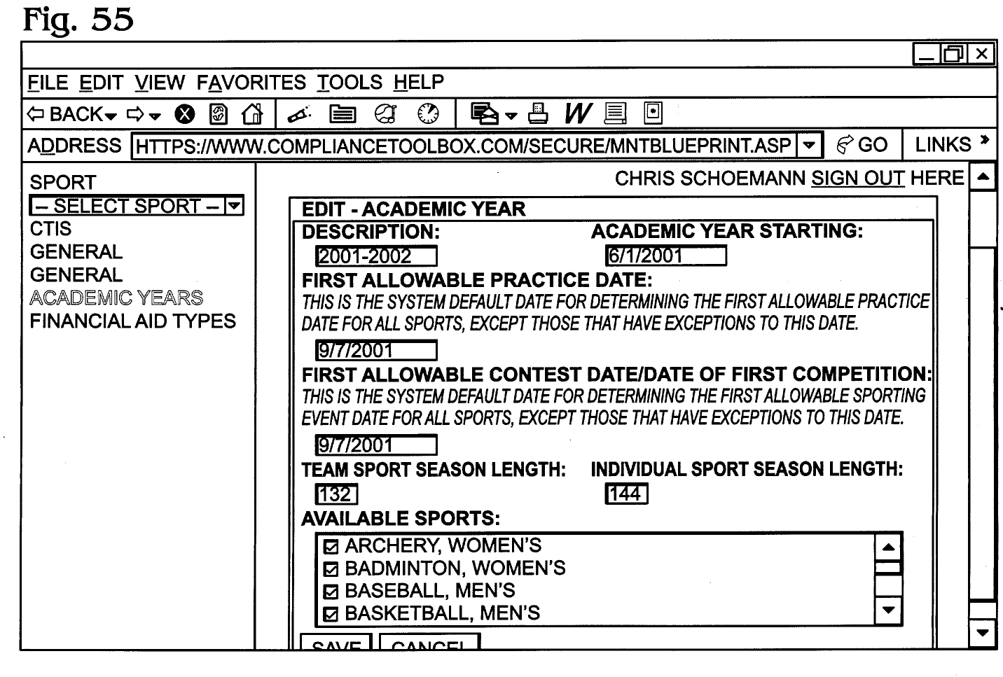

A SA can create the system wide blueprint and select which blueprint is the current academic year active blueprint after a user id is logged into the Compliance Toolbox application with SA privileges. The SA selects Blueprint and the system displays the Blueprint Administration page as shown in FIG. 55. The SA selects which sport to maintain and then selects General wherein the system displays the general blueprint information for the selected sport. The SA can modify the sports' detail which is used as validation for the User entering the sport calendar. The detail includes the number of contests allowed, the number of dates of competition allowed, the first allowable practice date, the first allowable contest date or date of competition and the end of the regular season. However, while adding or modifying if the SA entered invalid information the system displays what information is invalid and allows the SA to modify what they entered.

A SA can maintain the list of institutions that have access to the Compliance Toolbox application after a user id is logged into it with SA privileges. The SA selects Content Setup and the system displays the Content Setup page as shown in FIG. 49. The SA selects Institution and selects Add wherein the system displays the institution maintenance page as shown in FIG. 11. To add an institution the SA selects Add and the system loads the institution detail page to enter institution information. This information to be entered includes institution name, institution id, a first address, a second address, city, state, zip code, starting blueprint year, ending blueprint year and main compliance office (CO) user profile as detailed under the maintain user profile text. The starting blueprint year sets the point in time that the institution can start using the system. The ending blueprint is filled in only if the institution will not be using the system in the future. The SA selects Submit and the system saves the information and returns to the institution list. To modify an institution the SA selects the Institution and selects Modify. The SA modifies the detail, as defined previously in the Add An Institution, as shown in FIG. 13, and selects Submit wherein the system updates the information and returns to the institution list. To delete an institution the SA selects Remove after selecting the institution and the system removes the institution. However, when submitting if any invalid data is entered the system returns to the institution detail screen with messages stating which data is invalid.

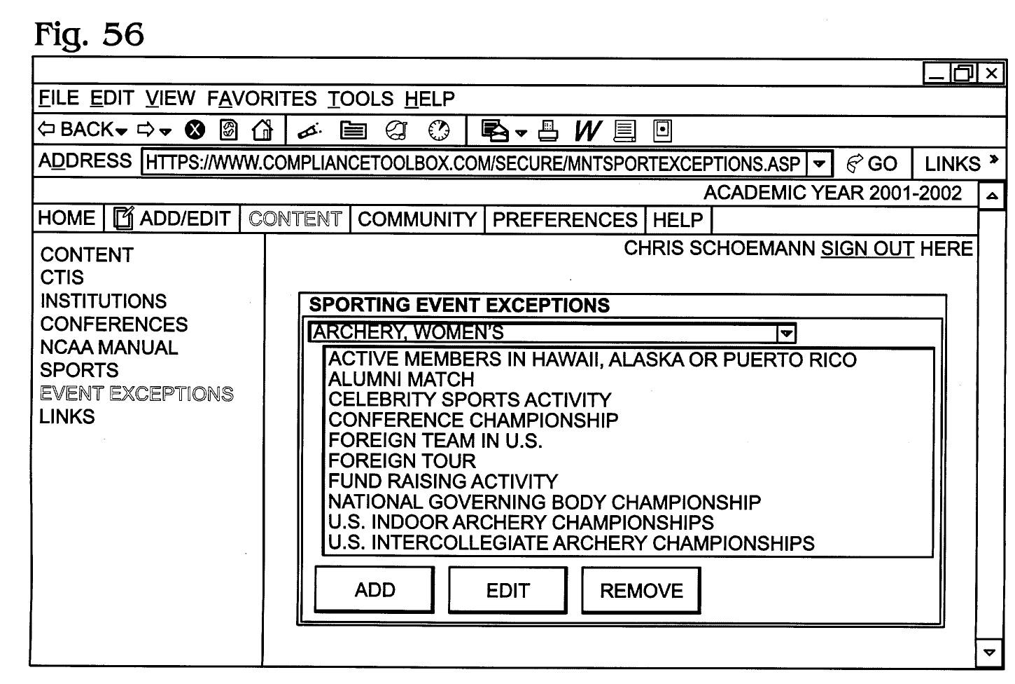

The SA can maintain the list of sporting event exceptions per sport, as shown in FIG. 56, after a user id is logged into the Compliance Toolbox application with SA privileges. For example, exceptions include conference championship, one in four year exemptions, and the like. The SA selects Content Setup and selects Event Exceptions, as shown in FIG. 56, and the system displays a list of exceptions for a selected sport. To select a sport the SA selects the desired sport from the drop down list of the system defined sports. The system then displays the exceptions for that sport. To add an exception to the selected sport the SA selects Add and the system displays the Add an Exception page. The SA enters information that includes the exception detail description, selects if the event is a once in four-year exception or annual exception and selects if the event is an National Collegiate Athletic Association event. The SA then selects Save wherein the system saves the information and returns to the exceptions list. To modify an exception the SA selects the Exception, selects Edit and the system loads the selected exception information and displays it in the Modified Exception page. The SA then modifies information that is defined in the Add An Exception page, selects Save and the system saves the information and returns to the exceptions list. To delete an exception the SA selects the exception and then selects Remove wherein the system deletes the exception. However, if preconditions in the system are not met it displays error messages that allows the SA to correct and resubmit.

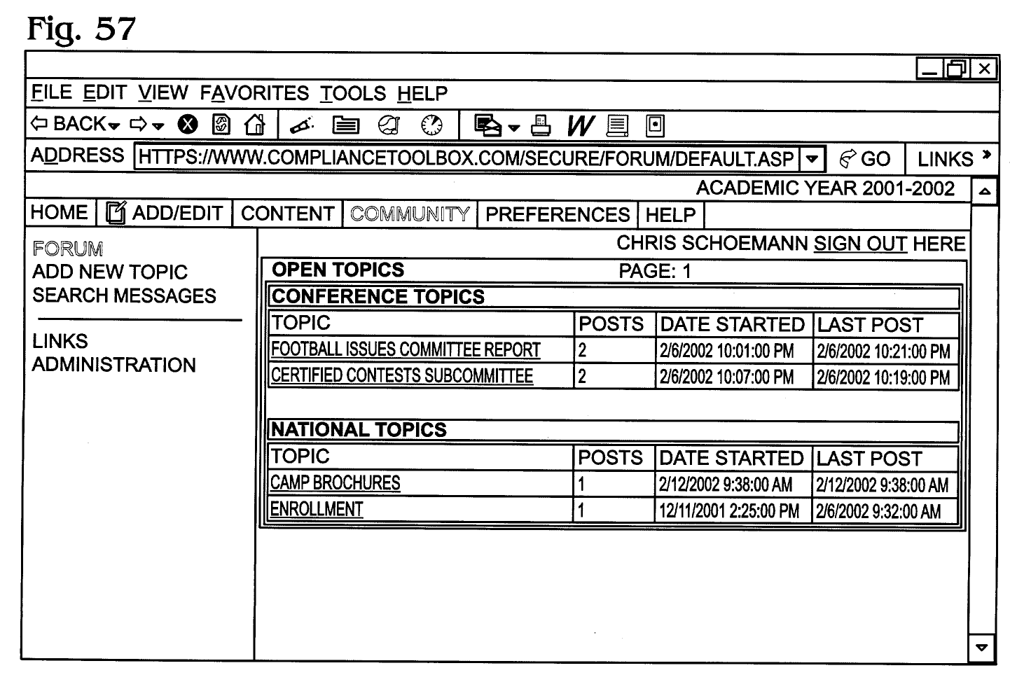

The SA can maintain the messages in the message forum after a user id is logged into the Compliance Toolbox application with SA privileges. The SA navigates to the message forum administrator page as shown in FIG. 57. The system presents the SA methods of searching for messages including, by message ID, by message subject/text, by author and by date range. The SA fills in the appropriate criteria and selects to search. The system presents a listing of messages that match the search criteria. Each listing element contains particular information including message ID, number of child messages, author, author e-mail, author full name, date created, date modified, message subject and message text. The SA can select one or more messages from the list and delete them if desired. However, if preconditions in the system are not met it displays error messages that allows the SA to correct and resubmit.

Another feature of this system is a data migration utility that allows authenticated end-users with the proper access level to import student-athlete data into the Compliance Toolbox first database. This utility allows institutions to export data from existing sources into a predefined format so that the data can then be imported into the Compliance Toolbox first database. For example, the User is not as burdened having to re-enter data for each student-athlete. The utility enables the User to upload up to six different types of flat files for importation. The flat files follow a comma separated list format and include user profiles, enrollment records, sport participation records, financial aid records, academic eligibility and transfer eligibility. Once the required files are uploaded to the web site the User can select to process the files. The files are parsed and error checked on a record by record basis. Each record that passes error checking is inserted into the first database. Any errors that are detected are logged for later reporting purposes. When all the files have been processed the User is presented with a list of warning and/or error messages indicating which records are is error. Furthermore, the User can elect to view which records were successfully imported.

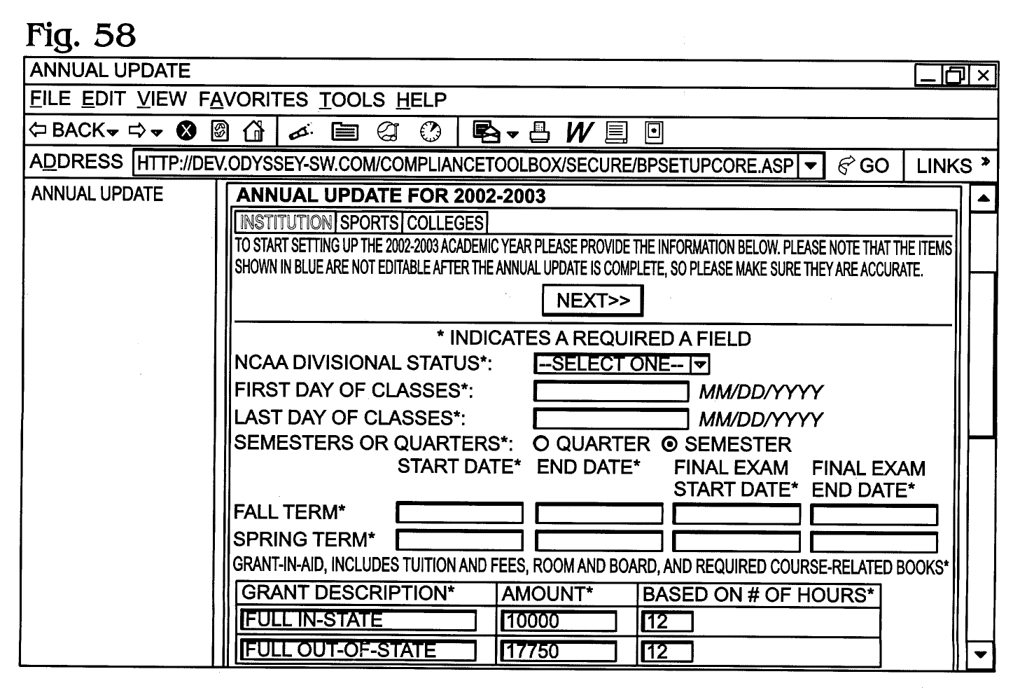

FIG. 58 illustrates the annual update page of the preferred embodiment of the invention. The User can start setting up of the next school year. The fields include National Collegiate Athletic Association Divisional status, first and last day of classes and whether the school is based on semesters or quarters. Additionally the annual update page includes fields to input information on the different semester or terms. This information includes start date, end date, final exam start date and final exam end date. Other fields on this page where information can be added include grant-in-aid and institutional aid sources.

While there has been illustrated and described what is at present considered to be a preferred embodiment of the present invention, it will be appreciated that numerous changes and modifications are likely to occur to those skilled in the art. It is intended in the appended claims to cover all those changes and modifications that fall within the spirit and scope of the present invention.

What is claimed is:

1. An interactive system for managing compliance of institutions, teams, coaches and individuals with NCAA regulations comprising:
a) an input means permitting a user to add, delete or manipulate information on institutions, teams, coaches and individuals that pertains to a regulated activity or activities, and add or delete NCAA rules and regulations that pertain to said activity or activities;
b) a first data base structure for collecting and storing said information;
c) a second data base structure for collecting and storing said rules and regulations;
d) a third data base structure for accessing said first and second data base including processing means for comparing said information with said rules and regulations and applying the comparison of said information with said rules and regulations to determine compliance eligibility of said institutions, teams, coaches and individuals.

2. The interactive system as claimed in claim 1, a communication link for accessing the Internet.

3. The interactive system as claimed in claim 1, an output means for displaying and printing said information, regulations and compliance eligibility.

4. The interactive system as claimed in claim 1, wherein said processing further comprises interaction with a plurality of protocols.

5. The interactive system as claimed in claim 1, wherein said communication link provides hot-links to a plurality of texts.

6. The interactive system as claimed in claim 5, wherein said texts are selected from the group consisting of National Collegiate Athletic Association Regulations, press releases, events, and interpretations.

7. The interactive system as claimed in claim 1, wherein said second data base further comprises a web based data base of compliance specific information for students, athletes, coaches, recruits, organizations and institutions.

8. The interactive system as claimed in claim 1, wherein said web based data base further comprises student enrollment information, student financial aid information, athlete academic eligibility, transfer eligibility, tracking complimentary admissions to athletic events and institution compliance data sheets.

9. The interactive system as claimed in claim 1, wherein said processing automatically determines athletic eligibility by providing a step-by-step protocol when new athletes are added to the system.

10. The interactive system as claimed in claim 1, wherein said first data base further includes information on a particular sport, institution profile, organization profile, event exception, individual athlete profiles, events calendar, complimentary ticket list, sport rosters, eligibility profile, recruit roster, ticket transfers and audit trail data.

11. The interactive system as claimed in claim 1, wherein accessing said first, second and third databases requires a security protocol.

12. The interactive system as claimed in claim 1, wherein said second database further comprises a calendar of events for all sports related to the governing athletic body, interpretations of regulations or compliance issues ruled on by committees related to the governing athletic body.

13. The interactive system as claimed in claim 1, wherein said third database further includes a security protocol to access the system.
